(19) United States
(12) Patent Application Publication
(10) Pub. No.: US 2010/0031205 A1
(43) Pub. Date: Feb. 4, 2010

(54) ANALYTICAL SYNTHESIS METHOD AND OTA-BASED CIRCUIT STRUCTURE

(75) Inventors: Chun-Ming Chang, Chung-Li (TW); Shu-Hui Tu, Chung-Li (TW)

Correspondence Address: WPAT, PC;INTELLECTUAL PROPERTY ATTORNEYS, 2030 MAIN STREET, SUITE 1300, IRVINE, CA, 92614, US

(73) Assignee: CHUNG YUAN CHRISTIAN UNIVERSITY, Chung-Li City (TW)

(21) Appl. No.: 12/535,194

(22) Filed: Aug. 4, 2009

Related U.S. Application Data
(60) Provisional application No. 61/085,926, filed on Aug. 4, 2008.

(51) Int. Cl. G06F 17/50

(52) U.S. Cl. 716/1

(57) ABSTRACT

An analytical Synthesis Method (ASM) is clearly and effectively demonstrated in the realization of current/voltage-mode Operational Trans-conductance Amplifier and Capacitor (OTA-C) circuits, where a complicated nth-order transfer function is manipulated and decomposed by a succession of innovative algebra operations until a set of simple equations are produced, which are then realized using n integrators and a constraint circuitry. The circuits realized includes voltage-mode nth-order OTA-C universal filter structures, tunable voltage/current-mode OTA-C universal biquad filters, voltage-mode odd/even-nth-order OTA-C elliptic filter structures, voltage/current-mode odd-nth-order OTA-C elliptic high-pass filter structures, and OTA-C quadrature oscillators. Some realized OTA-C circuits can be simplified to be OTA-only (OTA-parasiic C) circuits which fit for the operation at high frequencies.

### BACKGROUND

1. Field of the Invention

The present invention generally relates to filter design and more particularly to an OTA-based circuit.

2. Description of Related Art

High-order OTA-C filter structures have been investigated and developed for several years. Recently, the analytical synthesis methods have been introduced for realizing high-order current/voltage-mode OTA-C filters or current conveyor-based filters, where a complicated nth-order transfer function is manipulated and decomposed by a succession of innovative algebraic operations until a set of simple equations are produced, which are then realized using n integrators and a constraint circuitry (in fact, the new analytical synthesis method can be used in the design of any kind of linear system with a stable transfer function). In addition, all the filter structures presented in the related arts enjoy the following three important criteria:
filters use grounded capacitors, and thus can absorb equivalent shunt capacitive parasitics;
filters employ only single-ended-input OTAs, thus overcoming the feed-through effects due to finite input parasitic capacitances associated with differential-input OTAs; and
filters have the least number of active and passive elements for a given order, thus reducing power consumption, chip areas, and noise.

In a related art, it has been illustrated that the voltage-mode filter structure with arbitrary functions needs 2n+2, i.e., n more OTAs than the other voltage-mode filter structure with only low-pass (LP), band-pass (BP), and high-pass (HP) functions. This led to the research work in another related art: a new analytical synthesis method for realizing the voltage-mode high-order OTA-C all-pass (AP) and band-reject (BR) filters using only n+2 single-ended-input OTAs and n grounded capacitors.

Combining both the current-mode notch and inverting LP signals, a current-mode HP signal can be easily obtained. Similarly, a current-mode AP signal can be obtained by connecting current-mode notch and inverting BP signals. This well-known concept has been demonstrated in the recently reported current-mode OTA-C universal filter structure in another related art. However, the voltage-mode circuit lacks this ability, unlike the current-mode circuit, of the arithmetic operations of direct addition or subtraction of signals. Hence, although several voltage-mode OTA-C biquad filters have been presented recently, yet only two of them, using three differential-input OTAs and two single-ended-input OTAs in addition to two grounded capacitors, can synthesize all the five different generic filtering signals, i.e., LP, BP, HP, band-reject (or notch), and AP signals, simultaneously. Therefore, the problem as to how to bring about the arithmetic superiority of the current-mode circuit in terms of the arithmetic operations to the voltage-mode counterpart and still achieve the above three important criteria for the design of OTA-C filters is a very difficult one, but at the same time worthy of research. It may be noted that such a problem has been solved for the biquad structure with the additional valuable advantage of “programmability” using the recently reported analytical synthesis method.

Although both the voltage-mode nth-order OTA-C LP, BP, and HP filter structure of a related art and the voltage-mode nth-order OTA-C AP and BR filter structure of another related art use the least number of active and passive components, namely, n+2 single-ended-input OTAs and n grounded capacitors, yet none of the voltage-mode nth-order OTA-C universal filter structures (realizing low-pass, band-pass, high-pass, band-reject, and all-pass) employs such least number of active and passive components. Although the voltage-mode second-order OTA-C universal filter structure of yet another related art is “programmable” and uses 2+2(=4) single-ended-input OTAs and 2 grounded capacitors, yet none of the voltage-mode nth-order OTA-C universal filter structures are “programmable”. Therefore, there is not an existing any voltage-mode nth-order OTA-C universal filter structures in the published literature that has both the least number of components and the particular advantage of “programmability”. With these two properties in mind, a new voltage-mode nth-order programmable, universal filter structure using n+2 single-ended-input OTAs and n grounded capacitors is developed which is an extension of the recently reported voltage-mode second-order OTA-C programmable, universal filter structure given in still another related art.

Comparing the recently reported current-mode and voltage-mode OTA-C filter structures realized by the new analytical synthesis methods, the active component number of the voltage mode is at least two more than that of the current mode. The main reason for this is explained below. Since (i) the input-and-output relationship of an OTA given by gVBinB=IBoutB, where g is the transconductance of the OTA, VBinB is the input voltage difference between the plus and minus terminals of the OTA, and IBoutB is the output current flowing out from the output terminal of the OTA, is a current relationship, and (ii) the use of OTAs should be single-ended, i.e., one of the two input terminals of the OTA should be grounded, and the capacitors should be grounded, Kirchhoff's current law, which is relevant to many grounded branches, (as opposed to Kirchhoff's voltage law which is relevant to many floating branches) is suggested to be used in the synthesis method. Clearly, it is simple to do the synthesis for a current-mode transfer function by using Kirchhoff's current law. However, it becomes difficult to do such a synthesis for a voltage-mode transfer function by using Kirchhoff's current law because a voltage transfer function is a relationship between voltages and not currents. This leads to the difficulty in realizing a voltage-mode transfer function by using this approach, namely, using all single-ended-input (or grounded) OTAs and all grounded capacitors to do the realization.

Then, how does one attempt to solve this difficulty? An example of the process is illustrated below.

Assuming a general nth-order voltage-mode all-pass transfer function be

$$\frac{{V}_{out}}{{V}_{in}} = \frac{{\sum }_{i = 0}^{n} {( - 1 )}^{i} {a}_{i} {s}^{i}}{{( - 1 )}^{n} {\sum }_{i = 0}^{n} {a}_{i} {s}^{i}} \qquad ( 1 )$$

Multiplying both sides of (1) by a factor a/b, a following equation is obtained

$$( \frac{a}{b} ) \frac{{V}_{out}}{{V}_{in}} = ( \frac{a}{b} ) \frac{{\sum }_{i = 0}^{n} {( - 1 )}^{i} {a}_{i} {s}^{i}}{{( - 1 )}^{n} {\sum }_{i = 0}^{n} {a}_{i} {s}^{i}} \qquad ( 2 )$$

If we regard and b are regarded as the transconductances of the OTA, then both aVBoutB and bVBinB represent two “current” signals. Furthermore, if aVBoutB and bVBinB be Vₒᵤₜ^{*} and Vᵢₙ^{*} are considered, then (2) becomes

$$\frac{{V}_{out}^{*}}{{V}_{in}^{*}} = ( \frac{a}{b} ) \frac{{\sum }_{i = 0}^{n} {( - 1 )}^{i} {a}_{i} {s}^{i}}{{( - 1 )}^{n} {\sum }_{i = 0}^{n} {a}_{i} {s}^{i}} \qquad ( 3 )$$

Therefore, analytical synthesis method may be initiated with the following initial transfer function:

$$\frac{{V}_{out}}{{V}_{in}} = ( \frac{a}{b} ) \frac{{\sum }_{i = 0}^{n} {( - 1 )}^{i} {a}_{i} {s}^{i}}{{( - 1 )}^{n} {\sum }_{i = 0}^{n} {a}_{i} {s}^{i}} \qquad ( 4 )$$

which is the realized voltage-mode transfer function illustrated in a related art. Although the difference between (1) and (4) is an amplification factor of a/b, yet it will lead to an easier analytical synthesis using only single-ended-input (or grounded) OTAs and with all the capacitors grounded, since (4) is equivalent to the form of (2), but with a “current”-mode relationship. Moreover, due to the addition of the two transconductances a and b in (4), the realized circuit from a voltage transfer function has two more OTAs in structure than that from a current transfer function without the two transconductances, a and b. This property has also been demonstrated in the recently reported voltage-mode nth-order single-ended-input OTA and grounded capacitor filter structures, using n+2 OTAs, which is two more OTAs compared to the recent current-mode nth-order ones, all of which are realized using the analytical synthesis methods.

A differential (or double) input OTA can be realized by two parallel single-ended-input OTAs. Then, it may be possible to synthesize an nth-order filter structure using n differential-input OTAs instead of n+2 single-ended-input OTAs in addition to n capacitors. If it is possible to do so, the following question is quite interesting. Which one is the better? Is the one with n+2 single-ended-input OTAs or the one with n differential-input OTAs. The former uses more OTAs, but has lower parasitics for each single-ended-input OTA and the latter uses fewer OTAs, but has larger parasitics for each differential-input OTA. Therefore, it is really worthwhile to do such a comparison between the above mentioned two cases.

Another kind of analytical synthesis method, different from the recently reported ones, which makes use of only single-ended-input OTAs and grounded capacitors to realize a voltage-mode n-th order OTA-C universal filter structure with the minimum number of active and passive components, i.e., only n differential-input OTAs and only n floating capacitors, will be presented as follows.

However, there is still one more important characteristic: tunability (for the easy adjustment of both resonant angular frequency ωo and quality factor Q), which have not yet been considered and included in the voltage-mode universal biquad filter [20]. Although the tunable current-mode OTA-C universal biquad filter with the minimum number of components, three OTAs and two capacitors, was reported [28], yet the voltage-mode one has not been reported. A differential (or double) input OTA can be realized by two parallel single-ended-input OTAs. Then, it may be possible to synthesize an nth-order filter structure using n differential-input OTAs instead of n+2 single-ended-input OTAs in addition to n capacitors. This conclusion makes the realization of a tunable voltage-mode OTA-C biquad filter using the minimum number of components, only three OTAs and two capacitors just as the employment of the recently reported current-mode one, possible. It is demonstrated and illustrated using the effective analytical synthesis method. The analytical synthesis method is also applied to the recently reported tunable current-mode OTA-C universal biquad filter. The two tunable OTA-C universal biquad structures are with two different modes (voltage and current modes) having the same minimum number of components, three OTAs and two capacitors. It is really interesting to compare which one between the voltage and current modes has more precise output signal.

From de-normalization point of view, the smaller the given capacitance of a capacitor is the higher the operating frequency of a circuit. However, the capacitance cannot be given by a value too low to overcome the effect produced by parasitic capacitances. Note that the output error generated from the existence of parasitic capacitances increases based upon the percentage increment of the whole parasitic capacitance in the circuit. Because (i) the particular arrangement to put a grounded capacitor at each internal node of the circuit leads to the absorption of the parasitic capacitance at each node by the given grounded capacitor; (ii) no other kinds of capacitors are arranged in the circuit except the case illustrated in (i), and (iii) the minimization of the component number leads to the minimization of the whole parasitic capacitances and then has the most precise output signal, the realized tunable current-mode and voltage-mode OTA-C biquad structures can be straight transferred to the OTA-parasitic C ones just taking out the two given grounded capacitors from the OTA-C structures.

The elliptic filter is a better choice than other kinds of filters for satisfying with a stringent cut-off rate specification, namely, a narrower transition band, under the restriction of a finite order. In the recent decade, several 3rd-order OTA-C elliptic filters [4, 29-31] and high order OTA-C filter structures, feasible for 3rd-order elliptic filter, have been presented. Some of these 3rd-order elliptic filters employ seven or ten OTAs and three or four either grounded or floating capacitors. While only five OTAs and three grounded capacitors are employed in a related art, both don't use the minimum number, four, of OTAs and the other uses multiple-Gm-value OTAs leading to more complex bias circuits. And although the condensed elliptic filter employs only four OTAs, four capacitors, i.e., one more capacitor than the minimum number (three), are used. The 3rd-order current-mode elliptic filter proposed recently enjoys the minimum active and passive components, i.e., four OTAs and three capacitors (reducing the power dissipation and chip area), and low sensitivities. Since it is desirable for designers to realize not only current-mode but voltage-mode and not only third-order but also high-order elliptic filters, the synthesis of voltage-mode odd-nth-order OTA-C elliptic filter structure is worthy of our continuing research. Using a new analytical synthesis method by a succession of innovative algebra manipulation operations, demonstrated in the recently reported for synthesizing a voltage-mode odd-nth-order OTA-C elliptic filter structure with the minimum number of components is presented.

The well-known doubly terminated LC ladder filter has very low sensitivities so that its response won't be influenced seriously by unpredictable variations of process parameters for monolithic integrated filters. In this proposed new structure, all sensitivities of its elliptic filtering parameters, fp, fs, A1, and A2, to its each transconductance have the absolute values, each of which is smaller than unity except the sensitivity of A2 to the transconductance g2. Therefore, the proposed voltage-mode odd-nth-order OTA-C elliptic filter structure also enjoys low sensitivity merit, which has been achieved by LC ladder circuits.

However, the odd-nth-order elliptic filter structure cannot realize a high-pass elliptic filter owing to the lack of the term of the nth power of s in the numerator of the realized nth-order transfer function. As can be seen, even though s in the transfer function of the third-order elliptic filter could be replaced by 1/s, the resulting transfer function would have a form different from that of the previous one. It is interesting and useful to propose a current-mode or a voltage-mode odd-nth-order elliptic high-pass filter structure with the minimum number of components which has been presented in this patent using the effective analytical synthesis methods.

The “current”-mode even-nth-order operational transconductance amplifier and capacitor (OTA-C) elliptic filter structure with the minimum number of components has been published recently which is capable of achieving the following five advantages: (i) all single-ended-input OTAs, (ii) all grounded capacitors, (iii) the minimum active and passive components, (iv) one grounded capacitor at each internal node, and (v) equal-capacitance-type structure for eliminating the difficulty of precisely fabricating capacitances in integrated circuits. However, its counterpart: the voltage-mode one, until now, hasn't been presented in the literature.

The analytical synthesis methods, using a succession of innovative algebra manipulation operations to decompose a single complicated nth-order filter transfer function into a set of simple and feasible equations, have been demonstrated to be very effective for simultaneously achieving the three important criteria for the design of OTA-C filters. If we do the comparison between the recently reported current-mode and voltage-mode OTA-C filter structures using analytical synthesis methods, the active component number of the voltage mode is at least two more than that of the current mode. None of the previously reported voltage-mode even-nth-order OTA-C elliptic filter structures uses the minimum components. In the following presents a new kind of analytical synthesis method, different from the recently presented ones using all single-ended-input OTAs and all grounded capacitors, which will produce a voltage-mode even-nth-order elliptic filter structure with the minimum number of components using all single-ended-input OTAs and nearly all grounded capacitors but one floating capacitor.

Quadrature oscillators, which provide two sinusoidal signals with 90° phase difference, act as an essential role in many communication and instrumentation systems, for example, quadrature mixers and single-sideband generators in telecommunications and vector generators and selective voltmeters in measurement purposes, as well as in the physical characterization of microscopic particles and biological cells using the phenomenon of electro-rotation. In 1993, a quadrature oscillator was presented using two first-order all-pass filters (one of which is constructed using one operational amplifier (OA), three resistors and one floating capacitor) followed by an inverter. In 1998, a multiphase sinusoidal oscillator using inverting-mode operational amplifier also appeared. In 2000, using six current feedback operational amplifiers (CFAs) to construct a quadrature oscillator was given to designers. In 2002, the current differencing buffered amplifier (CDBA)-based quadrature oscillator was proposed employing two active elements, two grounded capacitors, and four floating resistors. And in 2005, three quadrature oscillators were reported using three second-generation current conveyors (CCIIs), three/five grounded capacitors, and five/three grounded resistors. On the other hand, for the purpose of avoiding the resistors used in the design and fabricated in the integrated circuit, operational trans-conductance amplifier (OTA) based quadrature oscillators were recommended such as (i) in 1997, using a first-order all-pass filter followed by an integrator was suggested to synthesize a quadrature oscillator constructed by two/three OTAs, three/two grounded/floating capacitors, and one voltage buffer; (ii) in 2000, an eight OTA and two grounded C quadrature oscillator with four quadrature outputs came into this world; and (iii) in 2002, using two lossy integrators followed by a lossless integrator or using three lossy integrators to construct a quadrature oscillator were published with the topology of three or five OTAs in addition to three grounded capacitors. However, none of recently reported OTA-C quadrature oscillators employ the minimum number of active and passive components. In this paper, three quadrature oscillators with the minimum number of components are presented with three different kinds of characteristics, i.e., (i) having the condition of oscillation (CO) and the frequency of oscillation (FO) but without the orthogonal control for both CO and FO—the minimum components are two OTAs and two capacitors, (ii) having CO and FO and with the orthogonal control for both CO and FO—the minimum components are three OTAs and two capacitors, and (iii) having only FO but without CO and the orthogonal control for both CO and FO—the minimum components are two OTAs and two capacitors. Three important criteria for the design of OTA-C circuits [7], namely, (i) the use of only single-ended-input OTAs for overcoming feed-through effects, (ii) employing only grounded capacitors for absorbing the shunt parasitic capacitances, and (iii) utilizing only the minimum number of active and passive components for minimizing the power consumption, chip area, and noise, making the total parasitics in the structure to be minimum and thus resulting in a very precise response, are achieved by the above latter two new cases using the following new Analytical Synthesis Method (ASM) which has been illustrated and demonstrated in the recent literature. When all of the parasitic capacitances are located at the same positions as the two given capacitors it is then possible to replace given capacitors with all of the parasitic capacitances without changing the network topology and the output oscillation due to no conditions of oscillation necessary for the third case. It makes the OTA-only-without-C oscillator come into this world.

### BRIEF SUMMARY

The new Analytical Synthesis Methods (ASMs) have been clearly and effectively demonstrated in the realization of current/voltage-mode Operational Trans-conductance Amplifier and Capacitor (OTA-C) circuits, where a complicated nth-order transfer function is manipulated and decomposed by a succession of innovative algebra operations until a set of simple equations are produced, which are then realized using n integrators and a constraint circuitry.

The circuits realized includes a plurality of voltage-mode nth-order OTA-C universal filter structures, a plurality of tunable voltage/current-mode OTA-C universal biquad filters, a plurality of voltage-mode odd/even-nth-order OTA-C elliptic filter structures, a plurality of voltage/current-mode odd-nth-order OTA-C elliptic high-pass filter structures, and a plurality of OTA-C quadrature oscillators. Some realized OTA-C circuits can be simplified to be OTA-only (OTA-parasiic C) circuits which fit for the operation at high frequencies.

The tuning technique to improve the precision of all output parameters is presented using the following steps: At step (i) the increment or decrement tendency of an output parameter when an individual component varies is determined, At step (ii), the relationships of step (i) among all output parameters is obtained. At step (iii), a non-contradictive approach to improve the precision of all output parameters is determined.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1-1 illustrates a voltage-mode n-th order OTA-C universal filter structure with equal capacitances according to an embodiment of the present invention;

FIG. 1-2 illustrates a voltage-mode n-th order OTA-C universal filter structure with equal transconductance according to an embodiment of the present invention;

FIG. 1-3 illustrates amplitude response of the biquad derived from FIG. 1-1 (∘, LP; □, HP; , BP; and x, BR or notch);

FIG. 1-4 illustrates amplitude response of the biquad [25] (∘, LP; □, HP; , BP; and x, BR or notch) according to an embodiment of the present invention;

FIG. 1-5 illustrates amplitude response of the biquad [26] (∘, LP; □, HP; , BP; and x, BR or notch) according to an embodiment of the present invention;

FIG. 1-6 illustrates a phase frequency responses of the AP biquads (-, theoretical; ∘ for FIG. 1; for [25]; and x for [26]) according to an embodiment of the present invention;

FIG. 1-7 illustrates a simulated low-pass response of the new universal biquad according to an embodiment of the present invention;

FIG. 1-8 illustrates a simulated band-pass response of the new universal biquad according to an embodiment of the present invention;

FIG. 1-9 illustrates a simulated high-pass response of the new universal biquad according to an embodiment of the present invention;

FIG. 1-10 illustrates a simulated band-reject response of the new universal biquad according to an embodiment of the present invention;

FIG. 1-11 illustrates a simulated all-pass phase response of the new universal biquad according to an embodiment of the present invention;

FIG. 1-12 illustrates an amplitude-frequency responses before (black line) and after (red line) tuning for the low-pass biquad according to an embodiment of the present invention;

FIG. 1-13 illustrates an amplitude-frequency responses before (black line) and after (red line) tuning for the high-pass biquad according to an embodiment of the present invention;

FIG. 1-14 illustrates an amplitude-frequency responses before (black line) and after (red line) tuning for the band-pass biquad according to an embodiment of the present invention;

FIG. 1-15 illustrates a phase-frequency responses before (black line) and after (red line) tuning for the all-pass biquad according to an embodiment of the present invention;

FIG. 1-16 illustrates an amplitude-frequency responses after tuning for the band-reject biquad according to an embodiment of the present invention;

FIG. 2.1 illustrates an OTA-C sub-circuit realized from Eq. (2.8) according to another embodiment of the present invention;

FIG. 2.2 OTA-C sub-circuit realized from Eq. (2.9) according to another embodiment of the present invention;

FIG. 2.3 illustrates a tunable voltage-mode OTA-C universal biquad according to another embodiment of the present invention;

FIG. 2.4 illustrates an OTA-C sub-circuit realized from Eq. (2.27) according to another embodiment of the present invention;

FIG. 2.5 illustrates an OTA-C sub-circuit realized from Eq. (2.29) according to another embodiment of the present invention;

FIG. 2.6 illustrates an OTA-C circuit realized from Eq. (2.13) and (2.14) according to another embodiment of the present invention

FIG. 2.7 illustrates a current-mode OTA-C universal biquad according to another embodiment of the present invention;

FIG. 2.8 illustrates an amplitude-frequency responses of the biquad illustrated in FIG. 2.7 (∘, LP; □, HP; , BP; and x, BR or notch) according to another embodiment of the present invention;

FIG. 2.9 illustrates an amplitude-frequency responses of the biquad illustrated in FIG. 2.3 (∘, LP; □, HP; , BP; and x, BR or notch) according to another embodiment of the present invention;

FIG. 2.10 illustrates an amplitude-frequency responses of the biquad (∘, LP; □, HP; , BP; and x, BR or notch) according to a related art;

FIG. 2.11 illustrates an amplitude-frequency responses of the biquad (∘, lowpass; □, highpass; , bandpass; and x, bandreject or notch) according to another related art;

FIG. 2.12 illustrates phase response of the AP biquads (-, theoretical; ∘ for FIG. 2.7; □ for FIG. 2.3 [20]; for [25]; and x for [26]) according to another embodiment of the present invention;

FIG. 2.13 illustrates low-pass comparison of both FIGS. 2.3 and 2.7 at 950 MHz according to another embodiment of the present invention;

FIG. 2.14 illustrates high-pass comparison of both FIGS., 2.3 and 2.7 at 250 MHz according to another embodiment of the present invention;

FIG. 2.15 illustrates band-pass comparison of both FIGS., 2.3 and 2.7 at 50 and 200 MHz according to another embodiment of the present invention;

FIG. 2.16 illustrates band-reject comparison of both FIGS., 2.7 and 2.3 at 50 MHz according to another embodiment of the present invention;

FIG. 2.17 illustrates all-pass phase comparison of both FIGS., 2.3 and 2.7 at 750 MHz according to another embodiment of the present invention;

FIG. 2.18 illustrates the relationship between sensitivity and frequency for the current mode low-pass biquad illustrated in FIG. 2.7;

FIG. 2.19 illustrates the relationship between sensitivity and frequency for the voltage mode low-pass biquad illustrated in FIG. 2.3

FIG. 2.20 illustrates the current and voltage-mode low-pass output responses before tuning the component values according to another embodiment of the present invention;

FIG. 2.21 illustrates current and voltage-mode low-pass output responses after tuning the component values;

FIG. 2.22 illustrates the relationship between sensitivity and frequency for the current mode high-pass biquad illustrated in FIG. 2.7;

FIG. 2.23 illustrates the relationship between sensitivity and frequency for the voltage mode high-pass biquad illustrated in FIG. 2.3;

FIG. 2.24 illustrates the current-mode high-pass output responses before and after tuning the component values according to another embodiment of the present invention;

FIG. 2.25 illustrates the voltage-mode high-pass output responses before and after tuning the component values according to another embodiment of the present invention;

FIG. 2.26 illustrates the current-mode band-pass output responses before and after tuning the component values according to another embodiment of the present invention;

FIG. 2.27 illustrates the voltage-mode band-pass output responses before and after tuning the component values according to another embodiment of the present invention;

FIG. 2.28 illustrates the relationship between sensitivity and frequency for the current mode high-pass biquad illustrated in FIG. 2.7 according to another embodiment of the present invention;

FIG. 2.29 illustrates the relationship between sensitivity and frequency for the voltage mode high-pass biquad illustrated in FIG. 2.3;

FIG. 2.30 illustrates the current-mode band-reject output responses before and after tuning the component values according to another embodiment of the present invention;

FIG. 2.31 illustrates voltage-mode band-reject output responses before and after tuning the component values according to another embodiment of the present invention;

FIG. 2.32 illustrates the relationship between sensitivity and frequency for the current mode all-pass biquad illustrated in FIG. 2.7;

FIG. 2.33 illustrates the relationship between sensitivity and frequency for the voltage mode all-pass biquad illustrated in FIG. 2.3;

FIG. 2.34 illustrates the current-mode all-pass output responses before and after tuning the component values according to another embodiment of the present invention;

FIG. 2.35 illustrates the voltage-mode all-pass output responses before and after tuning the component values according to another embodiment of the present invention;

FIG. 2.36 illustrates the current-mode OTA-only low-pass simulation result according to another embodiment of the present invention;

FIG. 2.37 illustrates voltage-mode OTA-only low-pass simulation result according to another embodiment of the present invention;

FIG. 2.38 illustrates the current-mode high-pass output responses before (real line) and after (virtual line) withdrawing the capacitors according to another embodiment of the present invention;

FIG. 2.39 illustrates the current-mode OTA-only band-pass responses before (virtual line) and after (real line) tunings according to another embodiment of the present invention;

FIG. 2.40 illustrates the voltage-mode OTA-only band-pass responses before (virtual line) and after (real line) tunings according to another embodiment of the present invention;

FIG. 2.41 illustrates phase-frequency simulation results before (real line) and after (virtual line) tunings of the current-mode OTA-only all-pass biquad according to another embodiment of the present invention;

FIG. 3.1 illustrates OTA-C realization of Eq. (3.8-1) according to yet another embodiment of the present invention;

FIG. 3.2 illustrates OTA-C realization of Eq. (3.8-n-2) according to yet another embodiment of the present invention;

FIG. 3.3 illustrates OTA-C realization of Eq. (3.8-n) according to yet another embodiment of the present invention

FIG. 3.4 illustrates a voltage-mode odd-nth-order OTA-C elliptic filter according to yet another embodiment of the present invention;

FIG. 3.5 illustrates a voltage-mode third-order OTA-C elliptic filter according to yet another embodiment of the present invention;

FIG. 3.6 illustrates comparison between the simulation result and the theoretical curve of the new third-order OTA-C elliptic filter according to yet another embodiment of the present invention;

FIG. 3.7 illustrates the relationship between the sensitivity fp and the transconductance according to yet another embodiment of the present invention;

FIG. 3.8 illustrates the relationship between the sensitivities fs and the transconductance according to yet another embodiment of the present invention;

FIG. 3.9 illustrates the relationship between the sensitivity A1 and the transconductance according to yet another embodiment of the present invention;

FIG. 3.10 illustrates the relationship between the sensitivity A2 and the transconductance according to yet another embodiment of the present invention;

FIG. 4.1 illustrates an OTA implementation of Iout(i)(ai/bi) according to still another embodiment of the present invention;

FIG. 4.2 illustrates an OTA−C implementation of Iout(n−1)(ans/bn−1) according to still another embodiment of the present invention;

FIG. 4.3 illustrates an OTA-C implementation of Eq. (4.13a) according to still another embodiment of the present invention;

FIG. 4.4 illustrates a current-mode odd-nth-order OTA-C elliptic high-pass filter structure;

FIG. 4.5 illustrates a current-mode 3rd-order OTA-C elliptic high-pass filter according to still another embodiment of the present invention;

FIG. 5.1 illustrates an OTA-C implementation realized from Eq. (5.9-1) according to still another embodiment of the present invention;

FIG. 5.2 illustrates an OTA-C implementation realized from Eq. (5.9-n-2) according to still another embodiment of the present invention;

FIG. 5.3 illustrates an OTA-C implementation realized from Eq. (5.9-n-1) according to still another embodiment of the present invention;

FIG. 5.4 illustrates an OTA-C implementation realized from Eq. (5.9-n) according to still another embodiment of the present invention;

FIG. 5.5 illustrates a voltage-mode odd-nth-order OTA-C elliptic high-pass filter structure according to still another embodiment of the present invention;

FIG. 5.6 illustrates a third-order OTA-C elliptic high-pass filter according to still another embodiment of the present invention;

FIG. 6.1 illustrates a VM even-nth-order OTA-C elliptic filter structure with the minimum components according to still another embodiment of the present invention;

FIG. 6.2 illustrates a VM fourth-order elliptic (a) low-pass and (b) high-pass filter amplitude-frequency responses according to still another embodiment of the present invention;

### DETAILED DESCRIPTION

The new Analytical Synthesis Methods (ASMs) have been clearly and effectively demonstrated in the realization of current/voltage-mode Operational Trans-conductance Amplifier and Capacitor (OTA-C) circuits, where a complicated nth-order transfer function is manipulated and decomposed by a succession of innovative algebra operations until a set of simple equations are produced, which are then realized using n integrators and a constraint circuitry.

The circuits realized includes a plurality of voltage-mode nth-order OTA-C universal filter structures, a plurality of tunable voltage/current-mode OTA-C universal biquad filters, a plurality of voltage-mode odd/even-nth-order OTA-C elliptic filter structures, a plurality of voltage/current-mode odd-nth-order OTA-C elliptic high-pass filter structures, and a plurality of OTA-C quadrature oscillators. Some realized OTA-C circuits can be simplified to be OTA-only (OTA-parasiic C) circuits which fit for the operation at high frequencies.

The tuning technique to improve the precision of all output parameters is also presented using the following steps. At step (i), the increment or decrement tendency of an output parameter when an individual component varies is determined. At step (ii), the relationships of (i) among all output parameters and is obtained. At step (iii), a non-contradictive approach to improve the precision of all output parameters is determined.

The detailed descriptions of the new Analytical Synthesis Methods, the corresponding realized circuit structures, and the tuning technique stated above are illustrated as below. Note that OTA-based circuit structures can be replaced by the equivalent active element (such as the second-generation current controlled conveyor, namely, CCCII)-based circuit structures.

1. Analytical Synthesis Method of the Voltage-Mode High-Order OTA-C Universal Filter Structures

The advantages of the Analytical Synthesis Methods (ASMs) have been clearly and effectively demonstrated in the realization of high-order current/voltage-mode Operational Trans-conductance Amplifier and Capacitor (OTA-C) filters, where a complicated nth-order transfer function is manipulated and decomposed by a succession of innovative algebra operations until a set of simple equations are produced, which are then realized using n integrators and a constraint circuitry. In fact, the new Analytical Synthesis Method can be used in the design of any kind of linear system with a stable transfer function. The ASM is carried out according to the following steps. At step 1 the “decomposition” of a complicated nth-order transfer function into a set of simple and realizable equations. At step 2, the “realization” of each simple equation obtained from step 1 to a corresponding simple sub-circuitry. At step 3, the “combination” of all the simple sub-circuitries for constructing the whole complicated circuit structure. This section describes new ASMs for the realization of high-order voltage-mode high-order OTA-C universal filter structures. Since (i) the single-ended-input OTA has nearly half quantity of the parasitics when compared to the differential-input OTA used in a circuit structure, (ii) grounded resistors and capacitors are with much lower parasitics than floating resistors and capacitors, and (iii) the minimum number of active and passive components lead to the lowest total parasitics, power consumption, noise, and integrated circuit area, when the above three criteria can not be simultaneously achieved for the voltage-mode circuit structure, it is a very interesting problem which kind of the tradeoff is the better one.

The voltage-mode nth-order universal filter transfer function may be expressed by the following equation.

$${V}_{out} = \frac{{\sum }_{j = 0}^{n} {V}_{i ( j )} ( {s}^{j} {a}_{j} )}{{\sum }_{j = 0}^{n} ( {s}^{j} {a}_{j} )} \qquad ( 1 \text{-} 1 )$$

To realize the highest-order and lowest-order terms, sPnPaBnB and aB0B, a minimum numbers of n capacitors and n transconductances (of OTAs) are needed, respectively; thus the minimum number of passive and active components required for synthesizing (1-1) is n capacitors and n OTAs. In order to employ the minimum number of active and passive components in the design, differential-input OTAs and floating capacitors are considered to be used in the following new analytical synthesis method.

Cross-multiplying (1-1), dividing by sPnPaBnB, and re-arranging the sequence of terms, following equations are obtained.

$${V}_{out} = ( \frac{{a}_{o}}{{s}^{n} {a}_{n}} ) ( {V}_{i ( o )} - {V}_{out} ) + ( \frac{{a}_{1}}{{s}^{n - 1} {a}_{n}} ) ( {V}_{i ( 1 )} - {V}_{out} ) + ( \frac{{a}_{2}}{{s}^{n - 2} {a}_{n}} ) ( {V}_{i ( 2 )} - {V}_{out} ) + … + ( \frac{{a}_{n - 2}}{{s}^{2} {a}_{n}} ) ( {V}_{i ( n - 2 )} - {V}_{out} ) + ( \frac{{a}_{n - 1}}{{sa}_{n}} ) ( {V}_{i ( n - 1 )} - {V}_{out} ) + {V}_{i ( n )} \qquad ( 1 \text{-} 2 )$$

Since

$$\begin{matrix}( \frac{{a}_{0}}{{s}^{n} {a}_{n}} ) = ( \frac{{a}_{n - 1}}{{sa}_{n}} ) ( \frac{{a}_{n - 2}}{{sa}_{n - 1}} ) … ( \frac{{a}_{2}}{{sa}_{3}} ) ( \frac{{a}_{1}}{{sa}_{2}} ) ( \frac{{a}_{0}}{{sa}_{1}} ) \\ and & ( 1 \text{-} 3 ) \\ ( \frac{{a}_{j}}{{s}^{n - j} {a}_{n}} ) = ( \frac{{a}_{n - 1}}{{sa}_{n}} ) ( \frac{{a}_{n - 2}}{{sa}_{n - 1}} ) … ( \frac{{a}_{j + 1}}{{sa}_{j + 2}} ) ( \frac{{a}_{j}}{{sa}_{j + 1}} ) \\ for j = 0 , 1 , 2 , 3 … , n - 1 , & ( 1 \text{-} 4 )\end{matrix}$$

taking out the same common factor of the right side of (1-2),

$${V}_{out} = {V}_{i ( n )} + ( \frac{{a}_{n - 1}}{{sa}_{n}} ) \{ \begin{matrix}( \frac{{a}_{n - 2}}{{sa}_{n - 1}} ) [ \begin{matrix}( \frac{{a}_{n - 3}}{{sa}_{n - 2}} ) [ \begin{matrix}… ( \frac{{a}_{2}}{{sa}_{3}} ) [ \begin{matrix}( \frac{{a}_{1}}{{sa}_{2}} ) [ \begin{matrix}( \frac{{a}_{0}}{{sa}_{1}} ) ( {V}_{i ( 0 )} - {V}_{out} ) \\ + {V}_{i ( 1 )} - {V}_{out}\end{matrix} ] \\ + {V}_{i ( 2 )} - {V}_{out}\end{matrix} ] \\ + {V}_{i ( n - 3 )} - {V}_{out}\end{matrix} ] \\ + {V}_{i ( n - 2 )} - {V}_{out}\end{matrix} ] \\ + {V}_{i ( n - 1 )} - {V}_{out}\end{matrix} \} \qquad ( 1 \text{-} 5 )$$

A. Part I: Equal Capacitance Approach:

Observing (1-5), assuming

$${V}_{1} = ( \frac{( {a}_{0} / {a}_{1} )}{s} ) ( {V}_{i ( 0 )} - {V}_{out} ) + {V}_{i ( 1 )}$$

which is equivalent to

$$( {V}_{1} - {V}_{i ( 1 )} ) s = ( \frac{{a}_{0}}{{a}_{1}} ) ( {V}_{i ( 0 )} - {V}_{out} ) \\ and \\ {V}_{j} = ( \frac{( {a}_{j - 1} / {a}_{j} )}{s} ) ( {V}_{i ( j - 1 )} - {V}_{out} ) + {V}_{i ( j )} \\ for j = 2 , 3 … , n - 1 , n , \qquad ( 1 \text{-} 6 \text{-} 1 )$$

which is equivalent to

$$( {V}_{j} - {V}_{i ( j )} ) s = ( \frac{{a}_{j - 1}}{{a}_{j}} ) ( {V}_{i ( j - 1 )} - {V}_{out} ) \\ for j = 2 , 3 … , n - 1 , n , \qquad ( 1 \text{-} 6 \text{-} j )$$

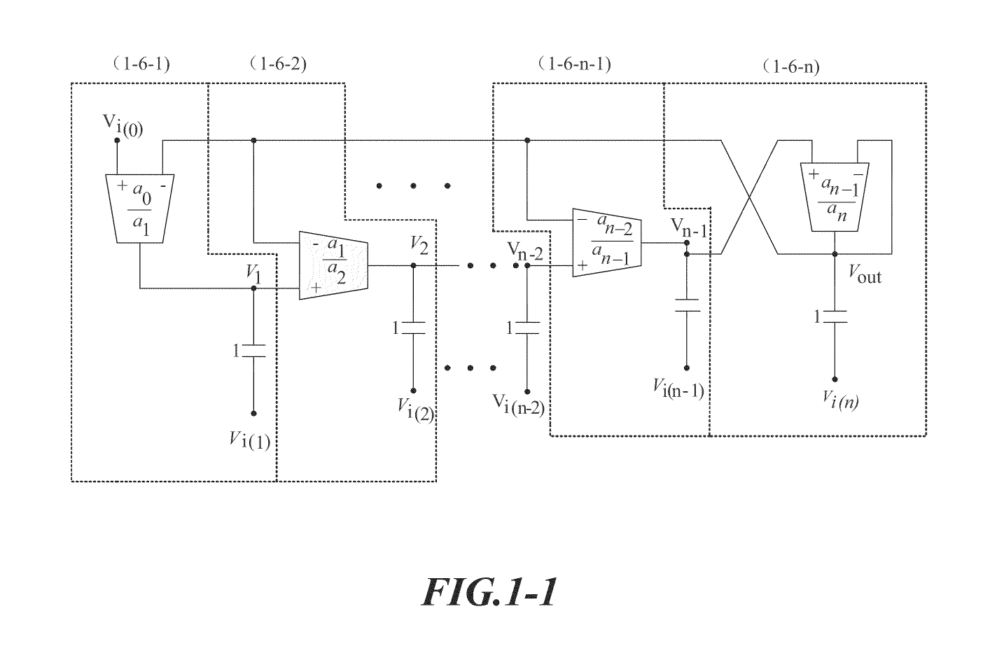

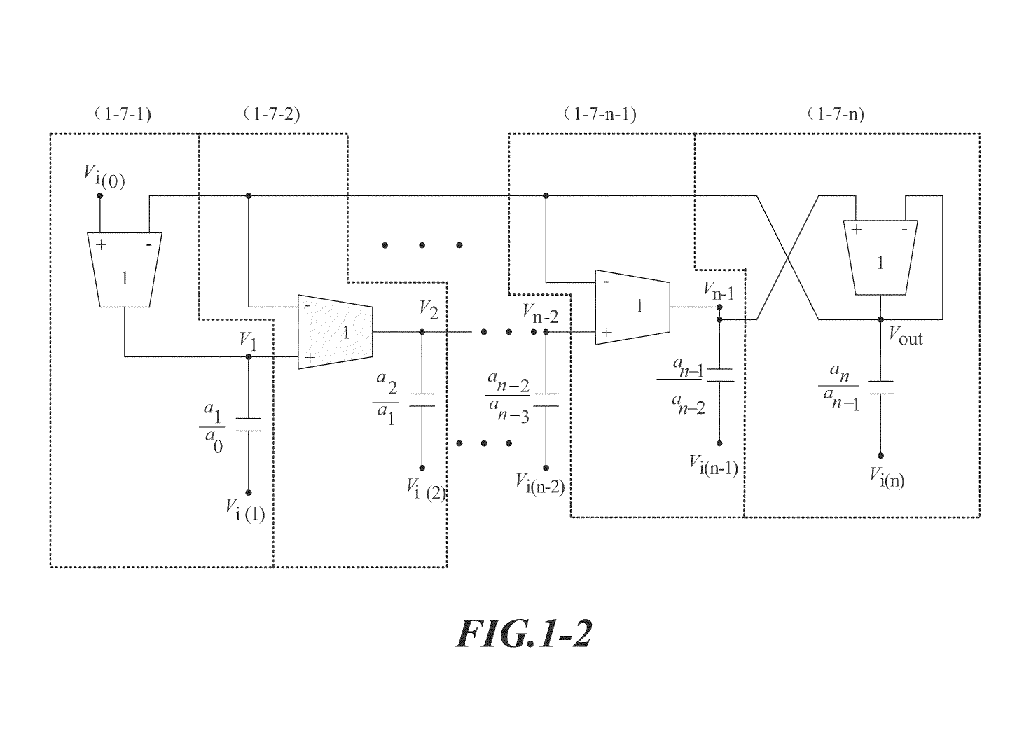

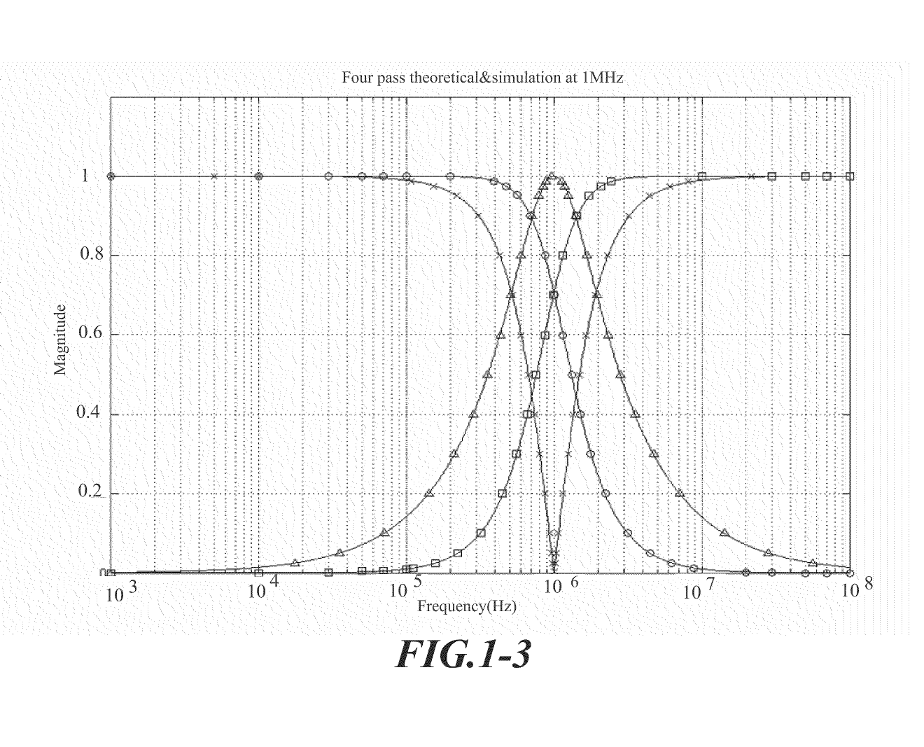

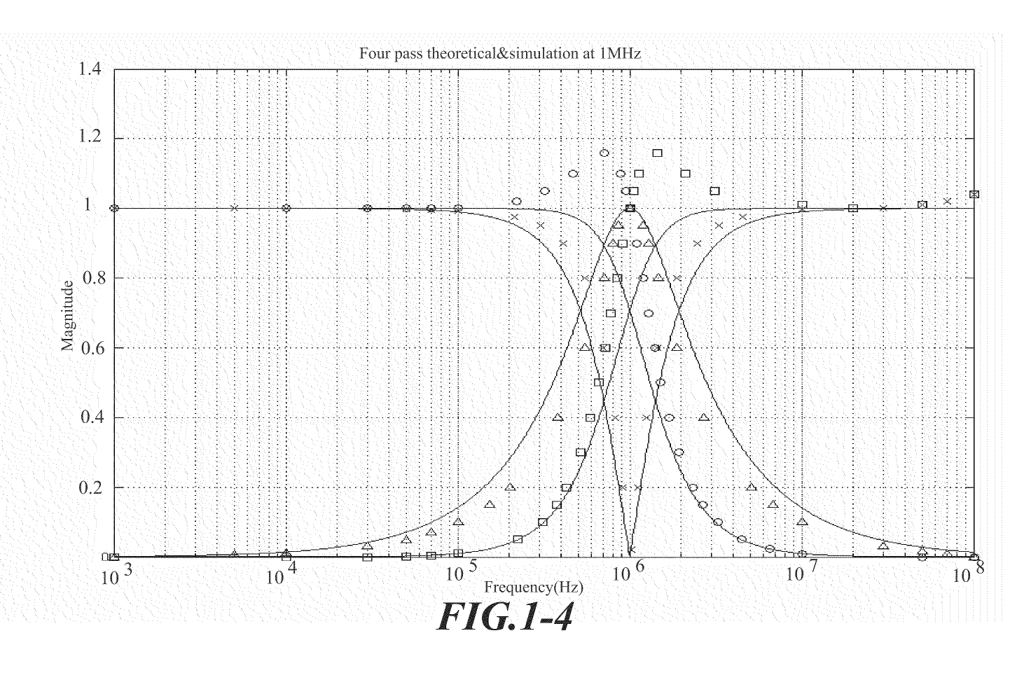

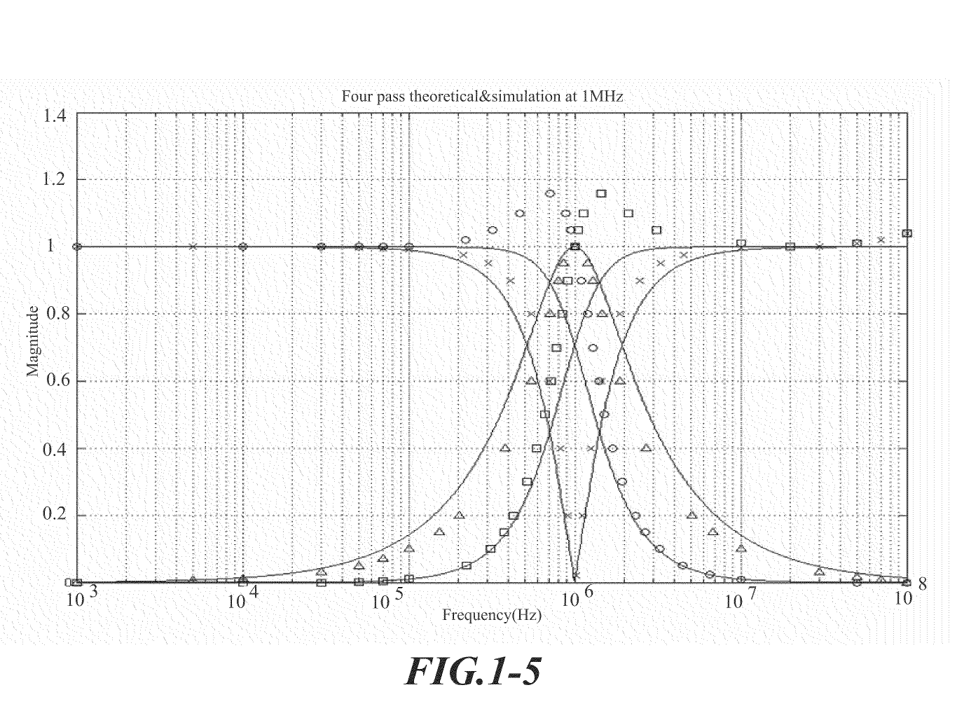

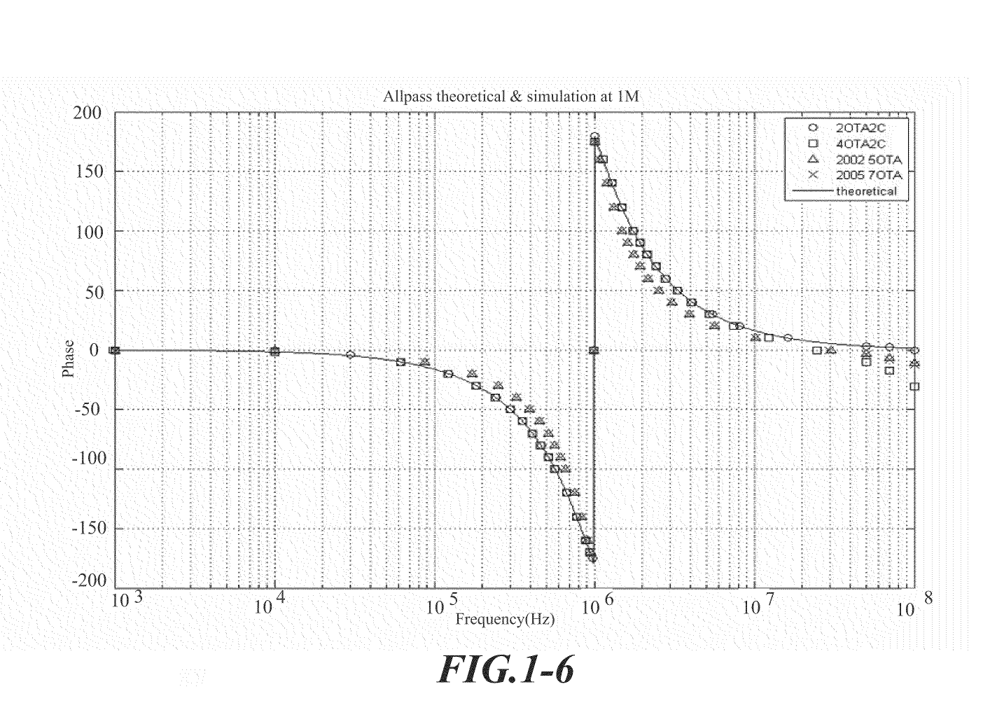

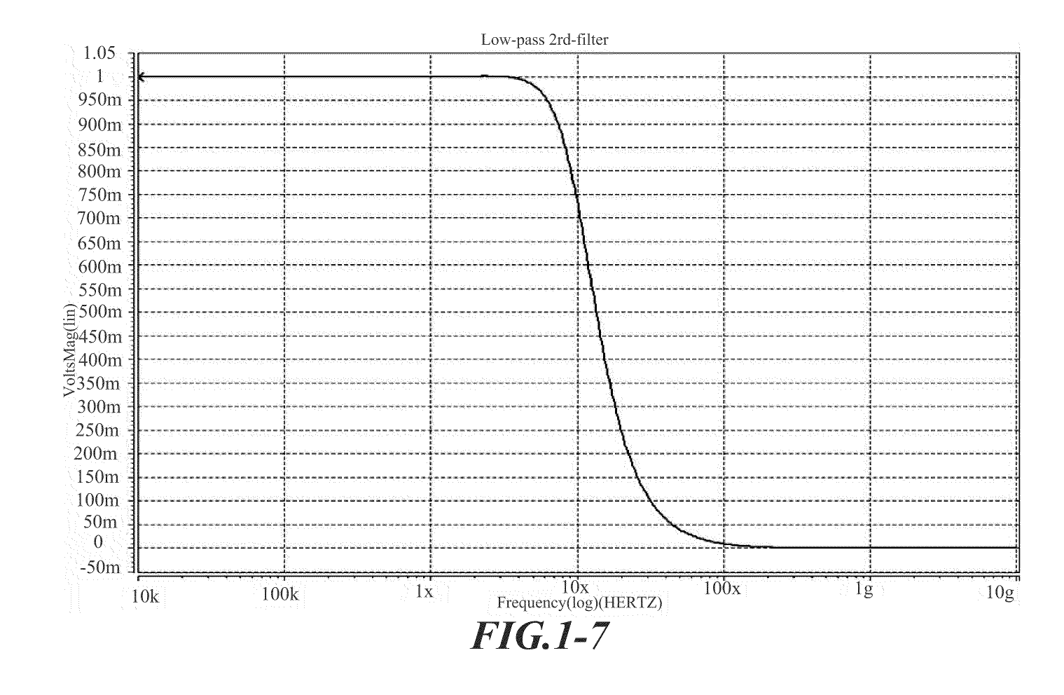

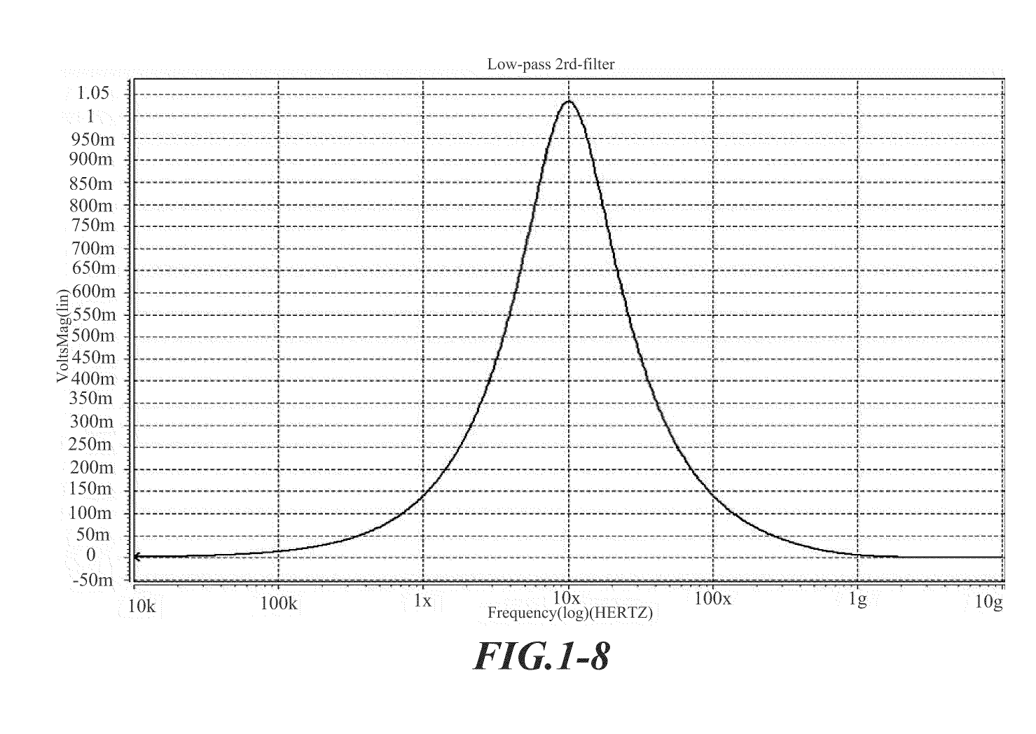

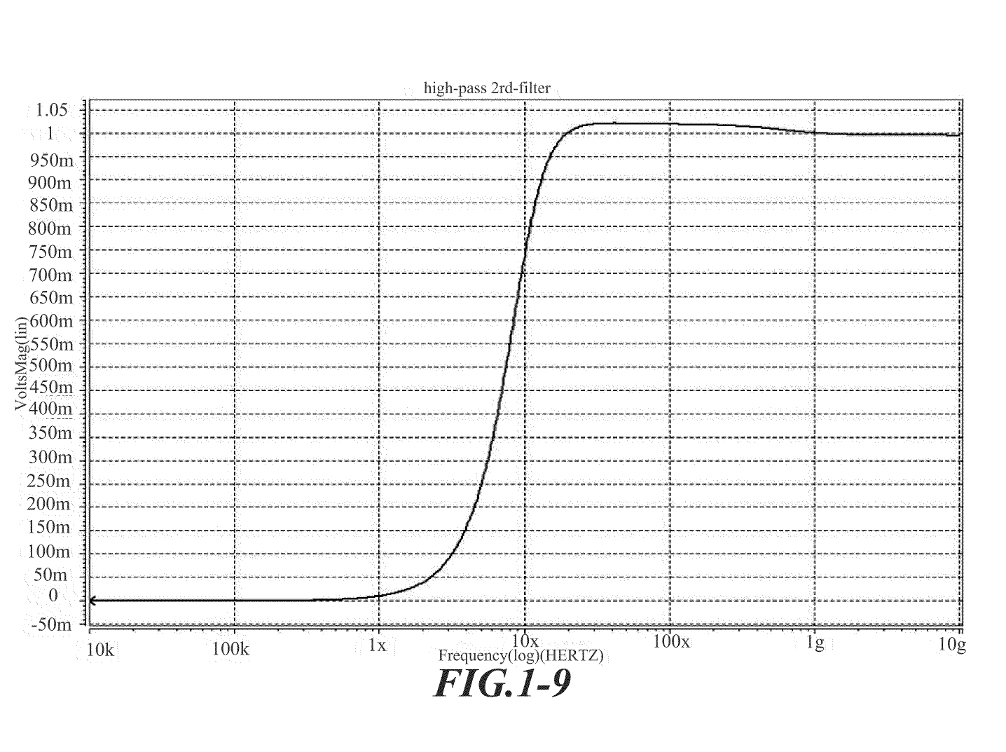

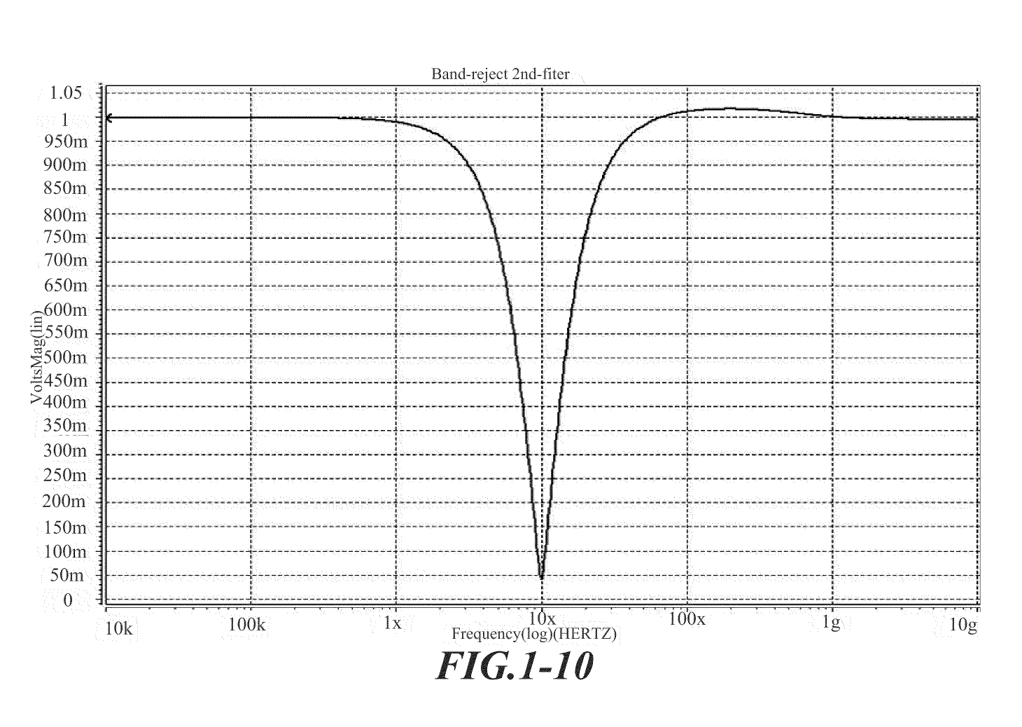

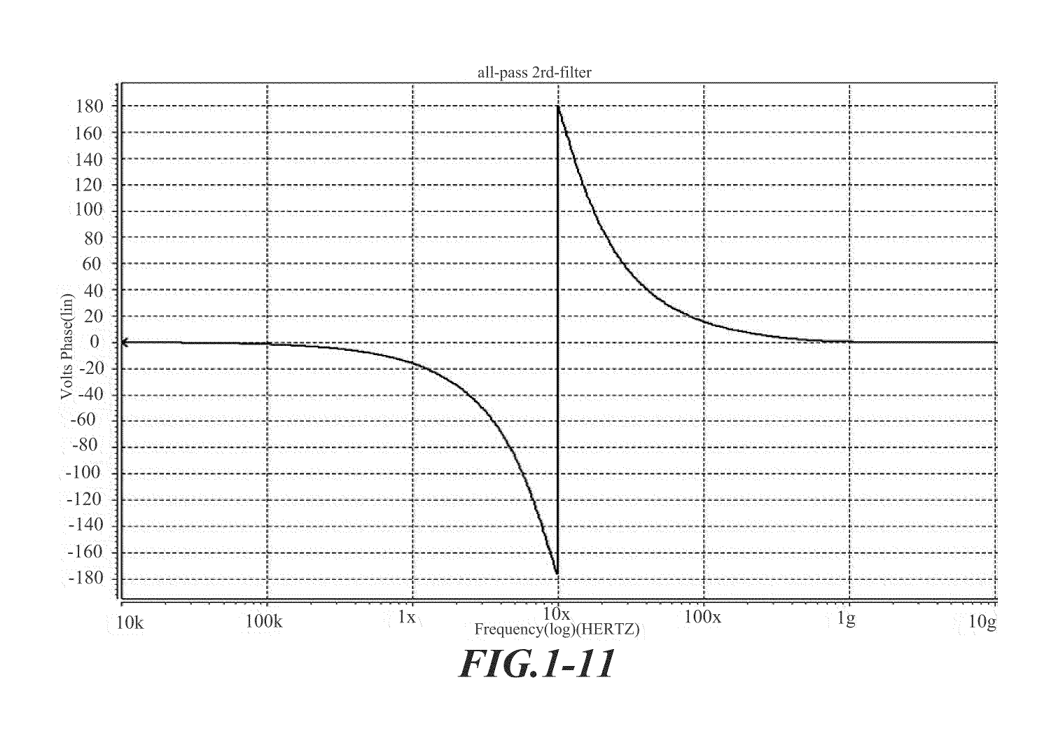

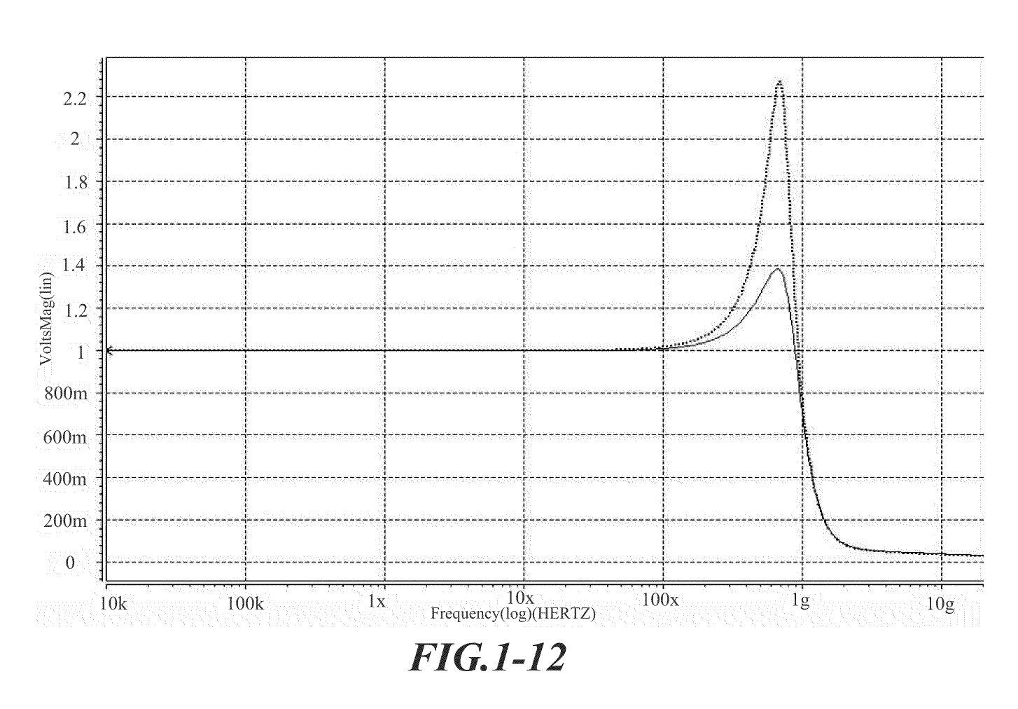

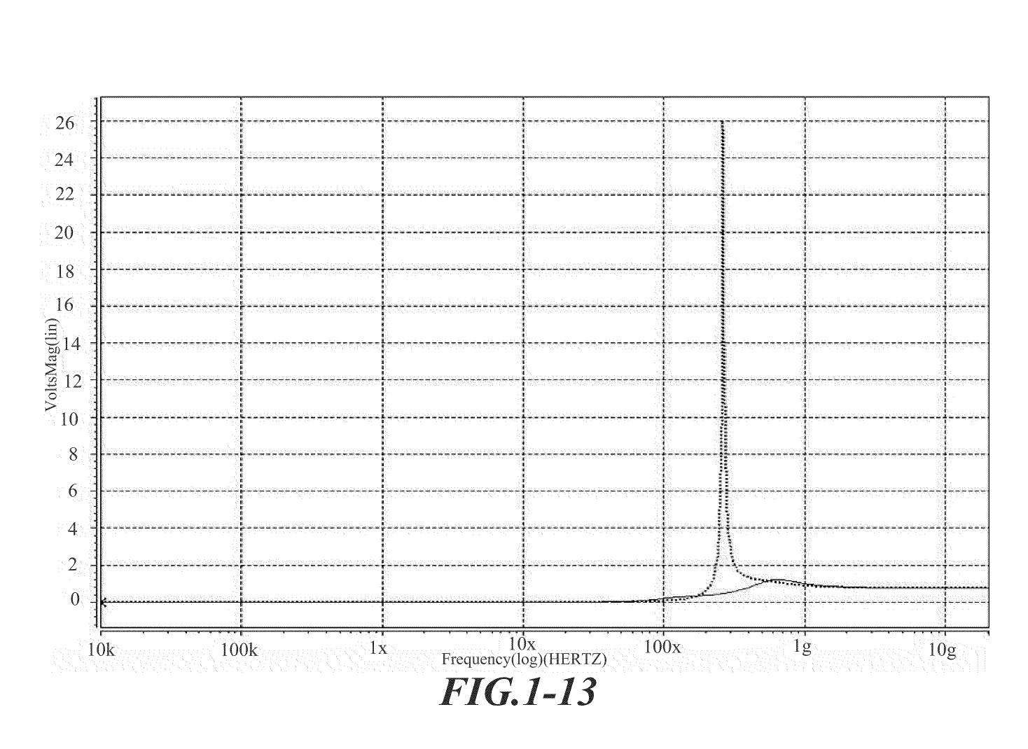

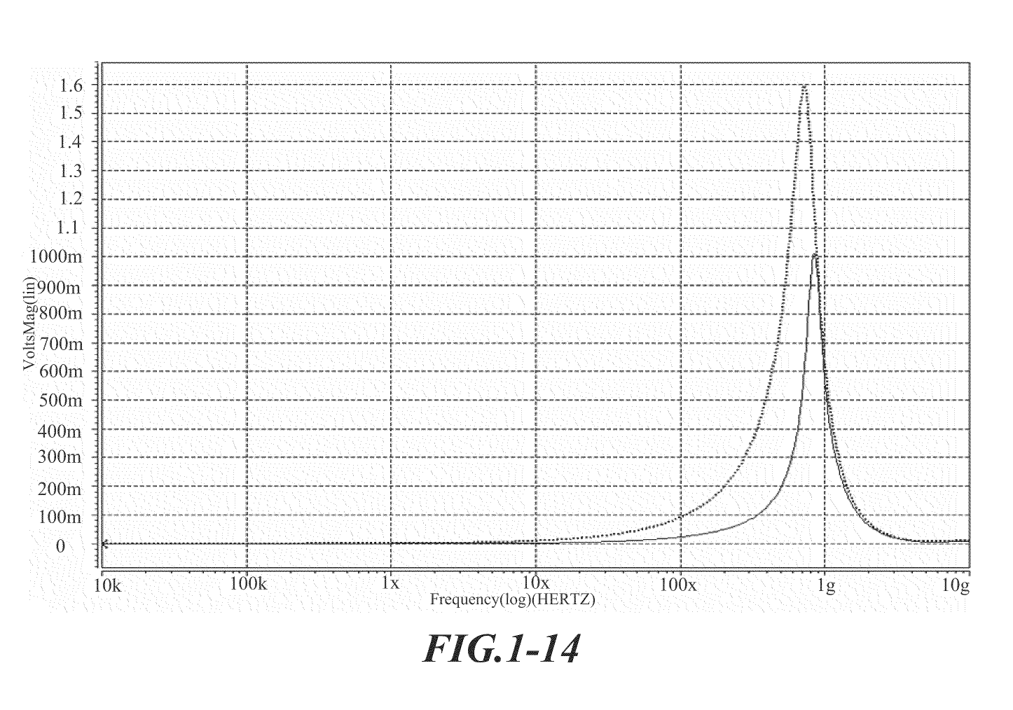

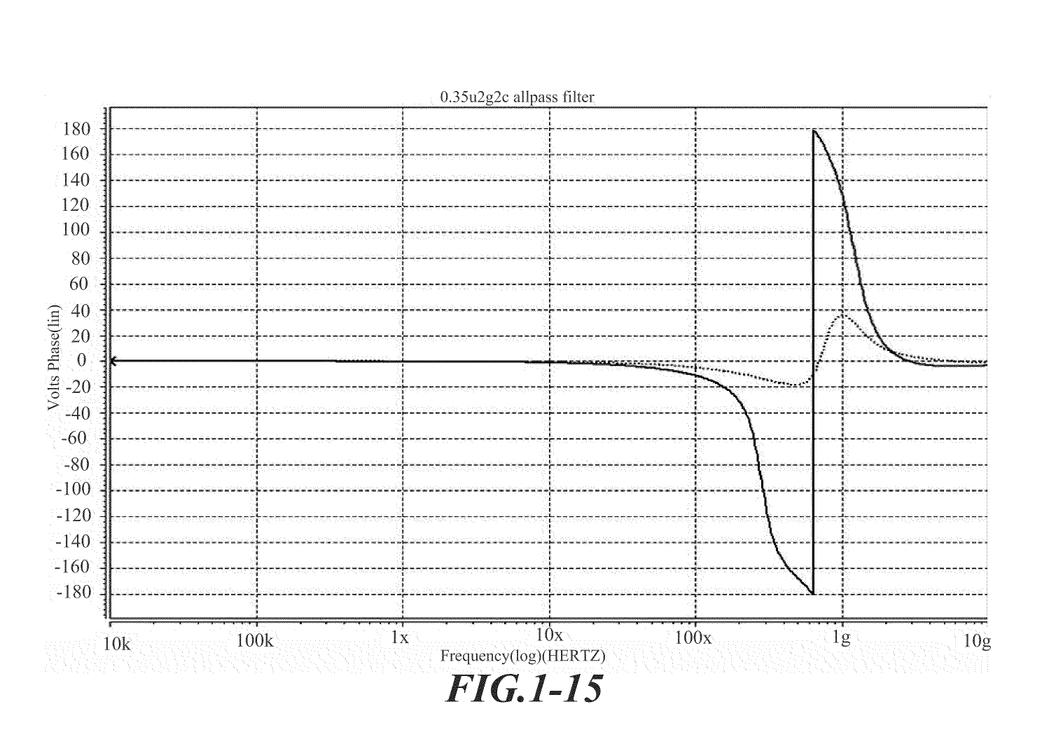

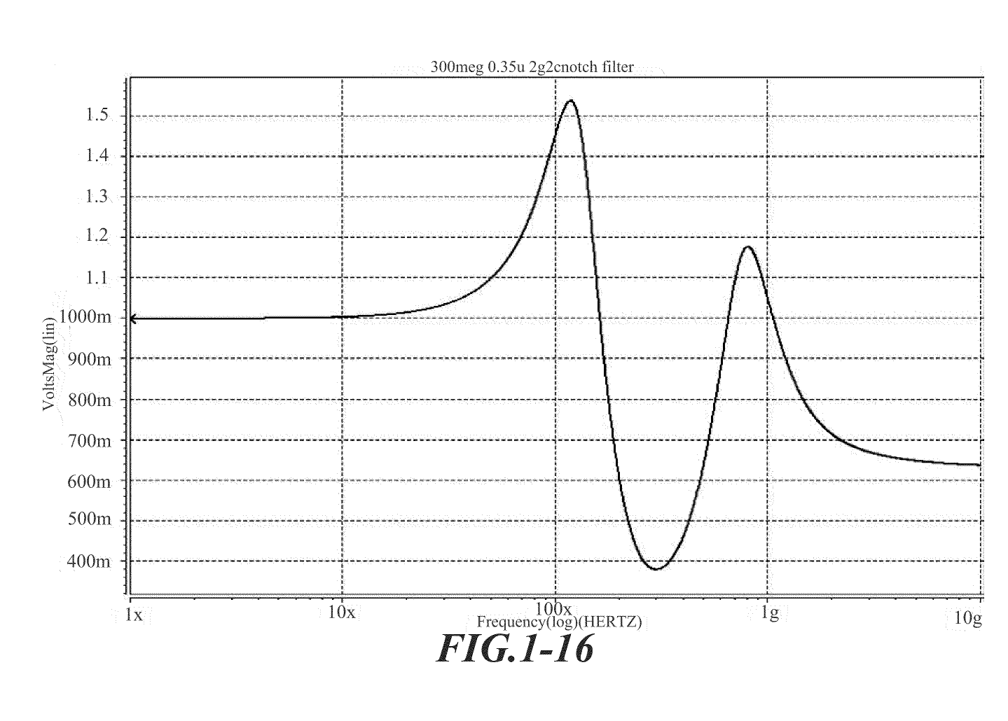

and VBoutB=VBnB. Each of the above equations is simple and easy to be realized using a differential-input OTA, with a transconductance of aBj-1B/aBjB, and a floating capacitor with unit capacitance. The OTA-C realizations of these simple first-order equations, (1-6-1), (1-6-2), (1-6-n-1), and (1-6-n), are presented in the dashed line blocks from the left to the right, respectively, in FIG. 1-1, which illustrates the new voltage-mode nth-order OTA-C universal filter structure with the minimum number of active and passive components, namely., n differential-input OTA and n floating capacitors. In particular, all of the capacitances are of equal value. Equal-valued capacitance design overcomes and eliminates the difficulty of precise variation of capacitances in IC fabrication.

B. Part II: Equal Transconductance Approach:

Observing (1-5), assuming

$${V}_{1} = ( \frac{1}{s ( {a}_{1} / {a}_{0} )} ) ( {V}_{i ( 0 )} - {V}_{out} ) - {V}_{i ( 1 )}$$

which is equivalent to

$$( {V}_{1} - {V}_{i ( 1 )} ) ( s \frac{{a}_{1}}{{a}_{0}} ) = ( 1 ) ( {V}_{i ( 0 )} - {V}_{out} ) \\ {V}_{j} = ( \frac{1}{s ( {a}_{j} / {a}_{j - 1} )} ) ( {V}_{i ( j - 1 )} - {V}_{out} ) + {V}_{i ( j )} \\ for j = 2 , 3 … , n - 1 , n \qquad ( 1 \text{-} 7 \text{-} 1 )$$

which is equivalent to

$$( {V}_{j} - {V}_{i ( j )} ) ( s \frac{{a}_{j}}{{a}_{j - 1}} ) = ( 1 ) ( {V}_{i ( j - 1 )} - {V}_{out} ) \\ for j = 2 , 3 … , n - 1 , n \qquad ( 1 \text{-} 7 \text{-} j )$$

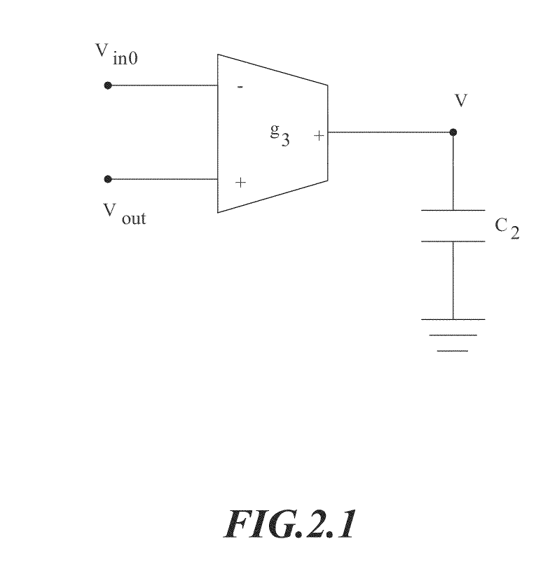

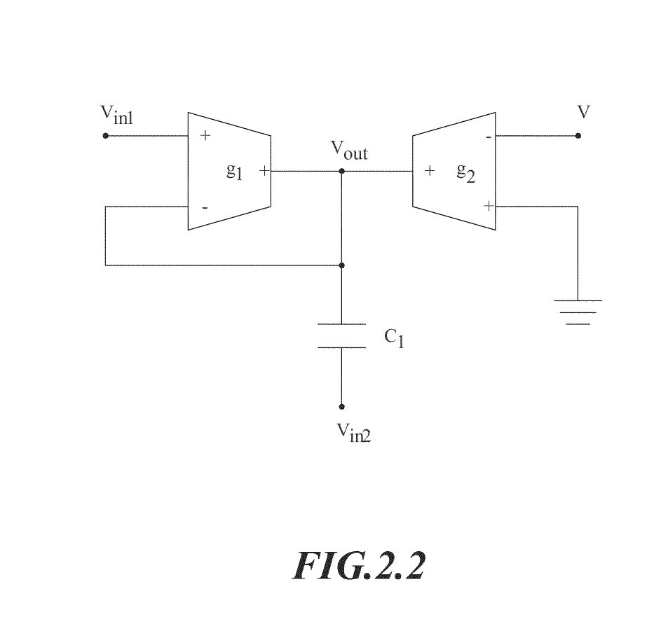

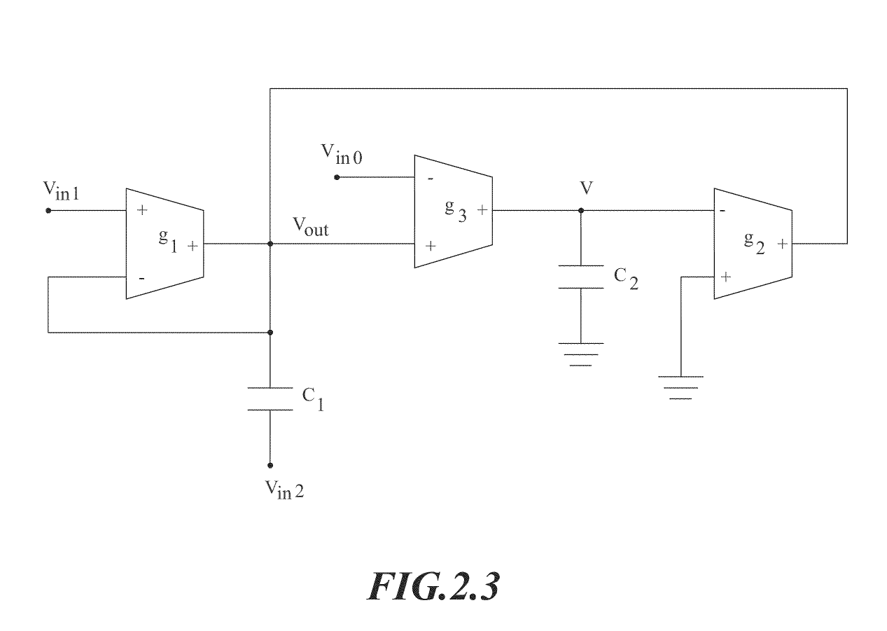

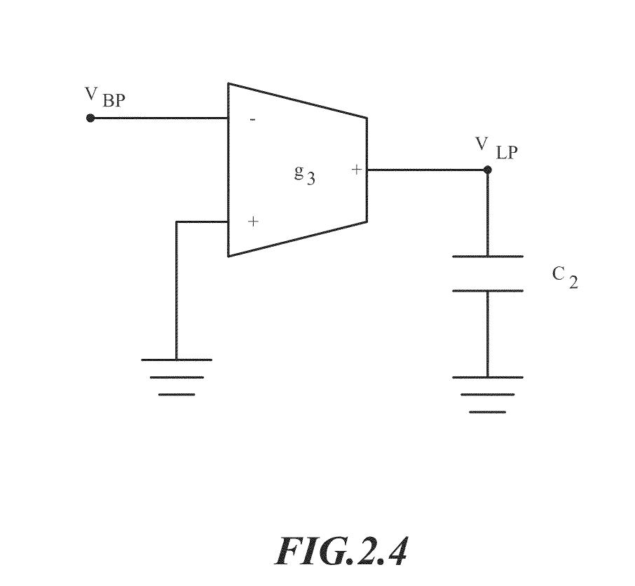

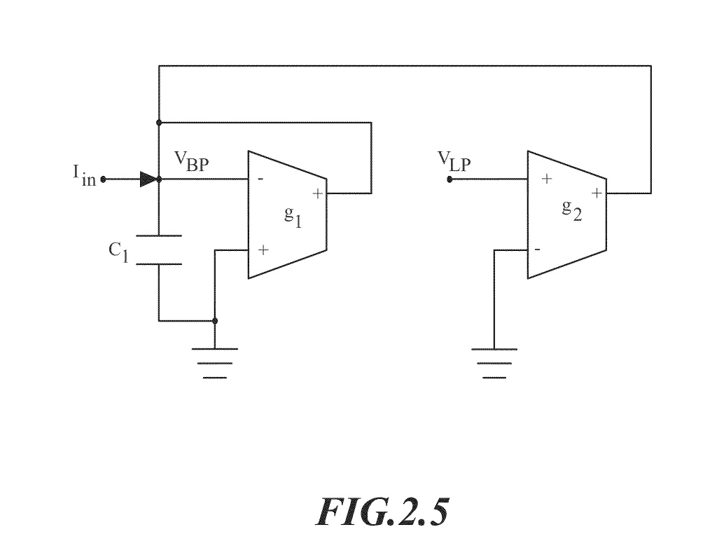

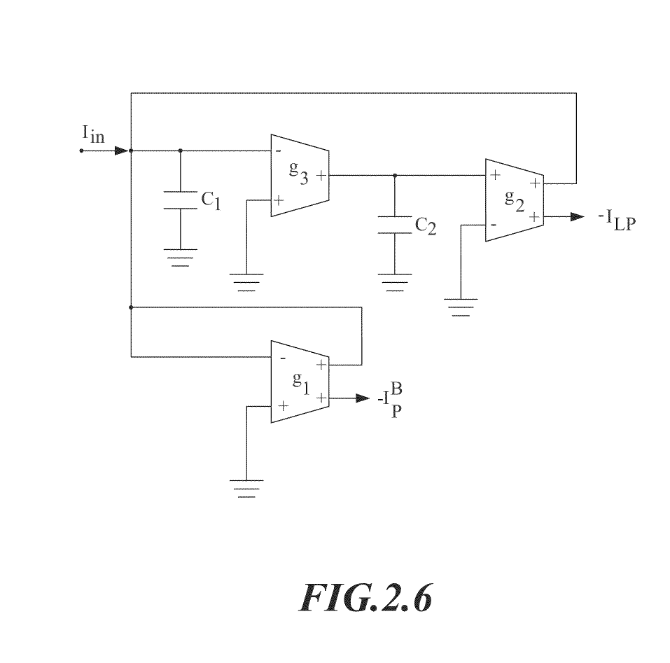

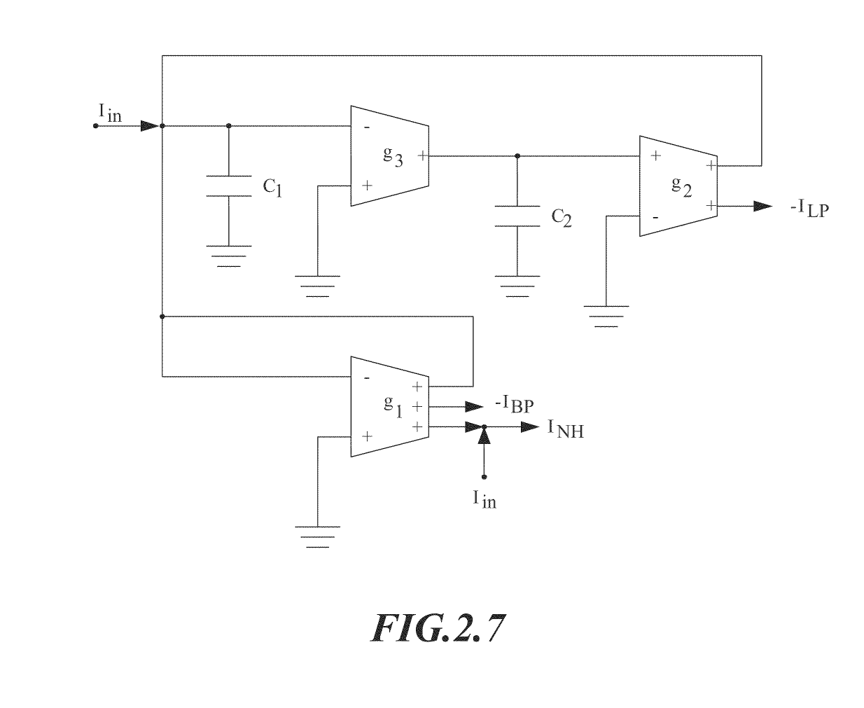

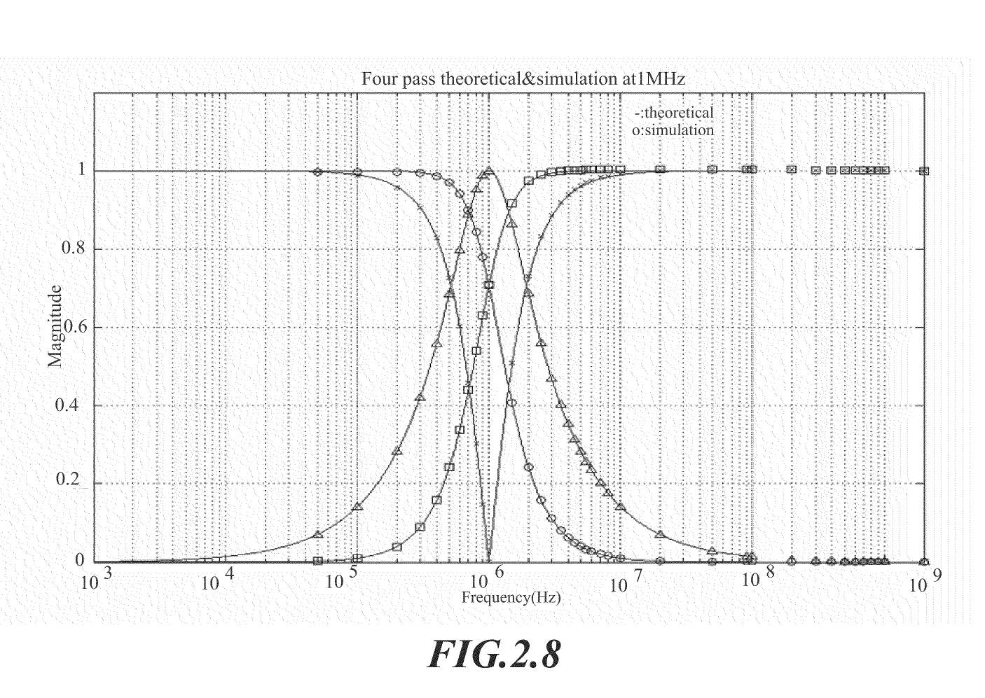

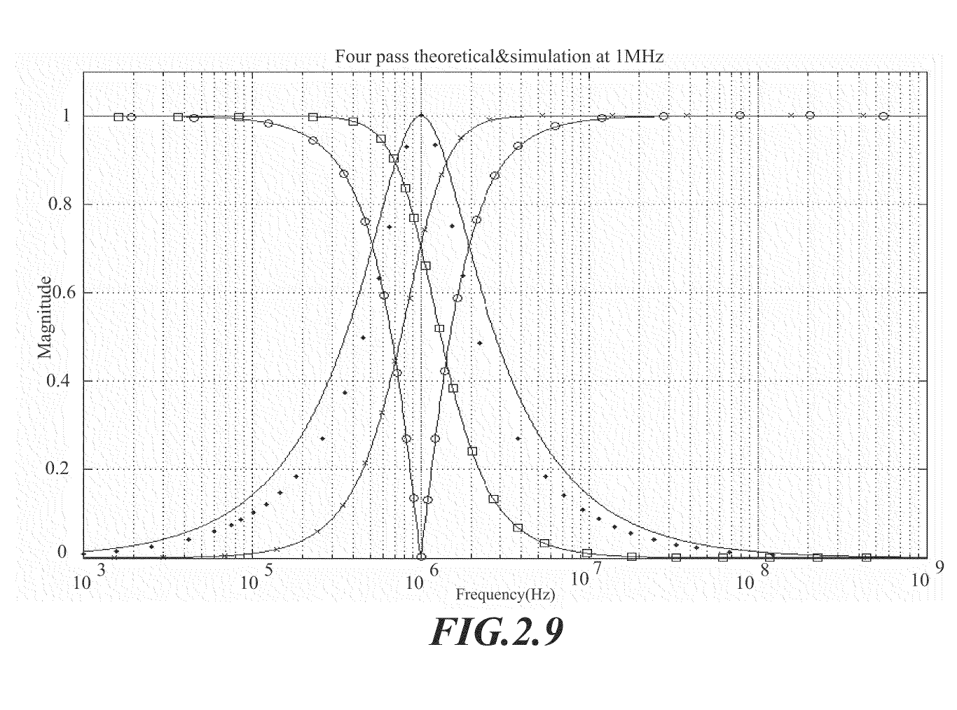

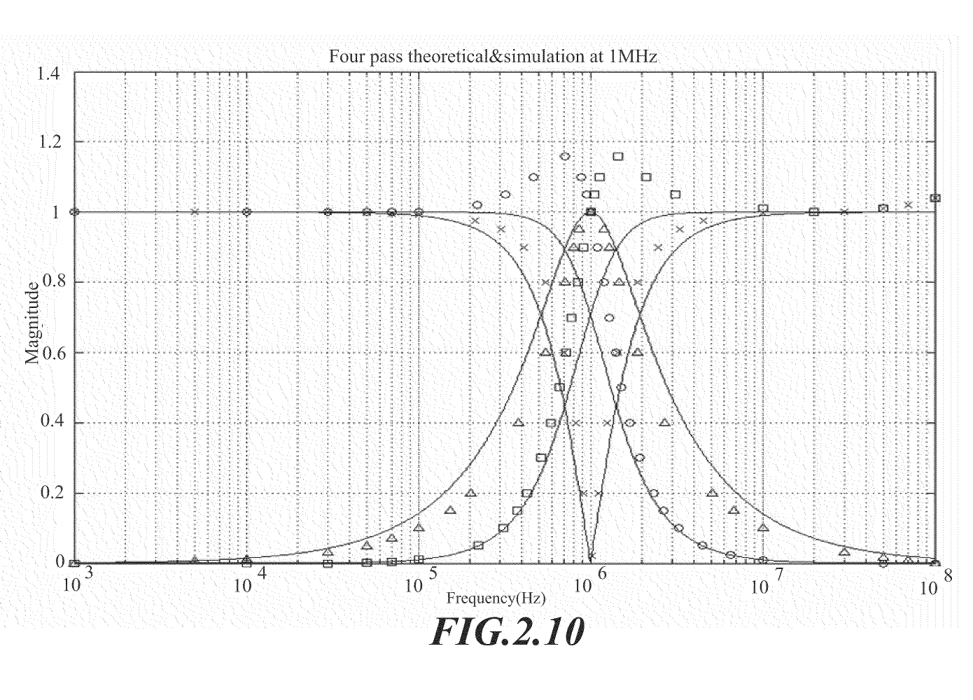

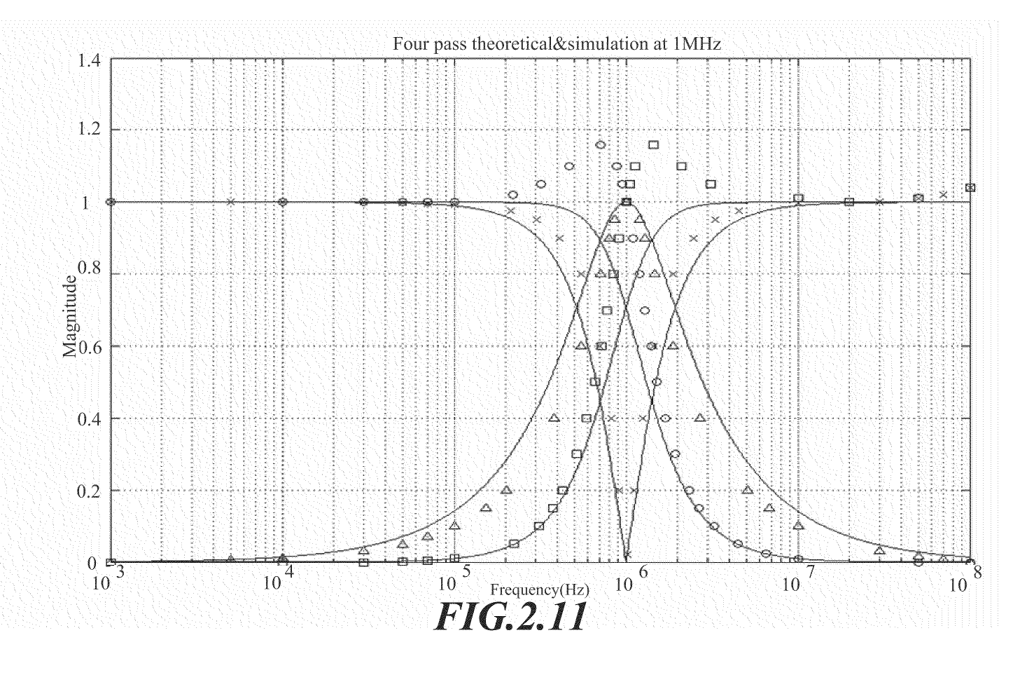

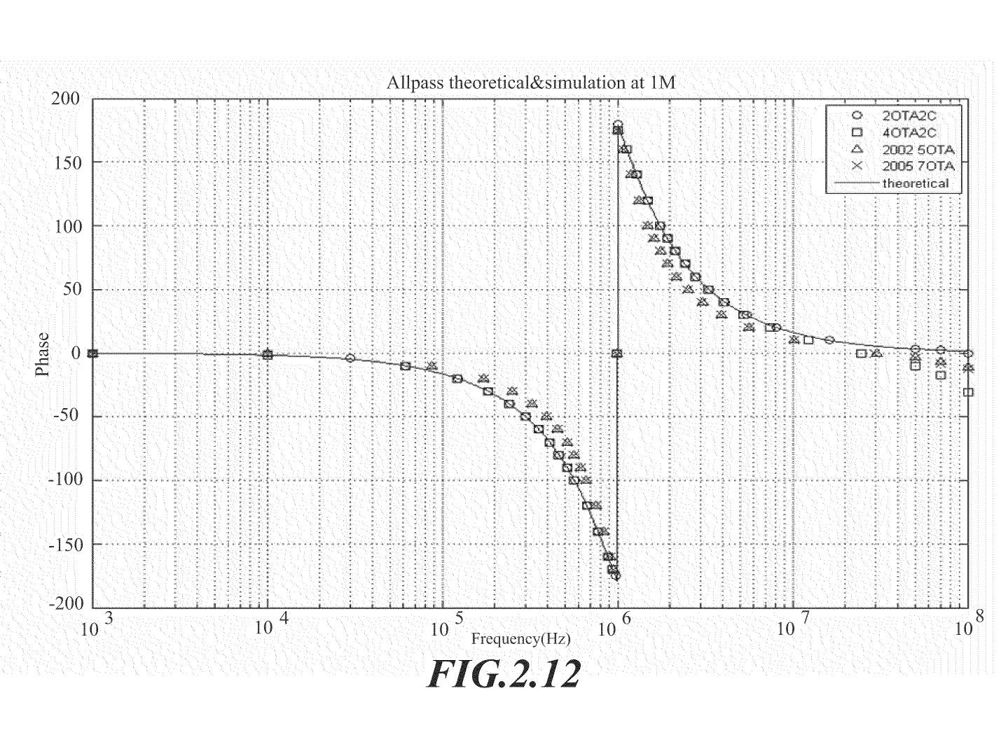

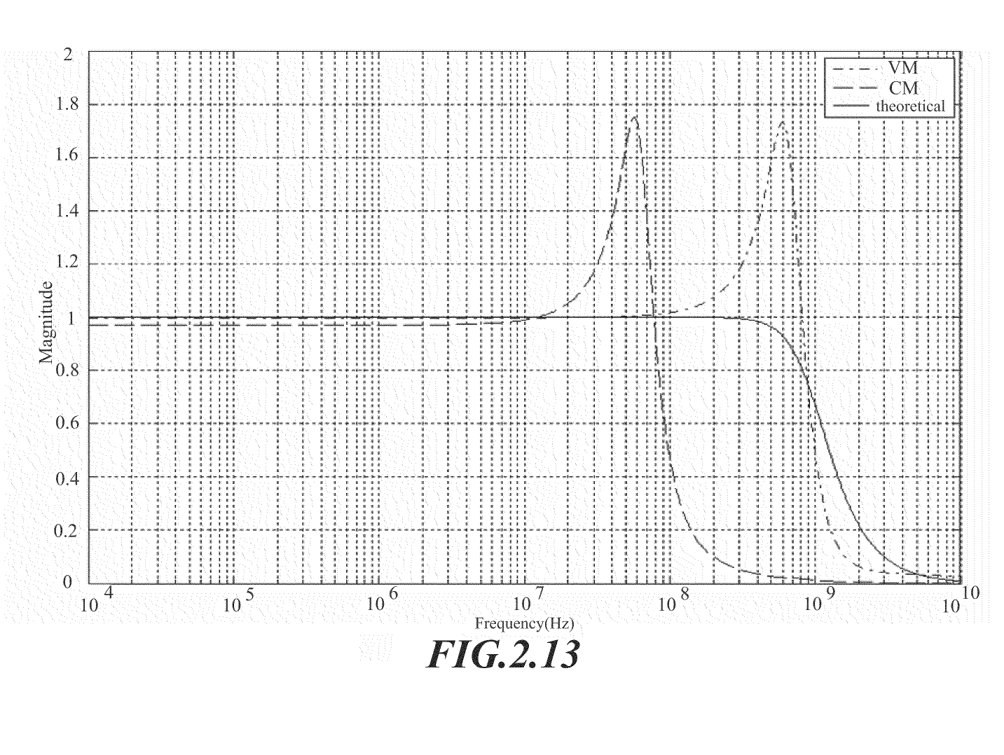

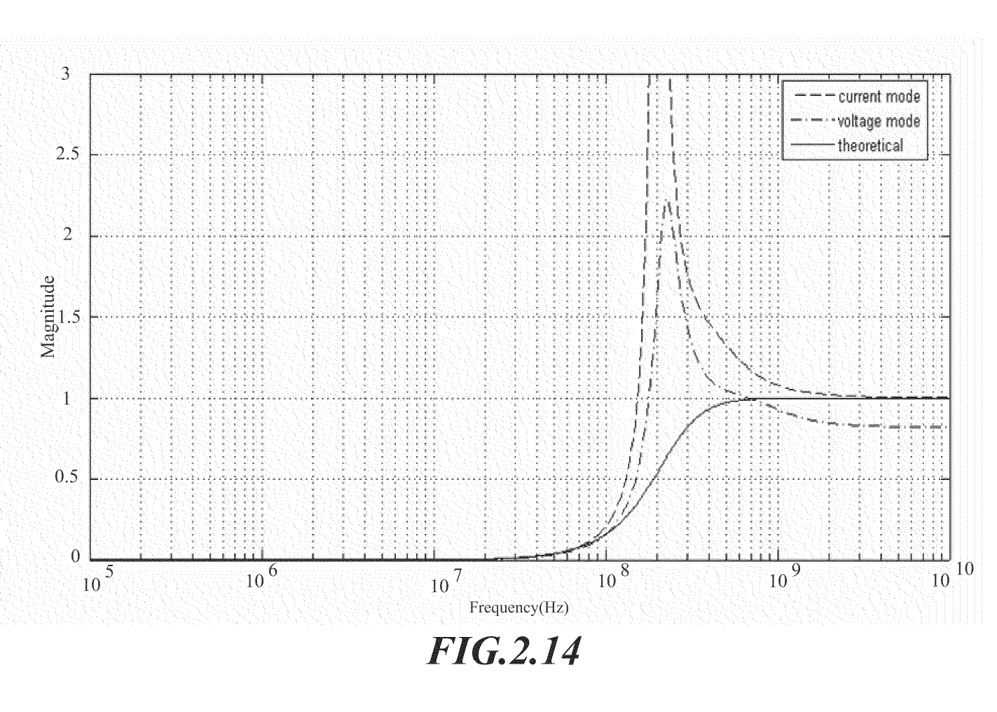

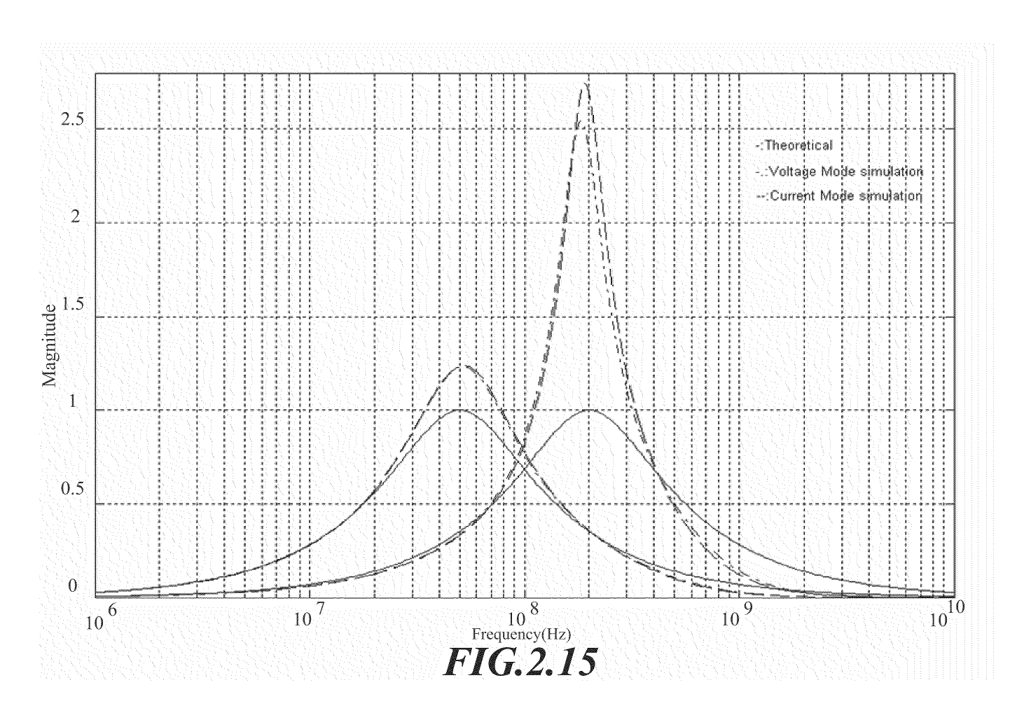

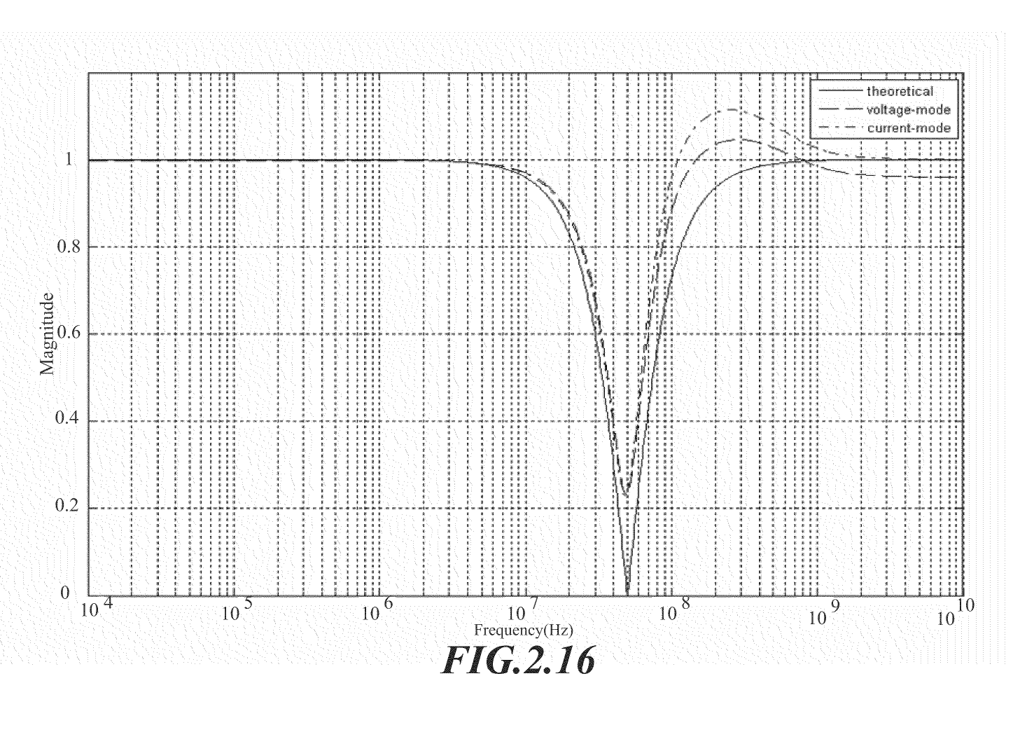

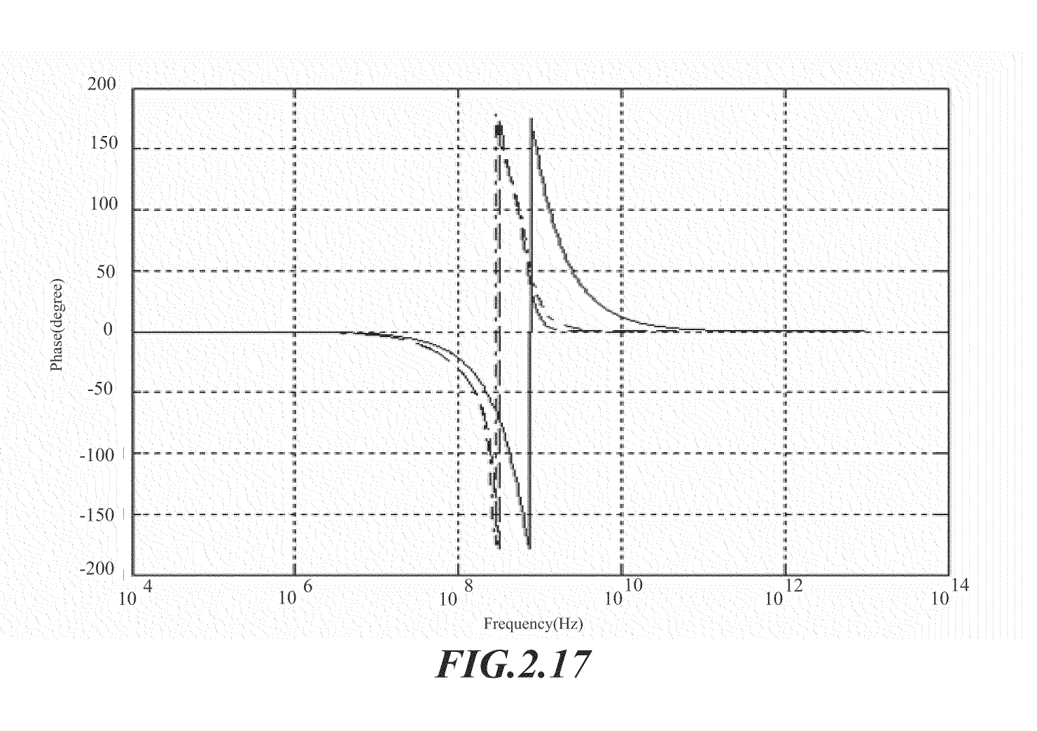

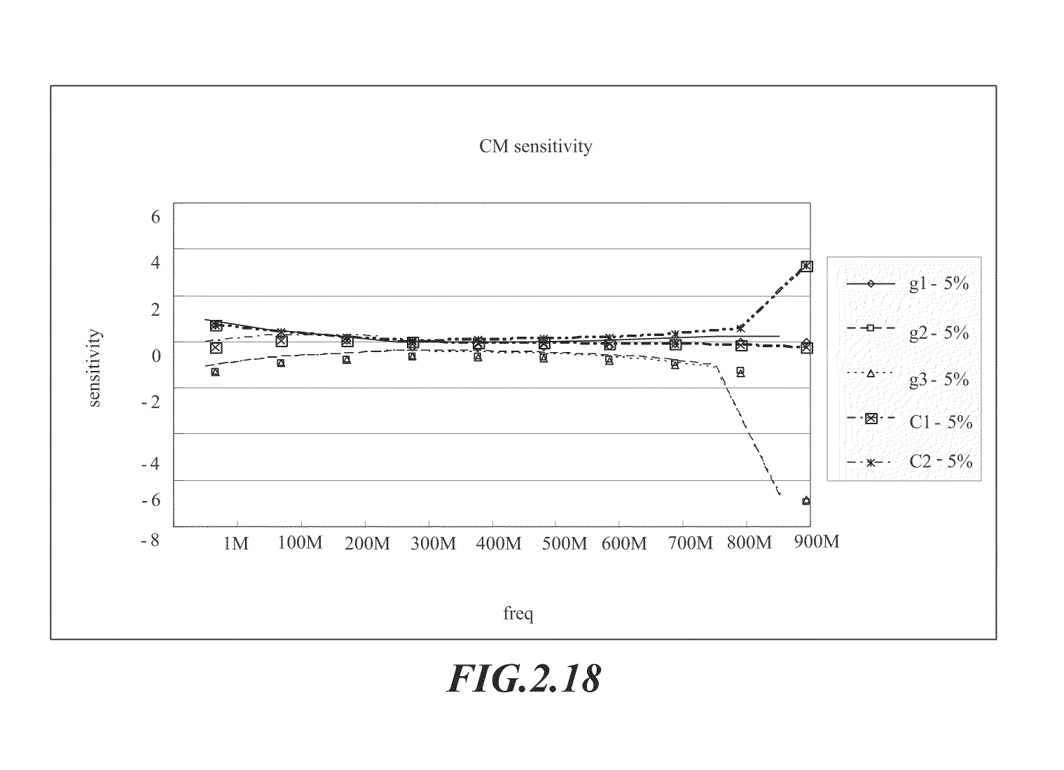

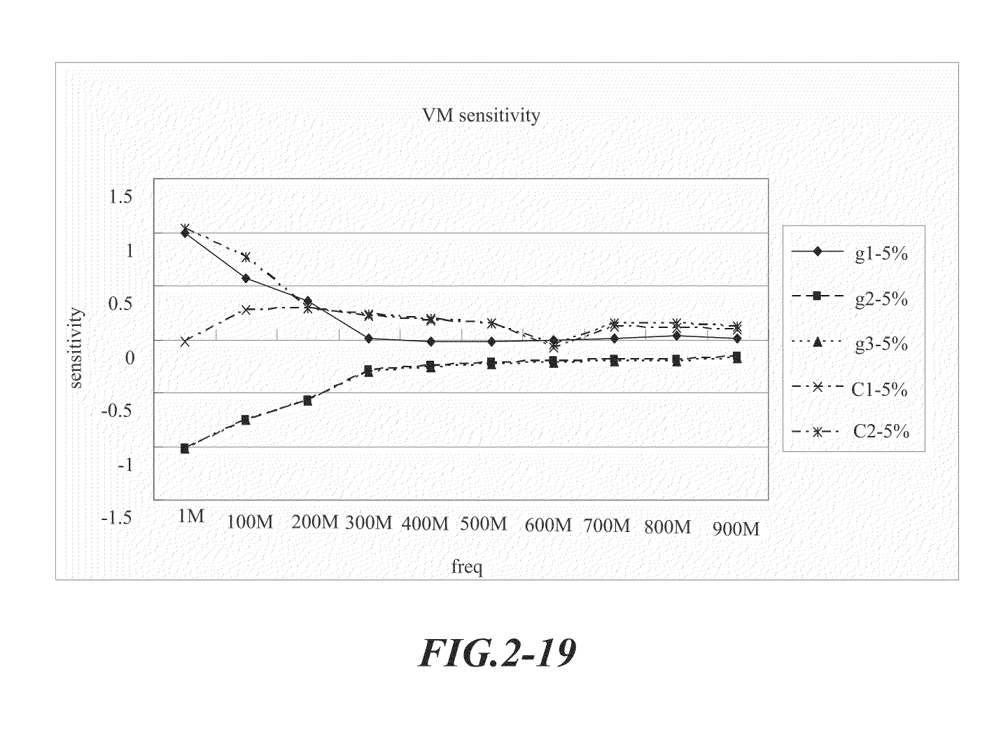

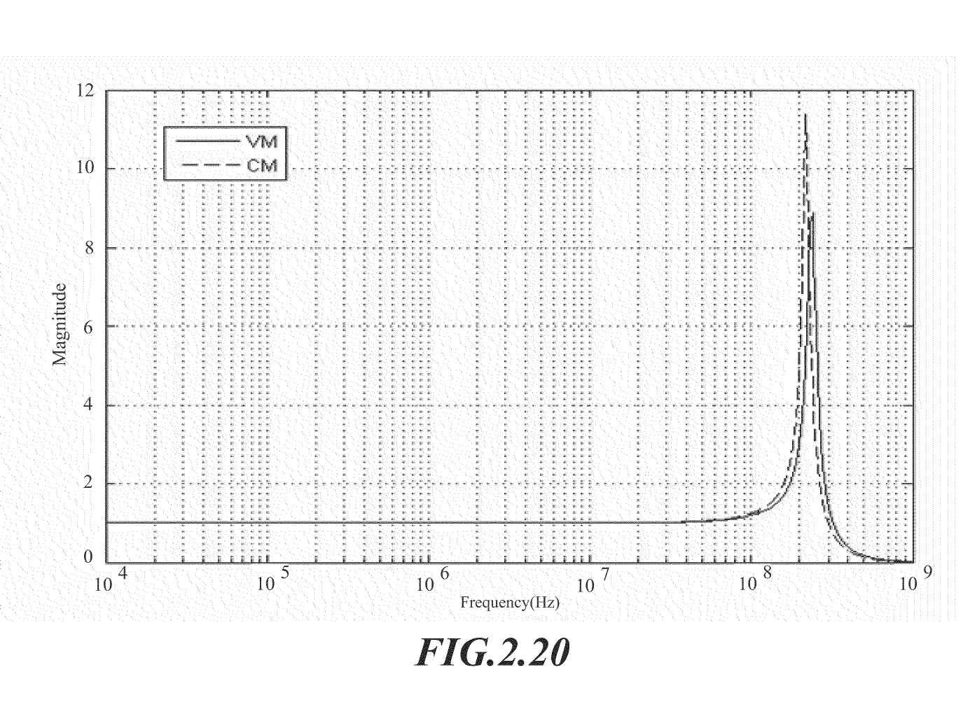

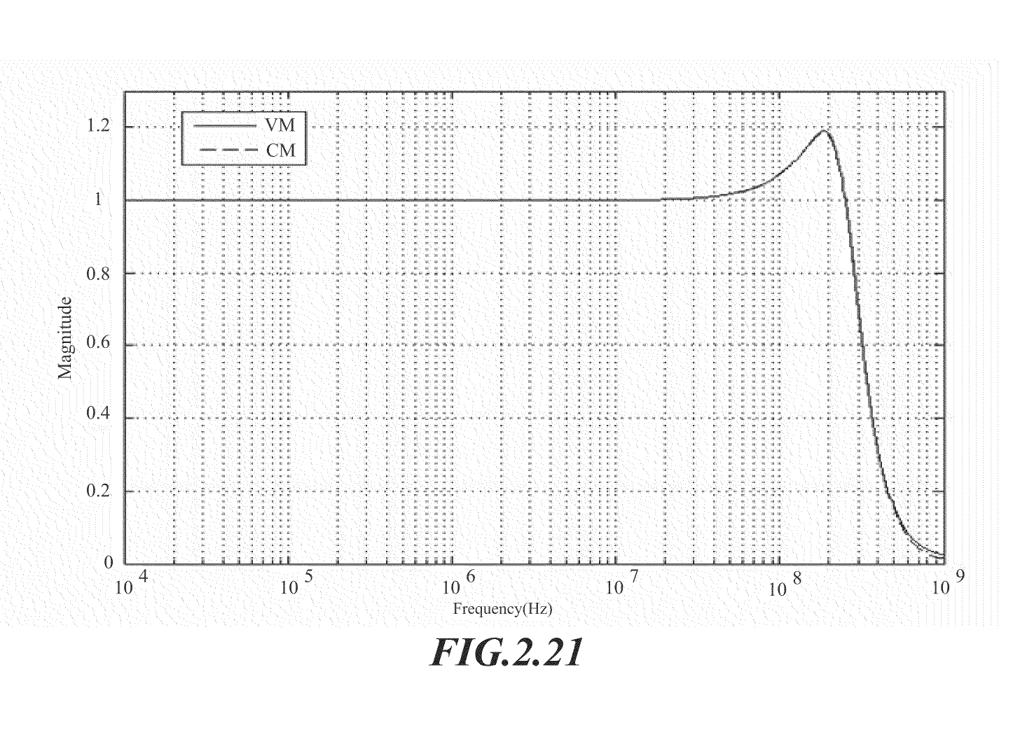

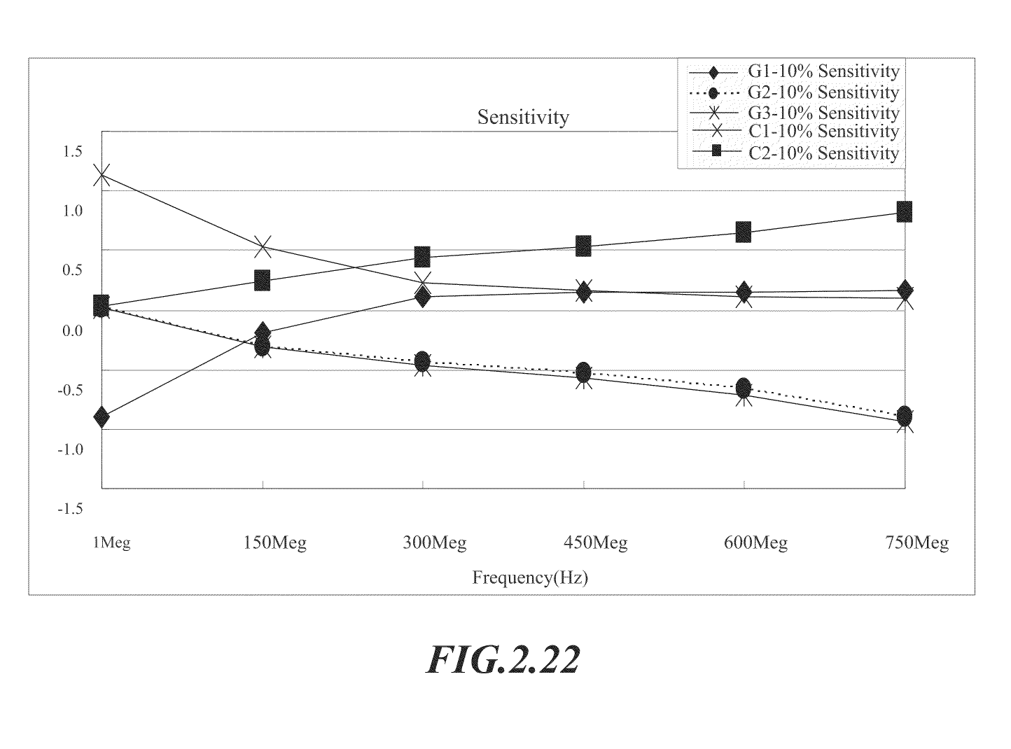

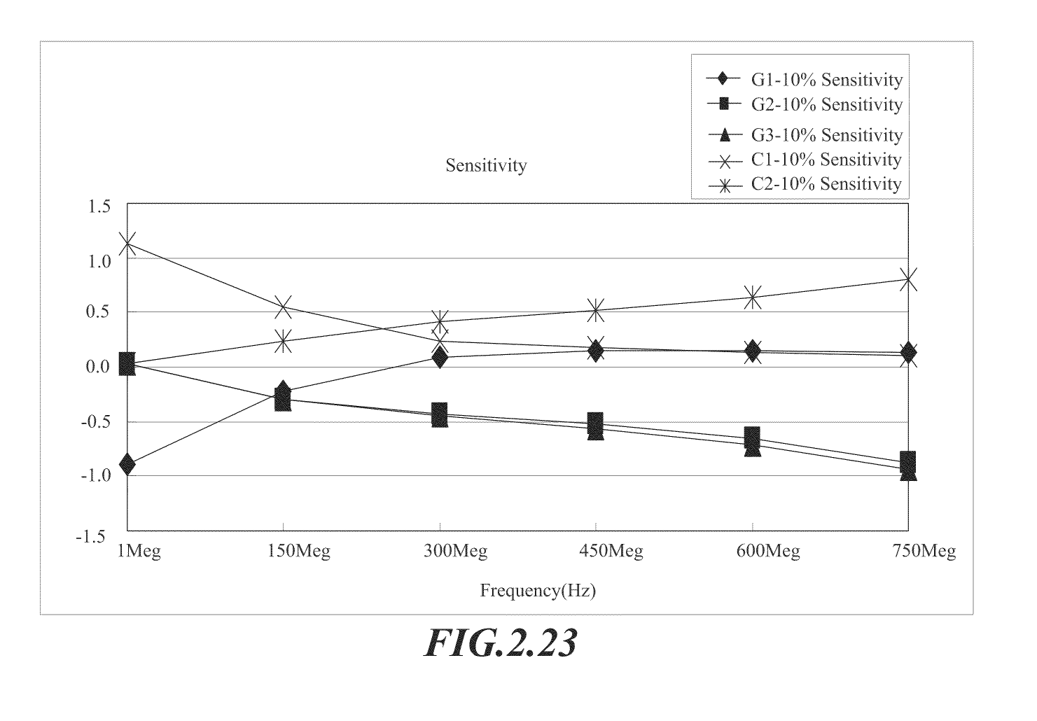

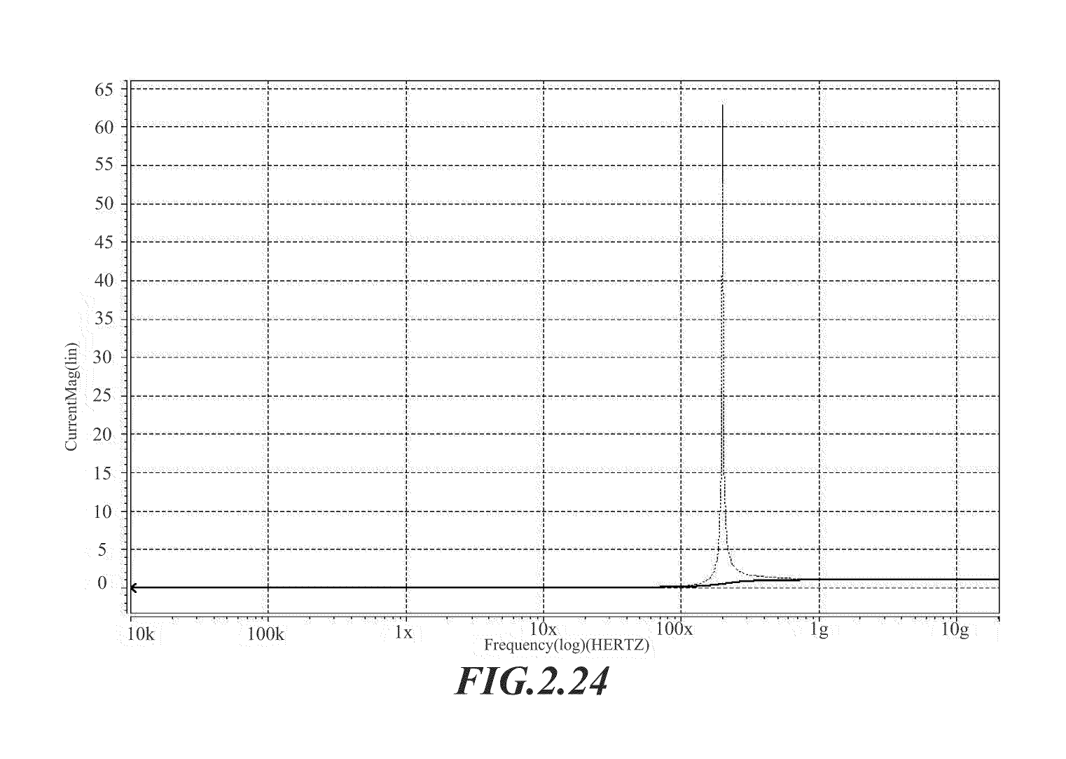

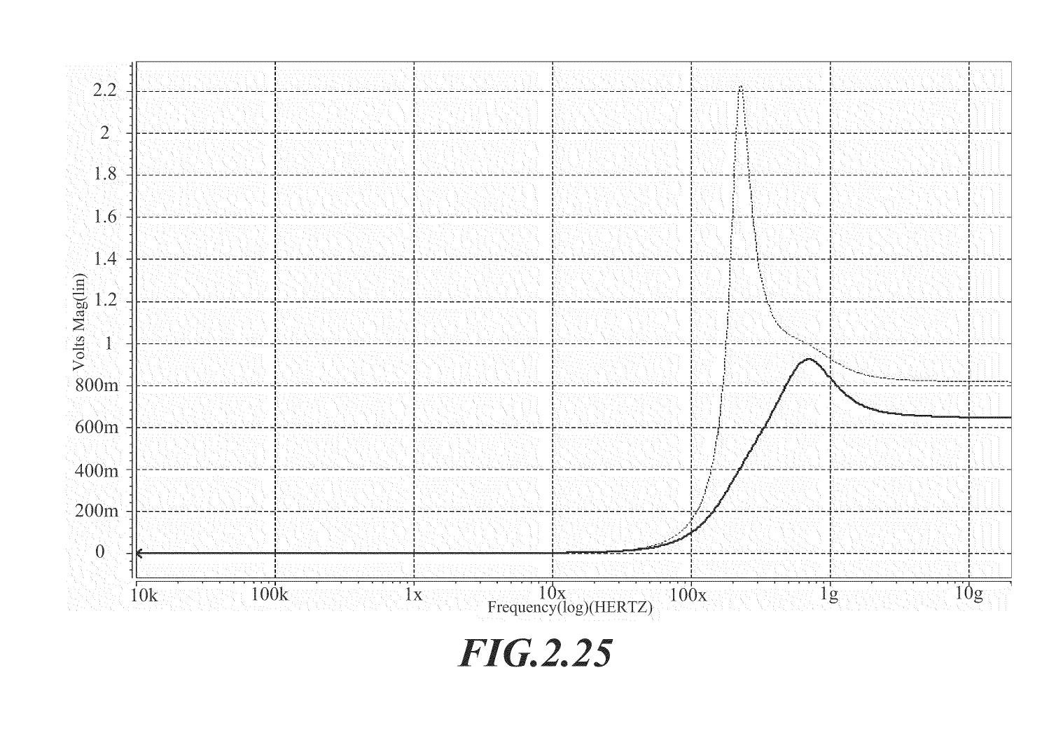

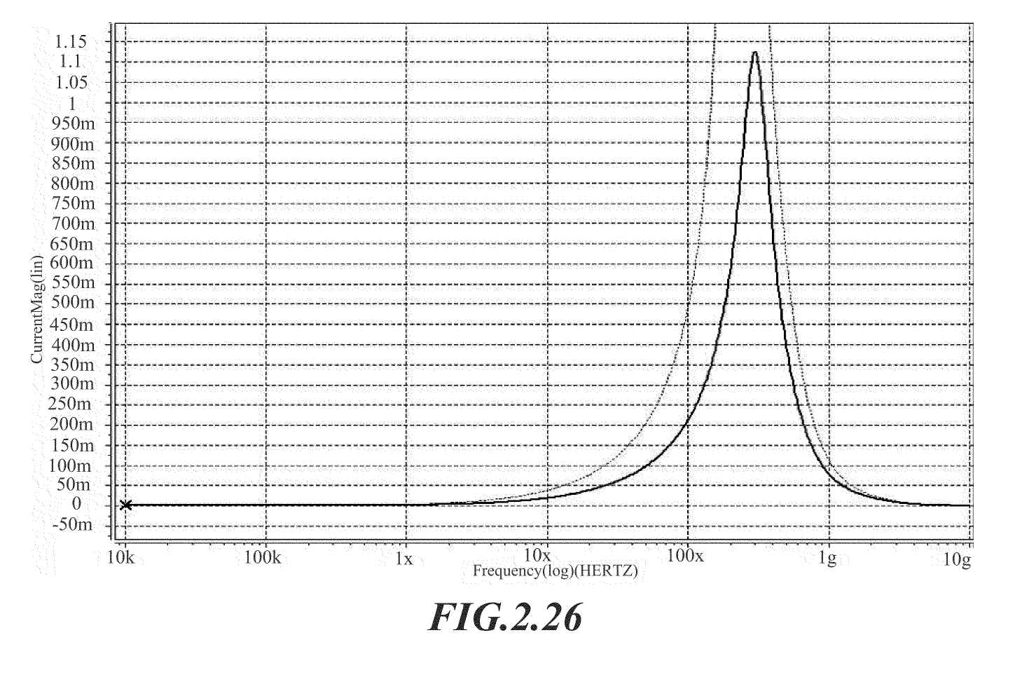

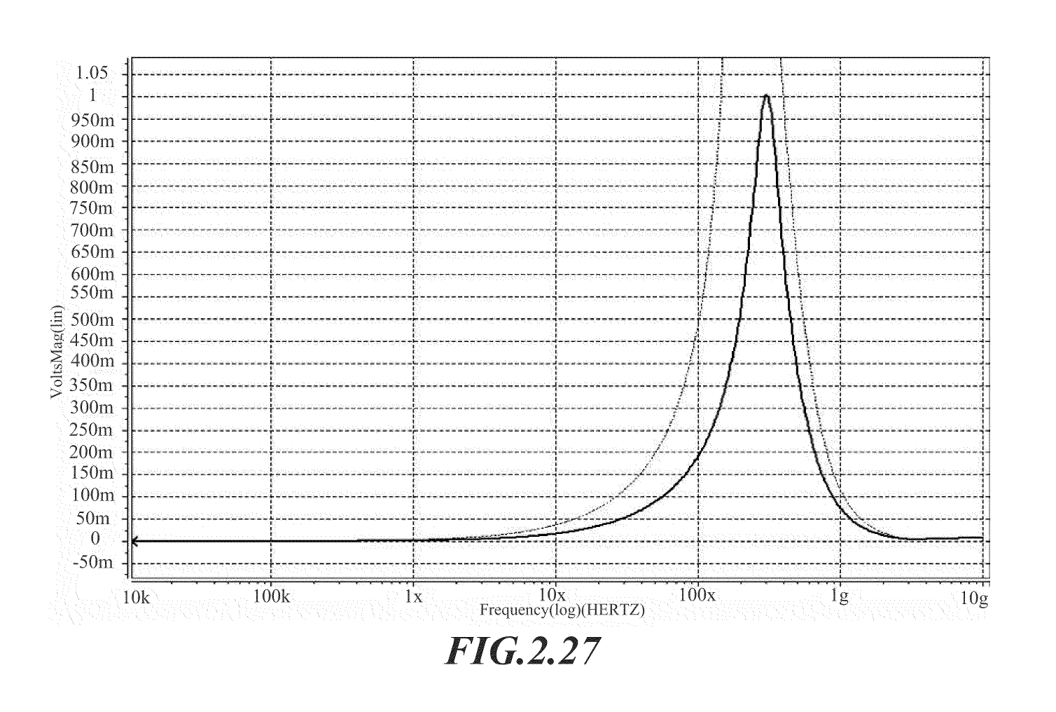

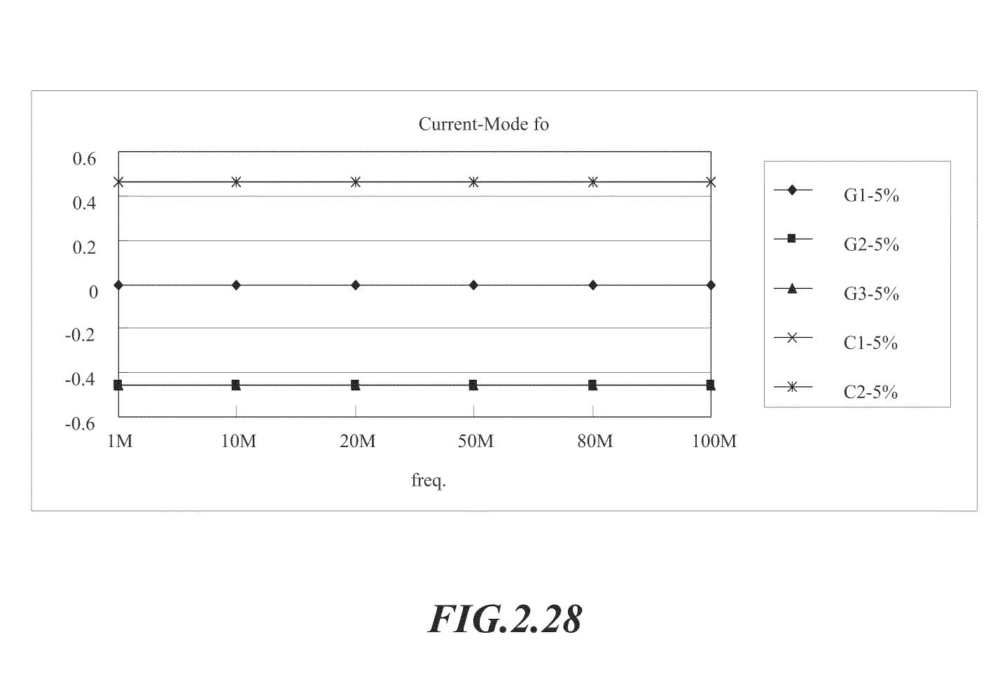

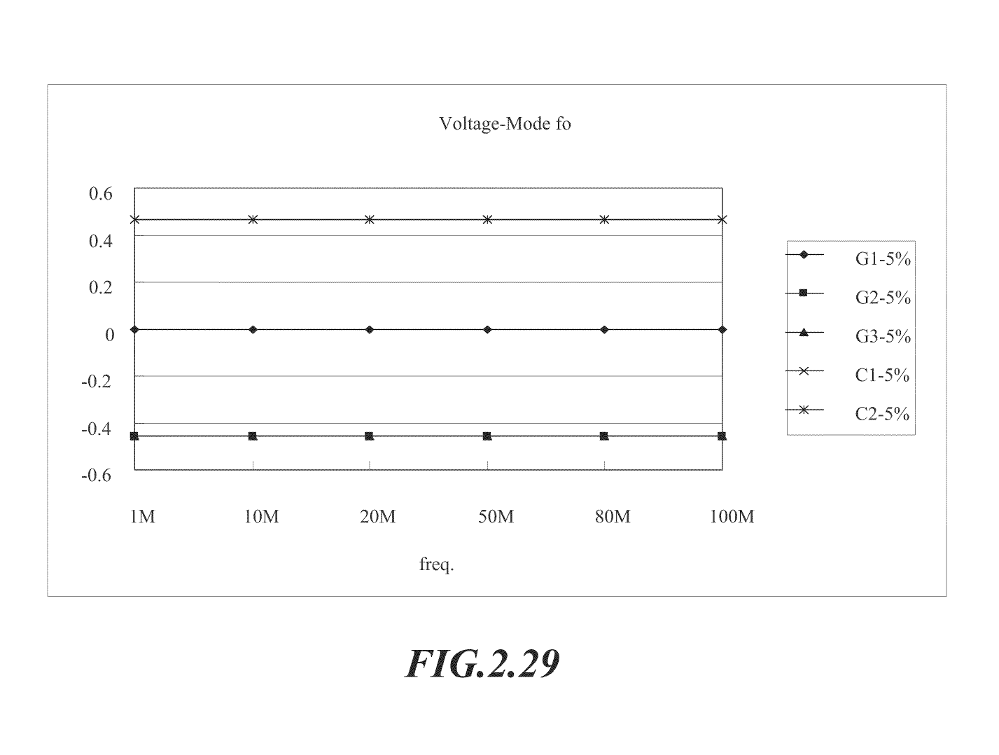

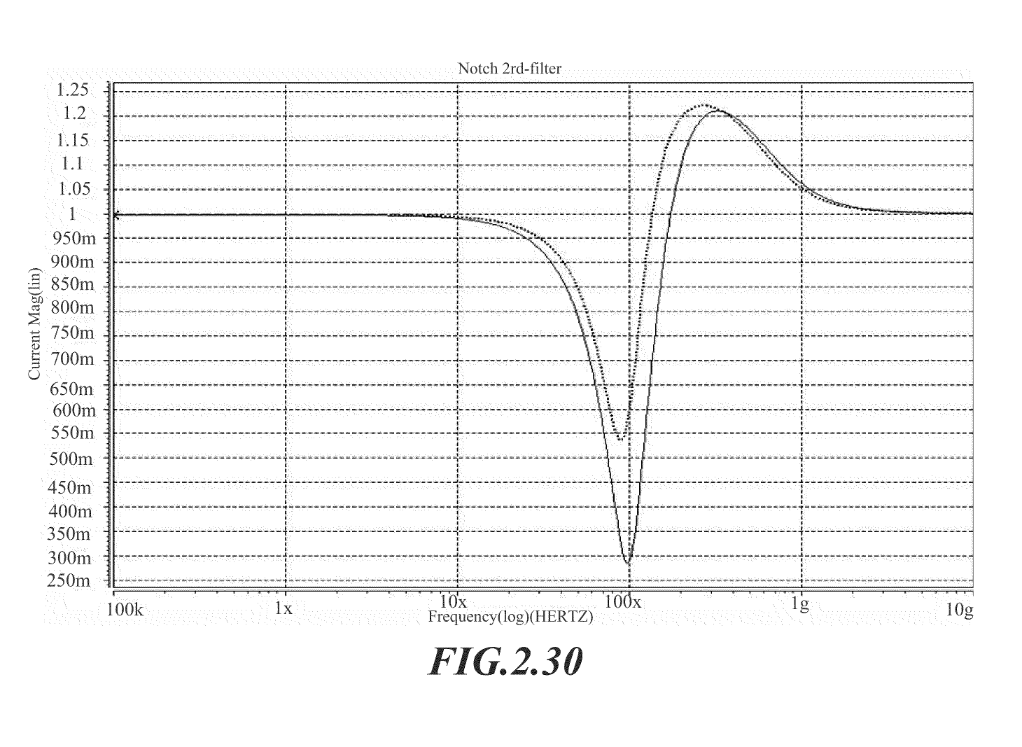

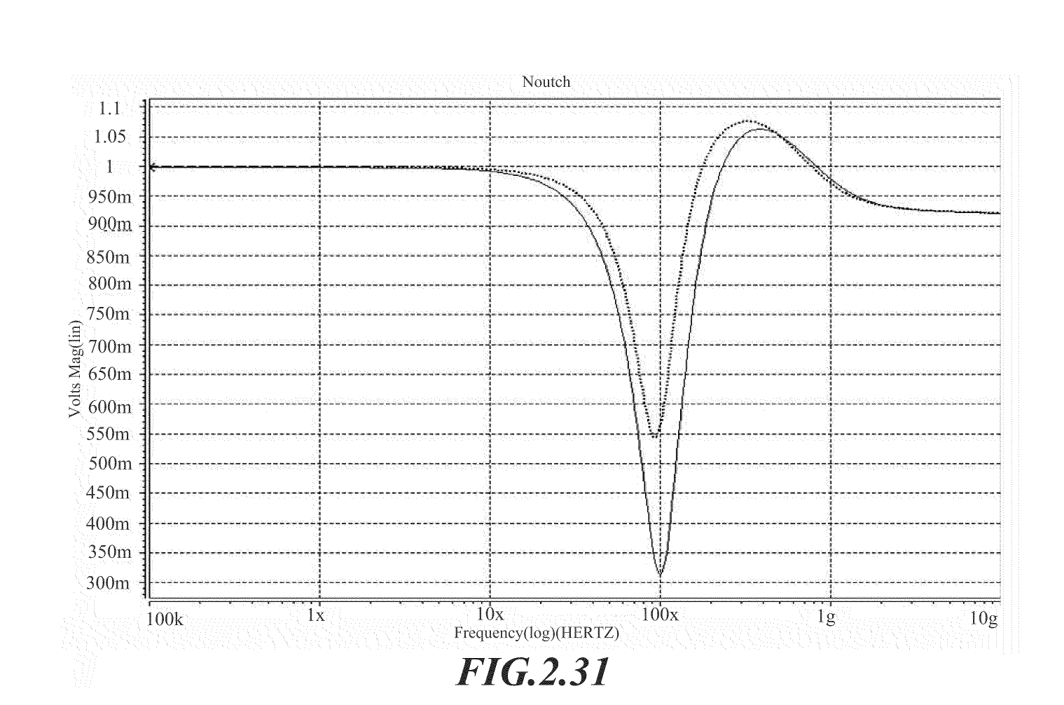

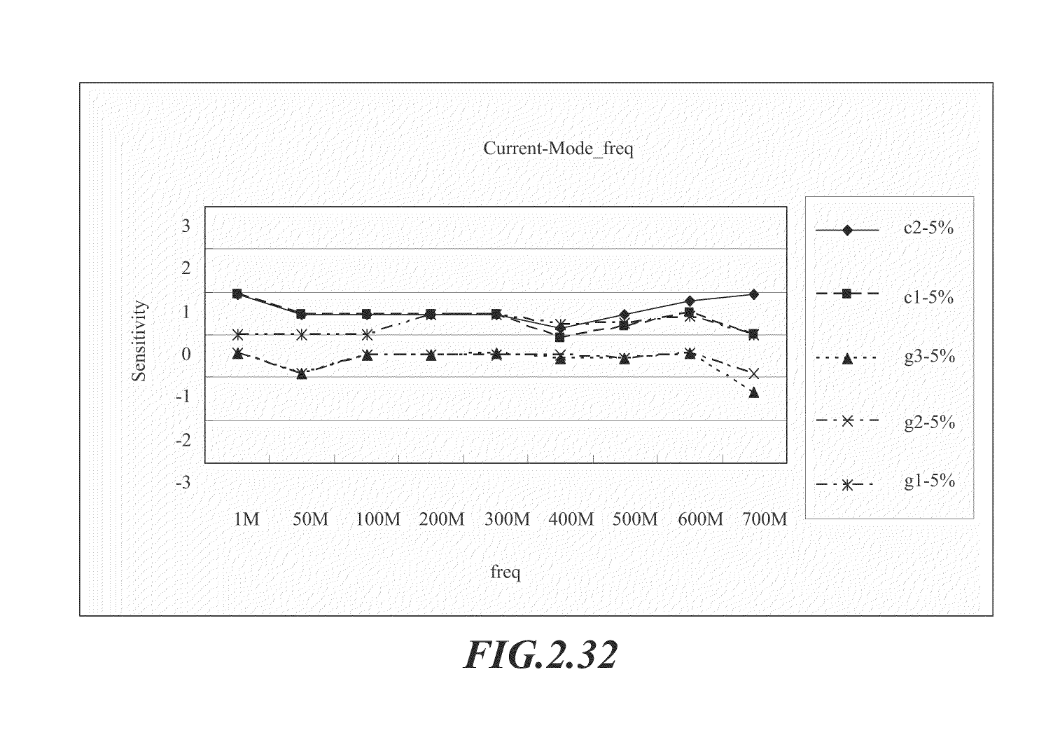

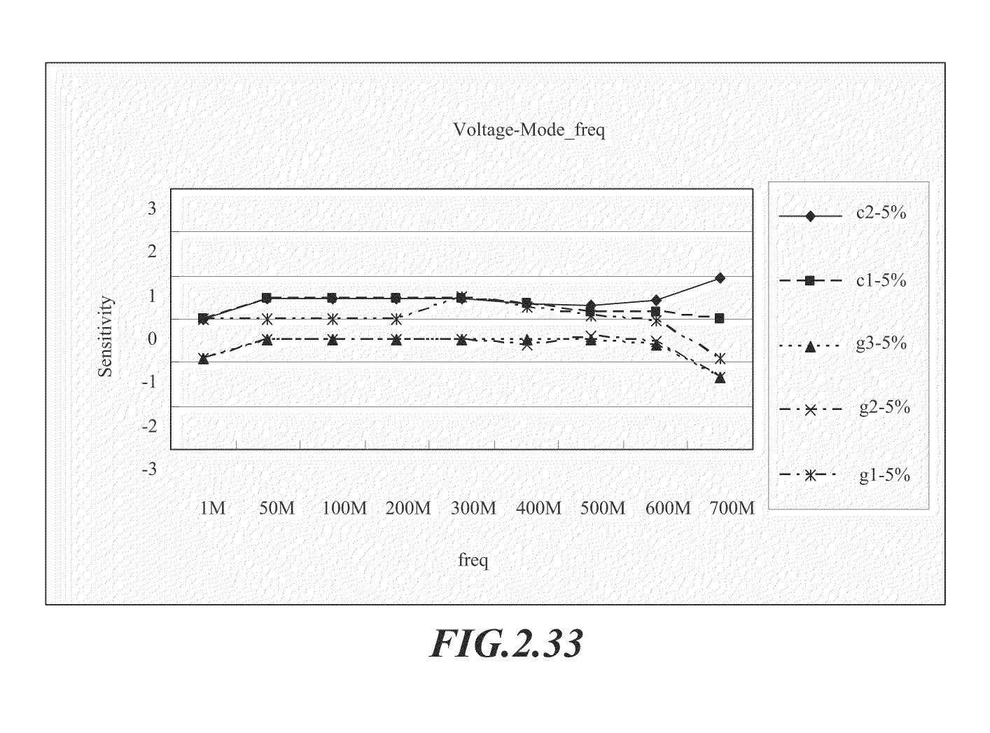

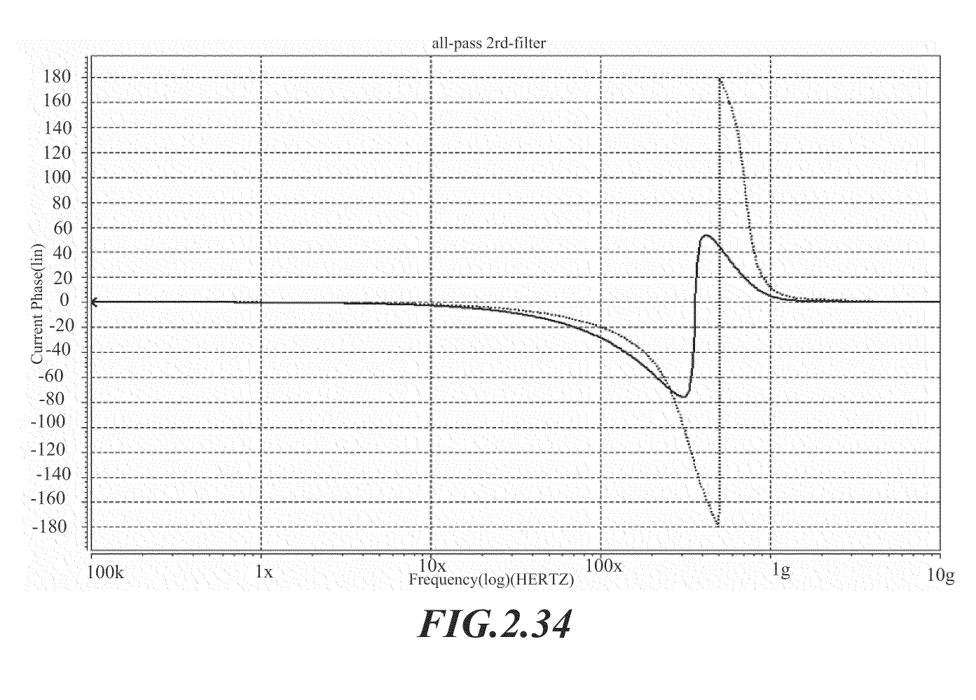

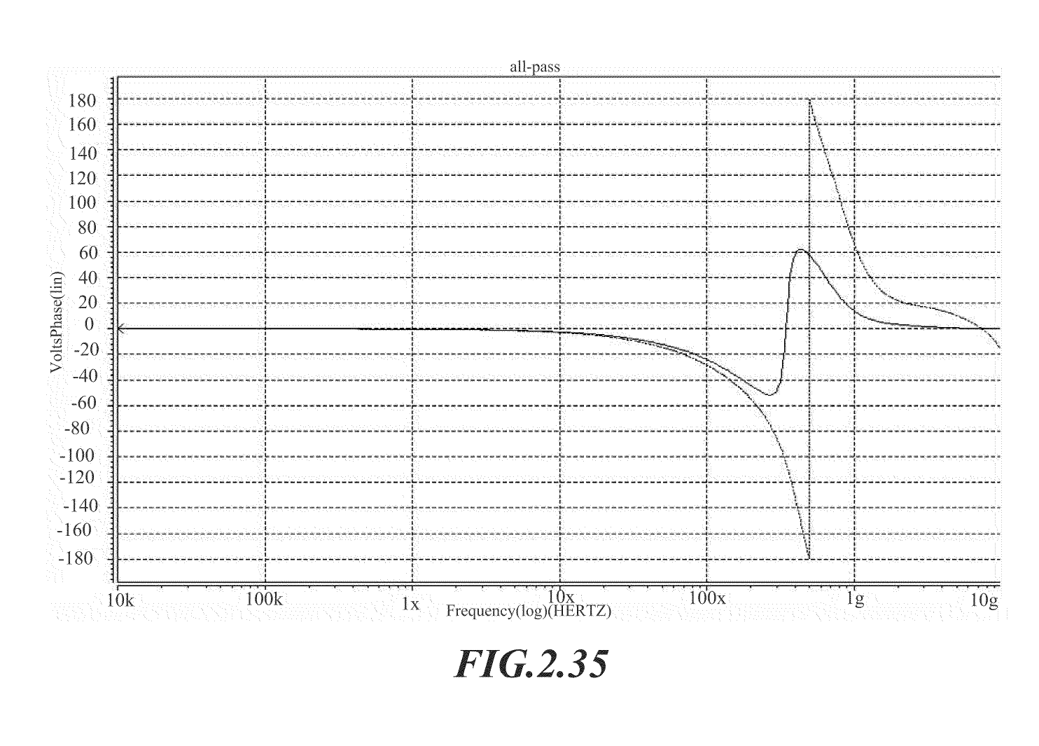

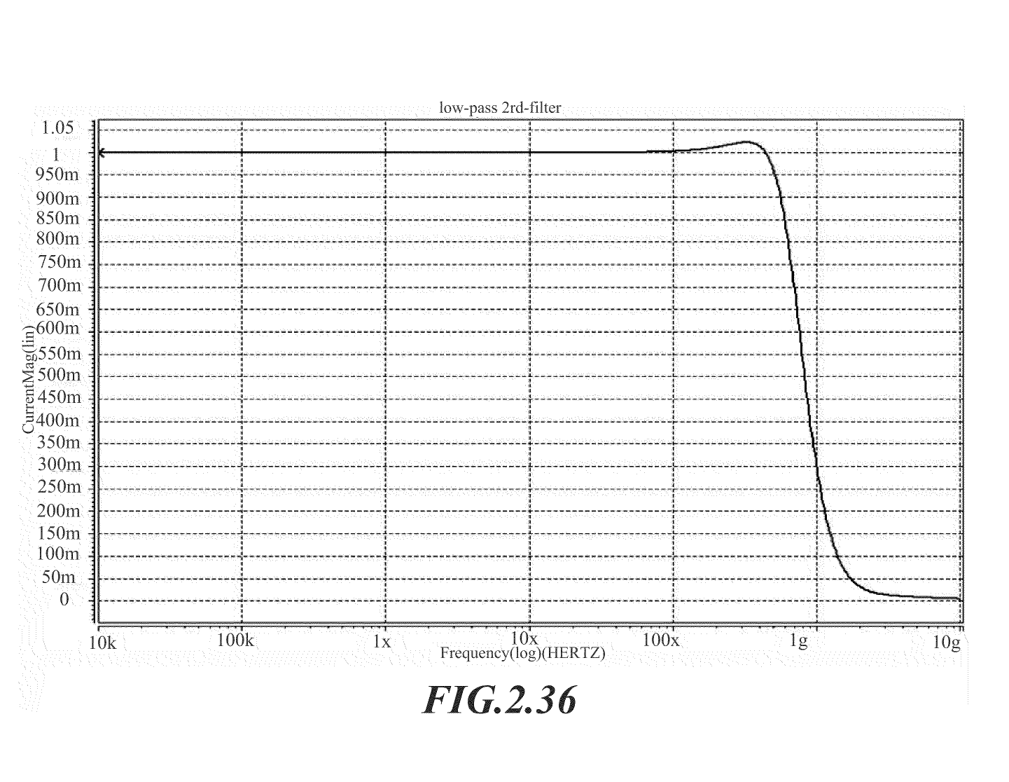

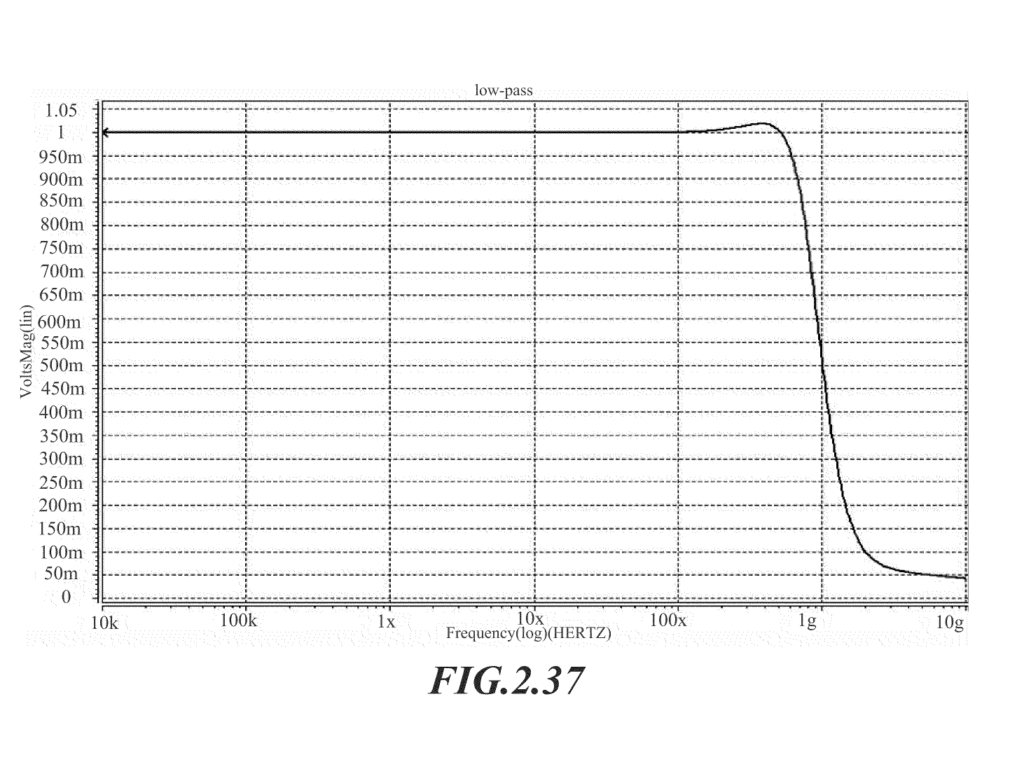

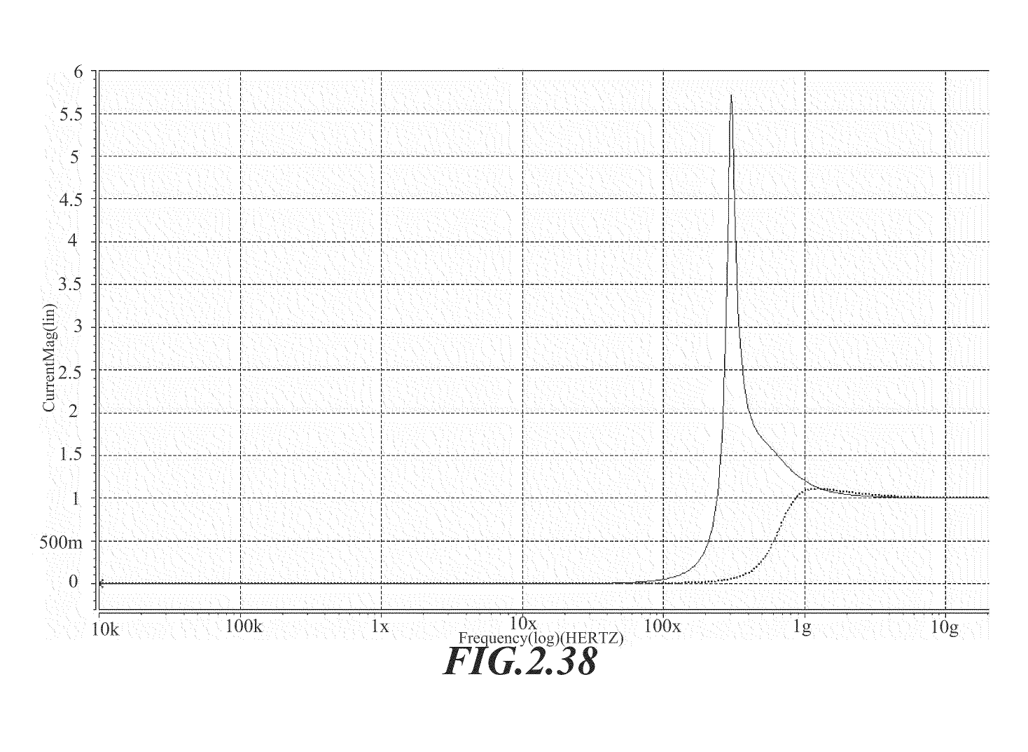

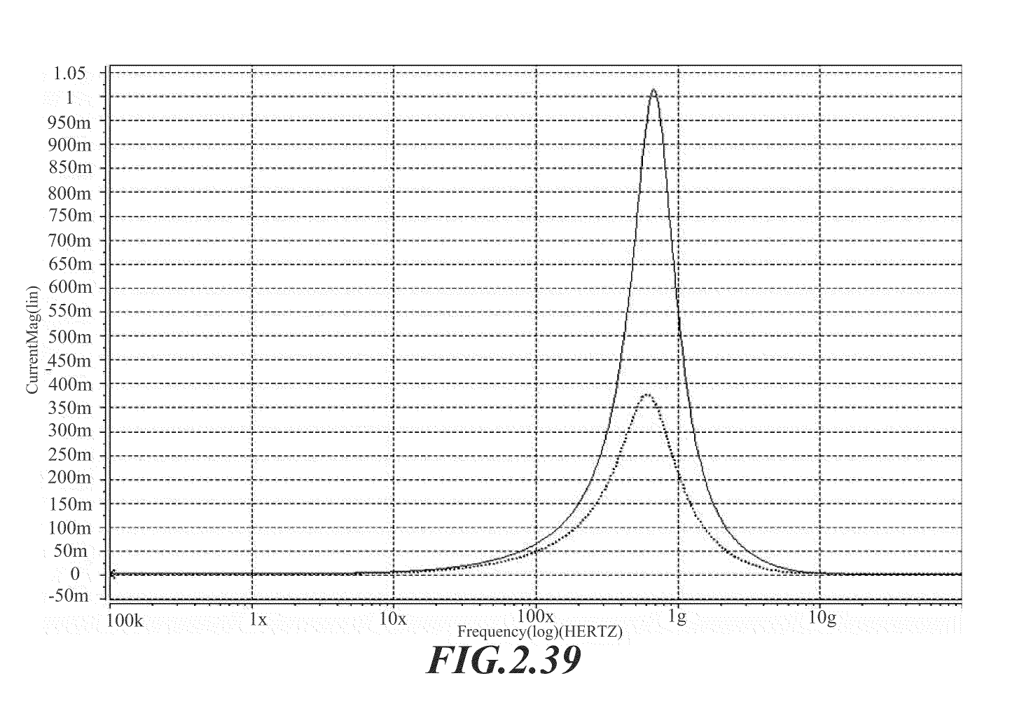

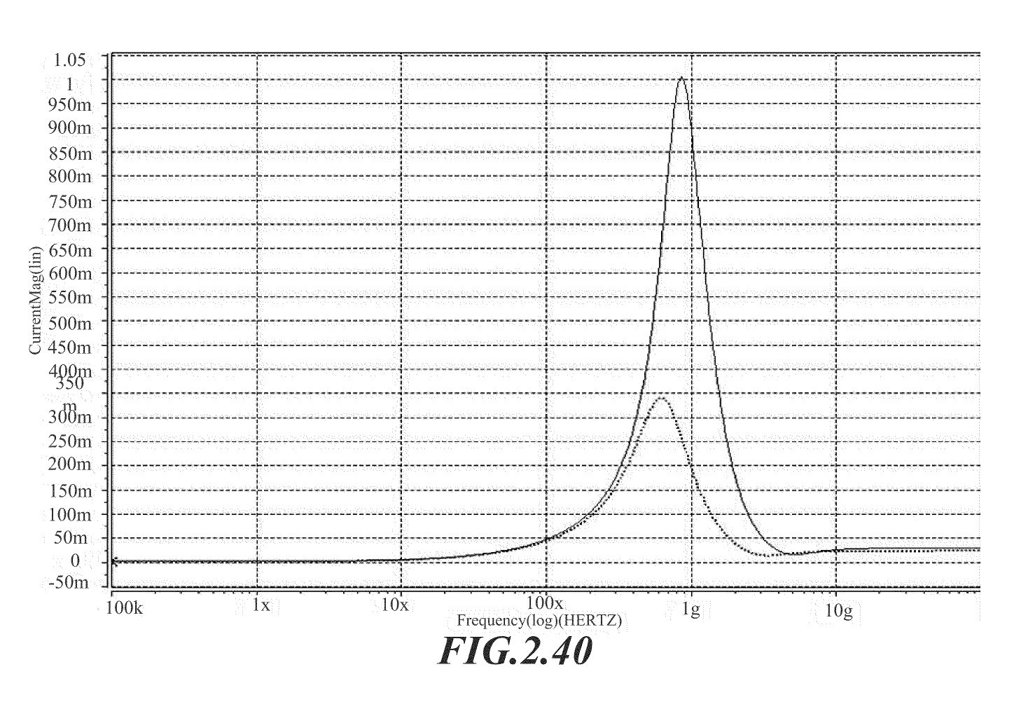

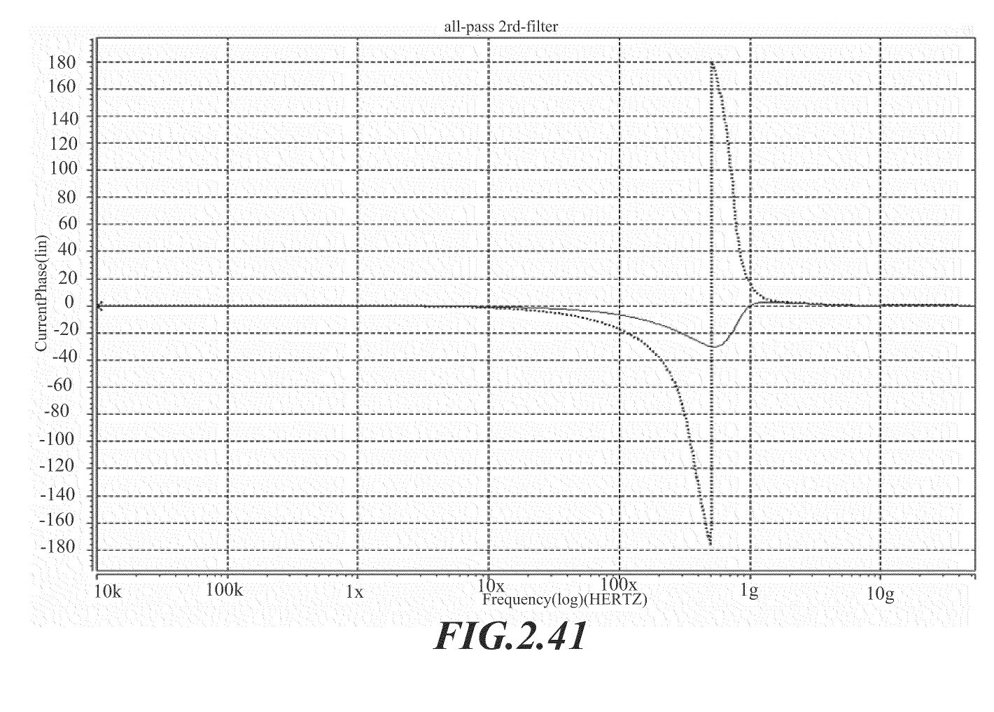

Each of the above equations is simple and can easily be realized using a differential-input OTA with unity transconductance and a floating capacitor of capacitance aBjB/aBj-1B. The OTA-C realizations of these simple first-order equations (1-7-1), (1-7-2), (1-7-n-1), and (1-7-n), are presented in the dashed line blocks from the left to the right, respectively, in FIG. 1-2, which illustrates the new voltage-mode nth-order OTA-C universal filter structure with the minimum number of active and passive components, namely., n differential-input OTA and n floating capacitors. In particular, all the transconductances are of equal value. Equal transconductance design leads to a simpler architecture in view of the fact that only a single biasing circuitry is needed for the entire filter structure.

In summary, the proposed synthesis method has decomposed the voltage-mode nth-order transfer function (1-1) into n first-order transfer functions illustrated in Eq. (1-6-1) (resp. (1-7-1)) to (1-6-n) (resp. (1-7-n)).

Filtering Performance Comparison:

The second-order OTA-C universal filters derived from FIG. 1-1 use two differential-input OTAs in addition to two grounded capacitors. But the two recently reported universal biquads [25, 26] employ three [25] (resp. four [26]) differential-input OTAs and two [25] (resp. three [26]) single-ended-input OTAs in addition to two grounded capacitors. A comparison from precise point of view among the above three universal biquads are illustrated in Table I with the TSMC035 level-49H-Spice simulation (using the CMOS implementation of the OTA [27] with supply voltages VBDDB=1.65V, VBSSB=−1.65V, and W/L=5μ/0.35μ and 10μ/0.35μ for NMOS and PMOS transistors, respectively), and with element values gBaB=gBbB=100 μS gB1B=222.144 μS, gB2B=444.288 μS, and CB1B=50 pF, CB2B=50 pF for the circuits of FIG. 1-1 and with all the transconductances being given by 314.159 μS, and CB1B=50 pF, CB2B=50 pF for the two recently-reported universal biquads [25, 26]). The corresponding frequency response results are illustrated in FIGS. 1-3 to 1-6.

It is clear from FIGS. 1-3 to 1-6 and Table I that the new OTA-C universal biquad filter derived from FIG. 1-1 are much more precise than the two recently reported universal biquads in the related art, when the theoretical resonant frequency is 1 MHz.

TABLE I
Comparison among the three OTA-C universal biquads

| | Filter | | | | |
|---|---|---|---|---|---|
| | f3dB (LP) | f3dB (HP) | fc (BP) | fc (BR) | fc (AP) |
| Biquad | error % | error % | error % | error % | error % |
| FIG. 1-1 | 1.0015 | 0.9974 | 1.0000 | 1.0000 | 0.9885 |
| | −0.15% | (−0.26%) | 0.00% | 0.00% | (−1.15%) |
| [25] | 1.2769 | 0.7861 | 1.0000 | 1.0000 | 0.9885 |
| | (−27.69%) | (−21.39%) | 0.00% | 0.00% | (−1.15%) |
| [26] | 1.2740 | 0.7854 | 1.0233 | 1.0233 | 0.9885 |
| | (−27.40%) | (−21.46%) | −2.33% | −2.33% | (−1.15%) |

To verify the theoretical analysis of the new voltage-mode OTA-C universal biquad derived from FIG. 1-1, the TSMC035 level-49H-Spice simulations using the CMOS implementation of the OTA [27] with supply voltages VBDDB=1.65V, VBSSB=−1.65V, and W/L=5μ/0.35μ and 10μ/0.35μ for NMOS and PMOS transistors, respectively, are conducted. Component values are given by gBaB=gBbB=100 μS gB1B=222.144 μS, gB2B=444.288 S, and CB1B=5 pF, CB2B=5 pF. The amplitude response of the LP, BP, HP and BR (notch) filters and the phase response of the AP filter are illustrated in FIGS. 1-7 to 1-11, with the simulated resonant frequencies, 10.367 MHz (3.67% error), 10.000 MHz (0.00% error), 9.647 MHz (−3.53% error), 10.000 MHz (0.00% error), and 9.885 MHz (−1.15% error) for the new universal biquad derived from FIG. 1-1, as compared to the theoretical resonant frequency of 10.000 MHz. We note that the output error of the new universal biquad at 10 MHz is still much more precise than that of the other universal biquads such as in the related arts at 1 MHz.

The same H-Spice scheme mentioned above is used for simulating the sensitivity of the biquad with the minimum number of components derived from FIG. 1-1. In addition to this, the tendencies of sensitivities will be used to vary the component values such that the output response becomes much more precise at very high frequencies (from 300 MHz to 1 GHz), thus reducing the distortion by the far more parasitic and magnetic effects when the operational frequency is much higher.

(i) For Low-Pass Biquad:

The component values are given by C1=C2=0.01685 pF, g1=75 μS, and g2=150 μS. The sensitivity simulation results are illustrated in Table II based upon the above component values with the 3 dB frequency at 1 GHz.

TABLE II
Simulation results of the sensitivity for the low-pass
biquad derived from FIG. 1-1

| | Element | | | |
|---|---|---|---|---|
| Parameter | g1 + 10% | g2 + 1.14% | g1 − 10% | G2 − 10% |
| f3dB | 1.53% | 0.27% | −1.68% | −3.68% |
| Peak | −7.34% | 2.09% | 10.15% | −9.41% |

The transconductance sensitivity of f3dB is very low, different from that of the peak value. Since the filtering simulation result illustrates that the 3 dB frequency is 1028 MHz with a 2.8% error and a peak of 2.27, only tuning the transconductances g1 and g2 to 143 μS and 107 μS leads to the more precise 3 dB frequency of 1004.6 MHz with only a 0.46% error and a lower peak of 1.38, as illustrated in FIG. 1-12.

(ii) For High-Pass Biquad:

The component values are given by C1=C2=0.08333 pF, g1=111.07 μS, and g2=222.14 μS. The sensitivity simulation results are illustrated in Table III based upon the above component values with the theoretical 3 dB frequency at 300 MHz.

TABLE III
Simulation results of the sensitivity for the high-pass biquad
derived from FIG. 1-1

Element

| Parameter | g1 + 10% | g2 + 10% | g1 − 10% | G2 − 10% |
|---|---|---|---|---|
| f3dB | 3.68% | 2.12% | −4.01% | −2.22% |
| Peak | −33.23% | −67.03% | −70.55% | −34.23% |

The transconductance sensitivity of f3dB is very low, different from that of the peak value. Since the filtering simulation result illustrates that the 3 dB frequency is 193 MHz with a large 31% error and a very high peak of up to 26, only tuning the transconductances g1 and g2 to 18 μS and 375 μS leads to the much more precise 3 dB frequency 300.6 MHz with only a 0.2% error and a much lower peak of 1.22, as illustrated in FIG. 1-13.

(iii) For Band-Pass Biquad:

The component values are given by C1=C2=0.0175 pF, g1=77.75 μS, and g2=155.50 μS. The sensitivity simulation results are illustrated in Table IV based upon the above component values with the 3 dB frequency at 1 GHz.

TABLE IV
Simulation results of the sensitivity for the band-pass
biquad derived from FIG. 1-1

Element

| Parameter | g1 + 5% | g2 + 5% | g1 − 5% | g2 − 5% |
|---|---|---|---|---|
| f3dB | 2.33% | — | 0.00% | −2.28% |
| Peak | −9.73% | — | 14.1% | 11.64% |

The transconductance sensitivity of f3dB is very low, different from that of the peak value. Since the filtering simulation result illustrates that the 3 dB frequency is 724.4 MHz with a 27.56% error and a peak of 1.60, tuning the transconductances g1 and g2 to 76.85 μS and 134.53 μS and C1=C2=0.008 pF leads to the more precise 3 dB frequency of 851.1 MHz with a 14.88% error and a much lower peak of 1.01, as illustrated in FIG. 1-14.

(iv) For all-pass biquad: the component values are given by C1=C2=0.015 pF, g1=54.55 μS, and g2=29.35 μS. The sensitivity simulation results are illustrated in Table V based upon the above component values with the theoretical 3 dB frequency at 1 GHz.

The transconductance sensitivity of f3dB and the peak are lower than those of the low and high phases (phase range). Since the filtering simulation result illustrates that the 3 dB frequency is 655 MHz, the peak is 2.95, and the phase difference is only from −13.1o to +13.3o, tuning the transconductances g1 and g2 to 4.02 μS and 101 μS and C1=C2=0.001 pF leads to a 3 dB frequency of 638 MHz, a peak of 2.73, and a much more desired phase difference from −179.32o to +179.23o, as illustrated in FIG. 1-15

TABLE V
Simulation results of the sensitivity for the all-pass
biquad derived rom FIG. 1-1

Parameter

| | | | Low | High |
|---|---|---|---|---|
| Element | f3dB | Peak | phase | phase |
| g1 + 10% | 1.76% | 5.03% | 6.34% | −2.88% |
| g2 + 10% | 5.19% | −1.94% | 0.17% | −9.38% |

(v) For Band-Reject Biquad:

The component values are given by C1=C2=0.08333 pF, g1=111.07 μS, and g2=222.14 μS. The sensitivity simulation results are illustrated in Table VI based upon the above component values with the theoretical 3 dB frequency at 300 MHz.

TABLE VI
Simulation results of the sensitivity (with %) for the band-reject biquad
derived from FIG. 1-1 (E and P present element and parameter,
respectively)

E

| | G1 | G2 | C1 | C2 | G1 | [symbol] |
|---|---|---|---|---|---|---|
| P | −5% | −5% | −5% | −5% | 5% | [symbol] |
| f3dB | −0.46 | −0.46 | 0 | 0 | −0.45 | [symbol] |
| Peak | −1.37 | −10.9 | −12.6 | 1.32 | −11.4 | 1.43 |

[symbol]

indicates data missing or illegible when filed

The transconductance sensitivity of f3dB is very low, different from that of the peak value. Since the filtering simulation result illustrates that the 3 dB frequency is 263 MHz with a large 12.33% error and a very high peak of up to 62.5 (like a band-pass response), tuning the transconductances g1 and g2 to 15 μS and 380 μS, and C1=C2=0.044 pF leads to a much more precise 3 dB frequency of 299.3 MHz with only a 0.23% error and the deepest point with a value 0.38 (like a band-reject response), as illustrated in FIG. 1-16.

2. Analytical Syntheses of Tunable Voltage/Current-Mode OTA-C or Parasitic C Multifunction Biquad Structures with the Minimum Number of Components.

2.1 Analytical Synthesis Method of Tunable Voltage-Mode OTA-C Universal Biquad Structure.

The voltage-mode second-order universal filter transfer function with the performance of tunability may be illustrated as below.

$${V}_{out} = \frac{{V}_{in 2} ( {s}^{2} {C}_{1} {C}_{2} ) + {V}_{in 1} ( {sC}_{2} {g}_{1} ) + {V}_{in 0} ( {g}_{2} {g}_{3} )}{{s}^{2} {C}_{1} {C}_{2} + {sC}_{2} {g}_{1} + {g}_{2} {g}_{3}} \qquad ( 2.1 )$$

The resonant angular frequency and the quality factor are expressed as follows.

$$\begin{matrix}{ω}_{o} = \sqrt{\frac{{g}_{2} {g}_{3}}{{C}_{1} {C}_{2}}} & ( 2.2 ) \\ Q = \frac{1}{{g}_{1}} \sqrt{\frac{{C}_{1} {g}_{2} {g}_{3}}{{C}_{2}}} & ( 2.3 )\end{matrix}$$

Then, we can tune ωₒ first by varying g2 and g3 and then tune Q by adjusting g1 without any disturbance.

The new analytical synthesis method is illustrated as below.

Cross multiplying Eq. (2.1) yields

Vᵢₙ₂(s²C₁C₂)+Vᵢₙ₁(sC₂g₁)+Vᵢₙ₀(g₂g₃)=Vₒᵤₜ(s²C₁C₂+sC₂g₁+g₂g₃) (2.4)

Dividing (2.4) by sC2 yields

$${V}_{in 2} ( {sC}_{1} ) + {V}_{in 1} ( {g}_{1} ) + {V}_{in 0} ( \frac{{g}_{2} {g}_{3}}{{sC}_{2}} ) = {V}_{out} ( {sC}_{1} + {g}_{1} + \frac{{g}_{2} {g}_{3}}{{sC}_{2}} ) \qquad ( 2.5 )$$

Re-arranging (2.5) yields

$$( {V}_{in 2} - {V}_{out} ) {sC}_{1} + ( {V}_{in 1} - {V}_{out} ) {g}_{1} = - ( {V}_{in 0} - {V}_{out} ) \frac{{g}_{2} {g}_{3}}{{sC}_{2}} \qquad ( 2.6 )$$

Assuming a new node voltage V

$$V = - \frac{{g}_{3}}{{sC}_{2}} ( {V}_{in 0} - {V}_{out} ) \qquad ( 2.7 )$$

i.e., (Vᵢₙ₀−Vₒᵤₜ)g₃+V(sC₂)=0 (2.8)

Substituting (2.7) into (2.6) yields the following equation.)

(Vᵢₙ₂−Vₒᵤₜ)sC₁+(Vᵢₙ₁−Vₒᵤₜ)g₁=Vg₂ (2.9)

The above algebra operations obtain the two simple and feasible equations, (2.8) and (2.9), both of which lead to the following two OTA-C sub-circuits illustrated in FIGS. 2.1 and 2.2, respectively.

The combination of the above two sub-circuits produces FIG. 2.3, the tunable voltage-mode OTA-C universal biquad structure, which employs (i) for low-pass and band-pass: two single-ended-input and one differential-input OTAs, and two grounded capacitors; (ii) for high-pass: three single-ended-input OTAs, one grounded and one floating capacitors; (iii) for notch (or band-reject): two single-ended-input and one differential-input OTAs, and one grounded and one floating capacitors; and (iv) for all-pass: one single-ended-input and two differential-input OTAs and one grounded and one floating capacitors.

2.2 Analytical Synthesis Method of Tunable Current-Mode OTA-C Universal Biquad Structure

The following depicts the analytical synthesis method of the tunable current-mode universal (including low-pass, band-pass, high-pass, notch, and all-pass) biquad structure which was originally synthesized recently [27] using the model based on nullators, norators, current mirrors, and passive R (resistor) and C (capacitor) elements.

The five generic current-mode filtering functions, low-pass, band-pass, high-pass, notch, and all-pass, have the following three algebraic relationships:

$$\begin{matrix}1 + ( - \frac{{I}_{BP}}{{I}_{in}} ) = \frac{{I}_{NH}}{{I}_{in}} & ( 2.10 ) \\ \frac{{I}_{NH}}{{I}_{in}} + ( - \frac{{I}_{LP}}{{I}_{in}} ) = \frac{{I}_{HP}}{{I}_{in}} & ( 2.11 ) \\ \frac{{I}_{NH}}{{I}_{in}} + ( - \frac{{I}_{BP}}{{I}_{in}} ) = \frac{{I}_{AP}}{{I}_{in}} & ( 2.12 )\end{matrix}$$

It is apparent from Eq. (2.10) to (2.12) that both inverting low-pass and inverting band-pass filtering signals form the two fundamental (like seed) signals from which the other three, namely, notch, high-pass, and all-pass generic filtering signals can be obtained. Hence, the new analytical synthesis method may focus on a more condensed filter structure, i.e., the realization of current-mode OTA-C inverting low-pass and inverting band-pass biquad structure.

The simplest inverting low-pass and band-pass filtering transfer functions with the tunability of ωₒ (resonant angular frequency) and Q (quality factor) may be illustrated as below.

$$\begin{matrix}\frac{{I}_{LP}^{*}}{{I}_{in}} = \frac{- {g}_{2} {g}_{3}}{{s}^{2} {C}_{1} {C}_{2} + {sC}_{2} {g}_{1} + {g}_{2} {g}_{3}} & ( 2.13 ) \\ \frac{- {I}_{BP}}{{I}_{in}} = \frac{- {sC}_{2} {g}_{1}}{{s}^{2} {C}_{1} {C}_{2} + {sC}_{2} {g}_{1} + {g}_{2} {g}_{3}} & ( 2.14 )\end{matrix}$$

in both of which

$$\begin{matrix}{ω}_{o} = \sqrt{\frac{{g}_{2} {g}_{3}}{{C}_{1} {C}_{2}}} & ( 2.15 ) \\ Q = \frac{1}{{g}_{1}} \sqrt{\frac{{C}_{1} {g}_{2} {g}_{3}}{{C}_{2}}} & ( 2.16 )\end{matrix}$$

Then, g2 and g3 may be tuned first for an appropriate ωₒ, and then vary g1 for a proper Q. This characteristic means tunability. Both (2.13) and (2.14) can be equivalent to (2.17) and (2.18) respectively using the input-output characteristic of an OTA, i.e., Iout=gvin.

$$\begin{matrix}\frac{{I}_{LP}^{*}}{{I}_{in}} = \frac{{V}_{LP} {g}_{2}}{{I}_{in}} = \frac{- {g}_{2} {g}_{3}}{{s}^{2} {C}_{1} {C}_{2} + {sC}_{2} {g}_{1} + {g}_{2} {g}_{3}} & ( 2.17 ) \\ \frac{- {I}_{BP}}{{I}_{in}} = \frac{- {V}_{BP} {g}_{1}}{{I}_{in}} = \frac{- {sC}_{2} {g}_{1}}{{s}^{2} {C}_{1} {C}_{2} + {sC}_{2} {g}_{1} + {g}_{2} {g}_{3}} & ( 2.18 )\end{matrix}$$

Then both (2.17) and (2.18) can be simplified as

$$\begin{matrix}\frac{{V}_{LP}}{{I}_{in}} = \frac{- {g}_{3}}{{s}^{2} {C}_{1} {C}_{2} + {sC}_{2} {g}_{1} + {g}_{2} {g}_{3}} & ( 2.19 ) \\ \frac{{V}_{BP}}{{I}_{in}} = \frac{{sC}_{2}}{{s}^{2} {C}_{1} {C}_{2} + {sC}_{2} {g}_{1} + {g}_{2} {g}_{3}} & ( 2.20 )\end{matrix}$$

Cross multiply (2.19) and (2.20) subsequent to

(s²C₁C₂+sC₂g₁+g₂g₃)V_{LP}=−g₃Iᵢₙ (2.21)

(s²C₁C₂+sC₂g₁+g₂g₃)V_{BP}=sC₂Iᵢₙ (2.22)

Taking sC2 out from (s2C1C2+sC2 g1) in both (2.21) and (2.22) yields

[sC₂(sC₁+g₁)+g₂g₃]V_{LP}=−g₃Iᵢₙ (2.23)

[sC₂(sC₁+g₁)+g₂g₃]V_{BP}=sC₂Iᵢₙ (2.24)

Dividing (2.23) and (2.24) by (−g3) and sC2, respectively yields

$$\begin{matrix}[ ( {sC}_{1} + {g}_{1} ) ( - \frac{{sC}_{2}}{{g}_{3}} {V}_{LP} ) - {g}_{2} {V}_{LP} ] = {I}_{in} & ( 2.25 ) \\ [ ( {sC}_{1} + {g}_{1} ) {V}_{BP} - {g}_{2} ( - \frac{{g}_{3}}{{sC}_{2}} {V}_{BP} ) ] = {I}_{in} & ( 2.26 )\end{matrix}$$

Then, the simplest setting for node voltages is given by

$$- \frac{{sC}_{2}}{{g}_{3}} {V}_{LP} ≡ {V}_{BP} , \qquad ( 2.27 )$$

which produces

$$- \frac{{g}_{3}}{{sC}_{2}} {V}_{BP} = {V}_{LP} \qquad ( 2.28 )$$

Thus, (2.25) and (2.26) become (2.29) and (2.30), respectively, both of which are the same.

[(sC₁+g₁)V_{BP}−g₂V_{LP}]=Iᵢₙ (2.29)

[(sC₁+g₁)V_{BP}−g₂V_{LP}]=Iᵢₙ (2.30)

The above algebraic derivation obtains the two simple and feasible equations (2.27) and (2.29), both of which lead to the following two OTA-C sub-circuits illustrated in FIGS. 2.4 and 2.5, respectively.

The combination of the above two sub-circuits produces FIG. 2.6 in which the inverting low-pass and the inverting band-pass signals can be easily obtained.

Multiplied by Iin, (2.10), (2.11), and (2.12) become

Iᵢₙ+(−I_{BP})=I_{NH} (2.31)

I_{NH}+(−I_{LP})=I_{HP} (2.32)

I_{NH}+(−I_{BP})=I_{AP} (2.33)

Then, inserting an input current signal for joining an inverting band-pass signal can obtain a notch (or band-reject) output signal as illustrated in FIG. 2.7 which was presented recently using the model based on nullators, norators, current mirrors, and passive R and C elements. Moreover, the current-mode high-pass and all-pass signals can also be obtained by joining both notch and inverting low-pass and both notch and inverting band-pass signals, respectively. Note that the tunable current-mode biquad employs three single-ended-input OTAs and two grounded capacitors.

2.3 Filtering Performance Comparison

Part I: Filtering Performance Comparison with the Recently Reported Biquads [25, 26]:

Both the voltage-mode and the current-mode OTA-C universal biquads illustrated in FIGS. 2.3 and 2.7, respectively, use the minimum number of active and passive components, i.e., three OTAs and two capacitors. But the two recently reported universal biquads [25, 26] employ three [25] (resp. four [26]) differential-input OTAs and two [25] (resp. three [26]) single-ended-input OTAs in addition to two grounded capacitors. The comparison from precise point of view among the above four universal biquads are illustrated in FIGS. 2.8 to 2.12 and Table 2-I using the TSMC035 level-49H-Spice simulation (using the CMOS implementation of the OTA [28] with supply voltages VBDDB=1.65V, VBSSB=−1.65V, and W/L=5μ/0.35μ and 10μ/0.35μ for NMOS and PMOS transistors, respectively, and the element values: g1=444.28 μS, g2=g3=314.15 μS, and C1=C2=50 pF for FIGS. 2.3 and 2.7, and all transconductances are given by 314.159 μS, and C1=C2=50 pF for the two recently reported universal biquads [25, 26]). It is apparent that the precision of the two new tunable universal biquads illustrated in FIGS. 2.3 and 2.7 is much better than that of those two recently reported universal biquads illustrated in [25, 26]. Note that both FIGS. 2.3 and 2.7 have the same precision at 1 MHz with 0.3% error for low-pass, −0.3% error for high-pass, 0.00% error for both band-pass and band-reject, and 1.1% error for voltage-mode all-pass and −1.2% error for current-mode all-pass. It is clear from FIG. 2.8 to 2.12 and Table 2-I that the two OTA-C universal biquad filters with the minimum number of components illustrated in FIGS. 2.3 and 2.7 are much more precise in output responses than the two recently reported universal biquads [25, 26] having two [25] or four [26] more OTAs, when the theoretical resonant frequency is 1 MHz. It may be concluded that the fewer the number of components the more precise the output responses.

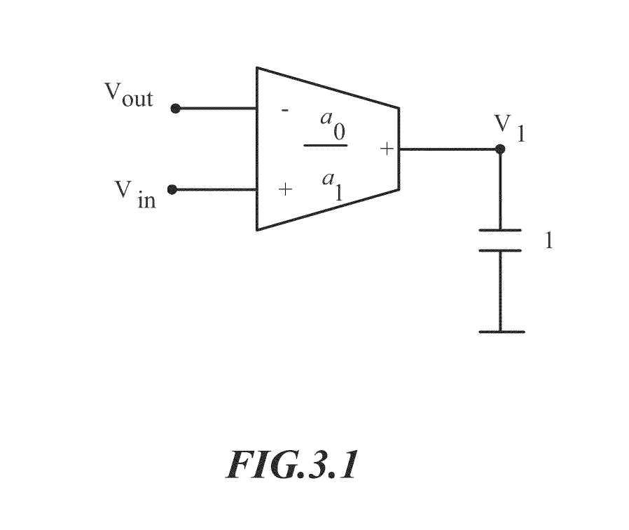

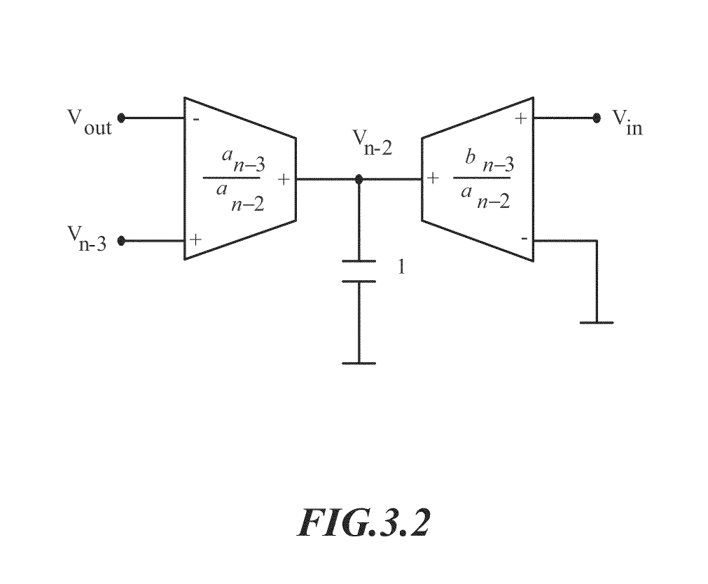

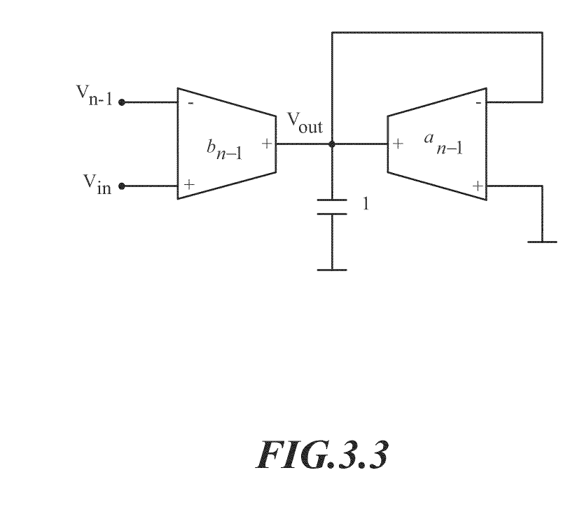

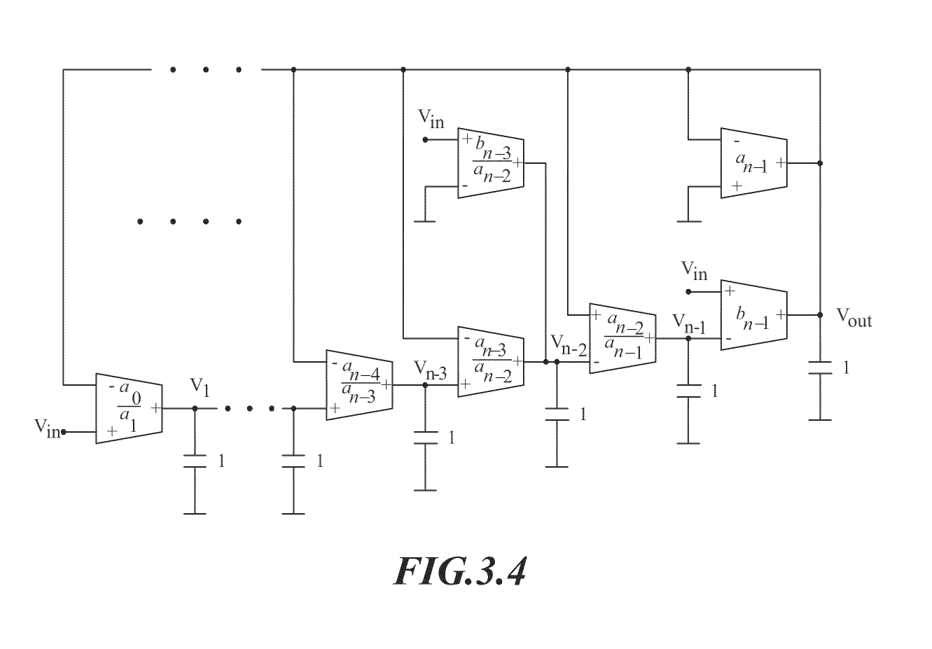

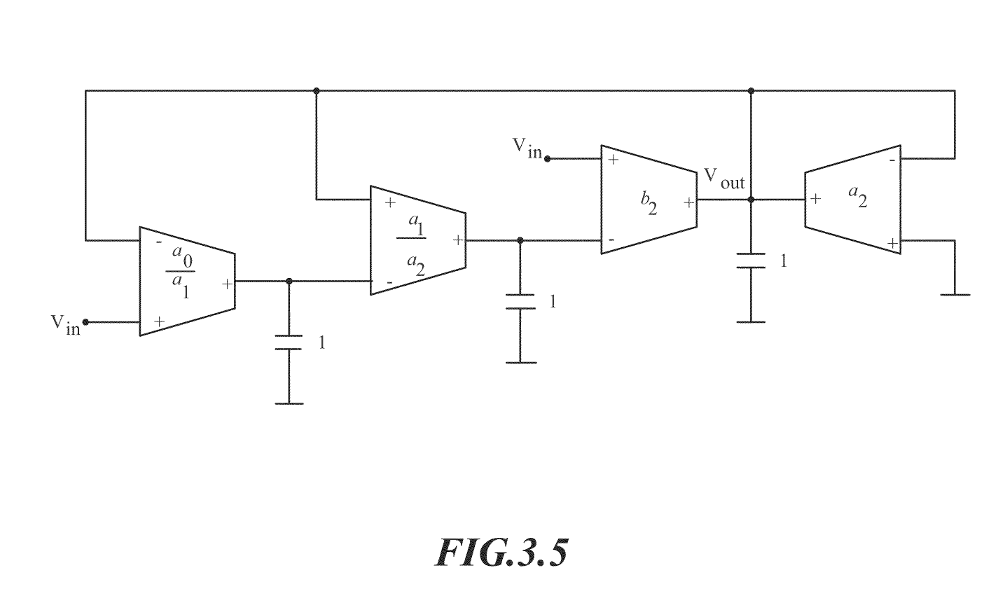

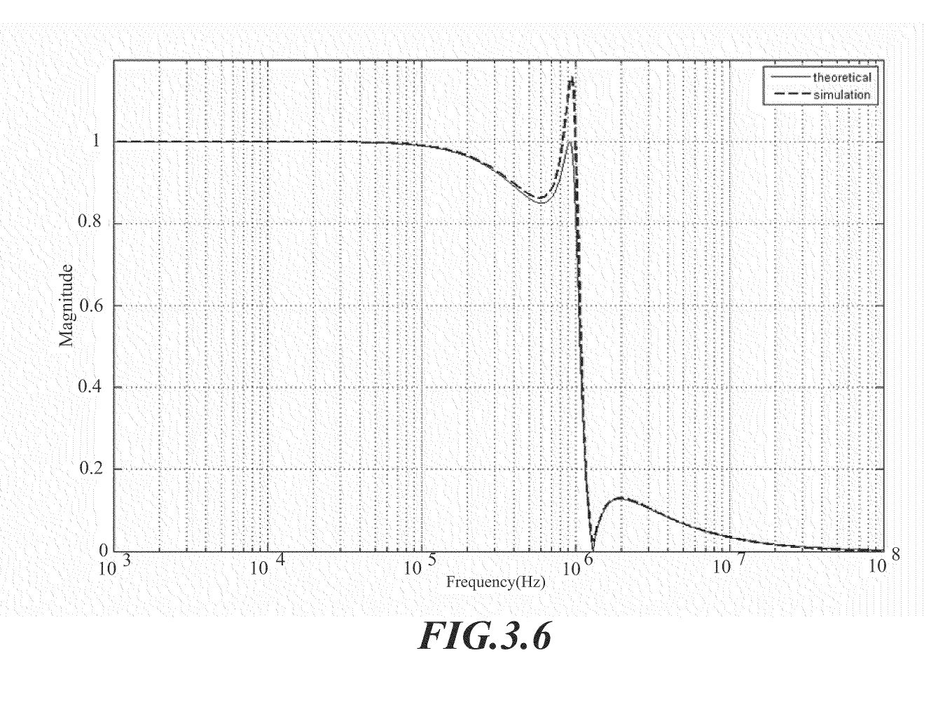

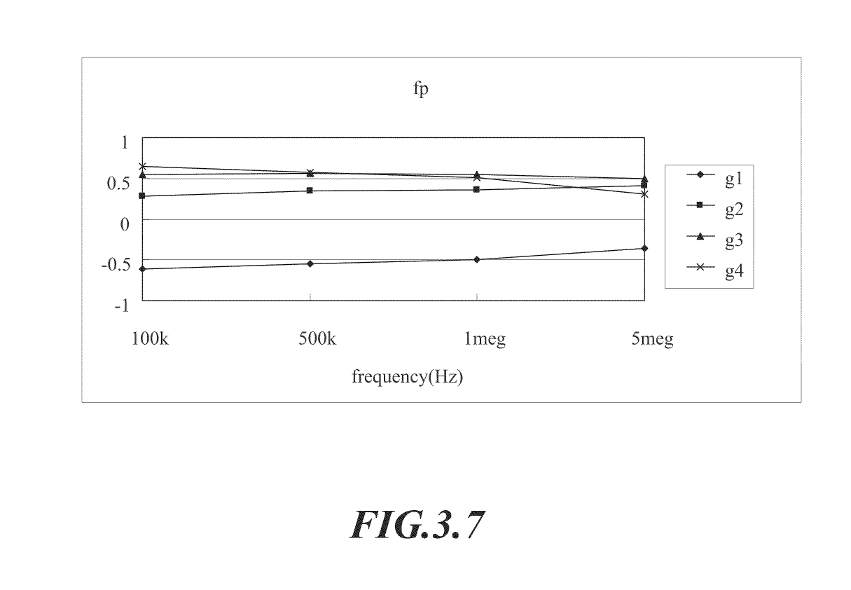

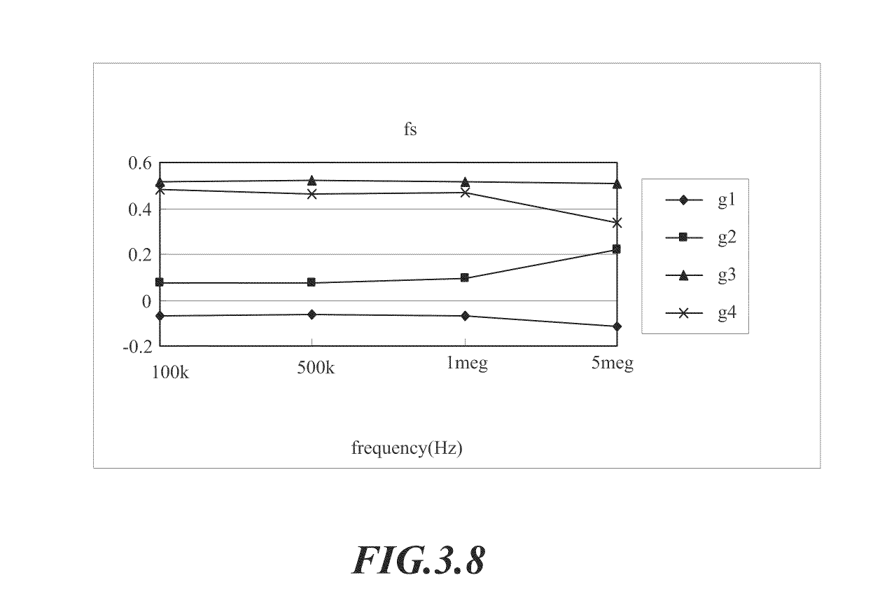

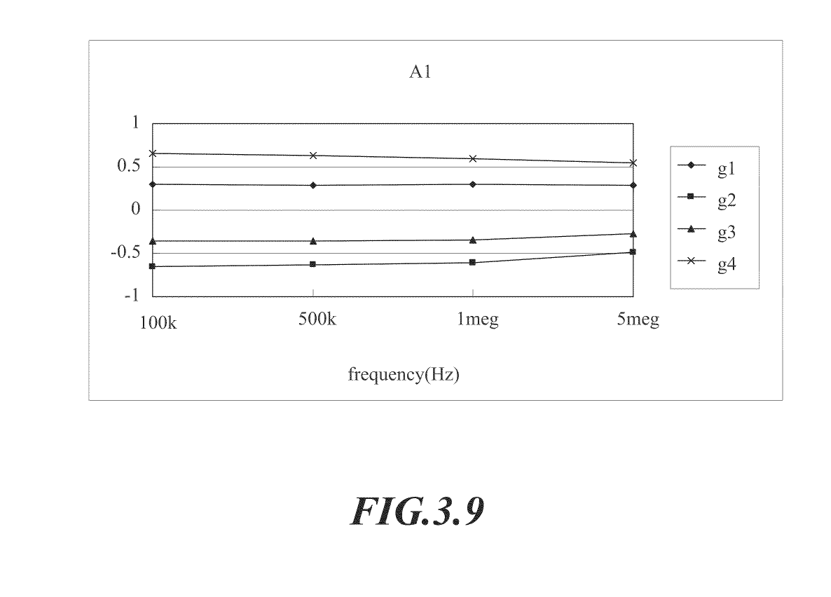

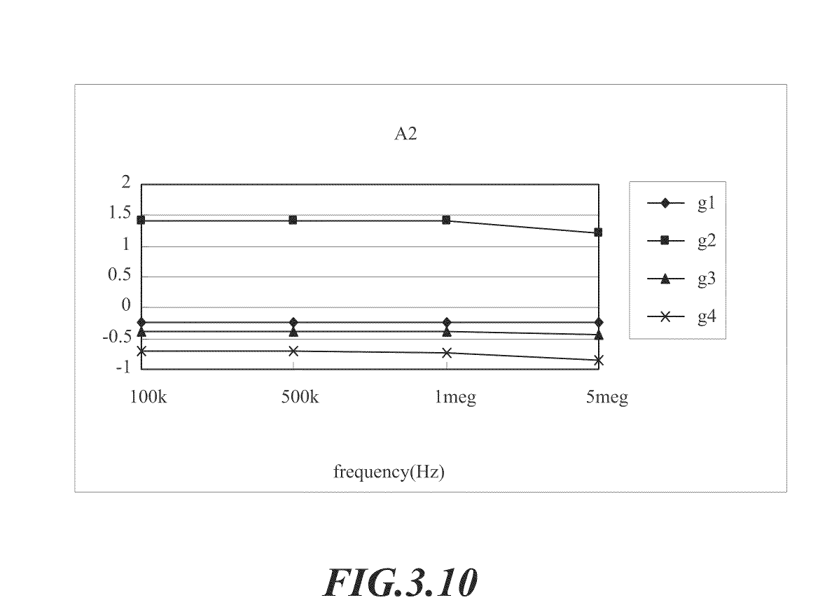

TABLE 1
Comparison among the four OTA-C universal biquads

| | Filter | | | | |
|---|---|---|---|---|---|
| | f3dB (LP) | f3dB (HP) | fc (BP) | fc (BR) | fc (AP) |
| Biquad | error % | error % | error % | error % | error % |
| FIG. 3 | 1.003 | 0.997 | 1.0000 | 1.0000 | 1.011 |
| | 0.3% | (−0.3%) | 0.00% | 0.00% | (1.1%) |
| [27] | 1.003 | 0.997 | 1.0000 | 1.0000 | 0.988 |
| | 0.3% | (−0.3%) | 0.00% | 0.00% | (−1.2%) |
| [25] | 1.2769 | 0.7861 | 1.0000 | 1.0000 | 0.9885 |
| | (−27.69%) | (−21.39%) | 0.00% | 0.00% | (−1.15%) |
| [26] | 1.2740 | 0.7854 | 1.0233 | 1.0233 | 0.9885 |
| | (−27.40%) | (−21.46%) | −2.33% | −2.33% | (−1.15%) |

Part II: Filtering Performance Comparison Between the Current-Mode and the Voltage-Mode Universal Biquads Illustrated in FIGS. 2.3 and 2.7, Respectively:

The advanced comparison between the tunable voltage-mode (illustrated in FIG. 2.3) and current-mode (illustrated in FIG. 2.7) universal biquads when the operating frequency is higher than 1 MHz, are presented as below.

1. For Low-Pass Responses:

The simulation results are illustrated in Table 2-2 with the following component values: (i) from 1 MHz to 250 MHz, g1=444.28 μS, g2=g3=314.15 μS, and C1=C2=from 50 pF to 0.2 pF; (ii) from 300 MHz to 850 MHz, g1=222.14 μS, g2=g3=157.075 μS, and C1=C2=from 0.0833 pF to 0.0294 pF; (iii) at 900 MHz, g1=177.712 μS, g2=g3=125.66 μS, and C1=C2=0.0222 pF; and (iv) at 950 MHz, g1=168.83 μS, g2=g3=1129.38 μS, and C1=C2=0.02 pF. Although both voltage and current mode ones have very low (only 0.3%) error at 1 MHz, which is much more precise than the recently reported biquads with −27.69% (in a related art) and −27.40% (in another related art) errors at 1MHz, when the operating frequency increases, the precision of the voltage-mode one is better in the frequency range from 1 to 200 MHz and from 500 to 950 MHz, but is worse from 200 to 500 MHz, than the current-mode one. The parasitic is a nonlinear function of frequency which is not just getting straight larger with the increasing operating frequency. For the voltage-mode one, i.e., for FIG. 2.3, the f3dB error is abruptly getting larger from 1 MHz to 150 MHz, at which the biquad has the largest parasitics leading to a 31.8% error for the f3 dB, is gradually getting smaller from 150 MHz to 750 MHz, at which the error is reduced to only 0.97%, and then increases (to −5.19% error) again from 750 MHz to 950 MHz. On the other hand for the current-mode one illustrated in FIG. 2.7, the f3dB error is getting larger from 1 MHz to 150 MHz, getting smaller from 150 MHz to 350 MHz, and then getting larger and larger from 350 MHz to 950 MHz. The output responses of the voltage and the current mode biquads at 950 MHz are illustrated in FIG. 2.13. Note that the parasitic capacitance (resp. conductance) makes the simulated resonant frequency be smaller (resp. larger) than the theoretical resonant frequency. Therefore, when the simulated resonant frequency is higher (resp. lower) than the theoretical resonant frequency, the effect of parasitic conductances is larger (resp. smaller) than that of parasitic capacitances.

TABLE 2.2
Filtering performance comparison between voltage mode
and current mode low-pass biquad structures

Param.

| | f3dB & error | Peak | f3dB & error | Peak |
|---|---|---|---|---|
| Freq. | (VM) | (VM) | (CM) | (CM) |
| 1 MHz | 1.003, 0.3% | 0.998 | 1.003, 0.3% | 0.998 |
| 50 MHz | 59.3, 8.6% | 1.052 | 60.6, 21.2% | 1.070 |
| 150 MHz | 198, 31.8% | 1.58 | 199, 32.9% | 1.76 |
| 250 MHz | 318, 27.1% | 2.97 | 314, 25.7% | 3.67 |
| 350 MHz | 396, 13.1% | 5.43 | 363, 3.61% | 7.91 |
| 450 MHz | 489, 8.7% | 3.46 | 432, −4.10% | 6.18 |
| 550 MHz | 581, 5.6% | 2.76 | 490, −10.9% | 6.16 |
| 650 MHz | 670, 3.1% | 2.40 | 536, −17.5% | 7.04 |
| 750 MHz | 757, 0.97% | 2.19 | 564, −24.7% | 9.44 |
| 850 MHz | 838, −1.44% | 2.04 | 563, −33.8% | 12.88 |
| 950 MHz | 901, −5.19% | 1.73 | 87, −90.8% | 1.75 |

2. For High-Pass Responses:

The simulation results are illustrated in Table 2-3 with the following component values: (i) from 1 MHz to 200 MHz, g1=444.28 μS, g2=g3=314.15 μS, and C1=C2=from 50 pF to 0.25 pF; (ii) from 250 MHz to 750 MHz, g1=222.14 μS, g2=g3=157.075 μS, and C1=C2=from 0.1 pF to 0.0333 pF. Although both voltage and current mode ones have very low (only 0.3%) error at 1 MHz, which is much more precise than the recently reported circuits with −21.39% (in a related art) and −21.46% (in another related art) errors at 1MHz, when the operating frequency is getting higher to 750 MHz, both the voltage-mode and the current-mode biquads have the nearly same f3dB error with a gradually increment from −0.3% to about −60% errors. The output responses of the voltage and the current mode high-pass biquads at 250 MHz are illustrated in FIG. 2.14, in which the voltage mode one is better in f3dB error and peak value than the current mode one. And in this high-pass case, the effect of parasitic capacitances increases as the operating frequency increases from 1 to 750 MHz.

TABLE 2-3
Filtering performance comparison between voltage mode
and current mode high-pass biquad structures.

| | Param. | | | |
|---|---|---|---|---|
| | f3dB & error | Peak | f3dB & error | Peak |
| Freq. | (VM) | (VM) | (CM) | (CM) |
| 1 MHz | .997, −0.3% | 1.002 | .997, −0.3% | 1.003 |
| 8 MHz | 7.73, −3.43% | 1.01 | 7.7, −3.7% | 1.025 |
| 50 MHz | 42, −17.0% | 1.1. | 41, −17.9% | 1.18 |
| 150 MHz | 103, −31.7% | 1.47 | 101, −32.4% | 1.83 |
| 250 MHz | 155, −37.9% | 2.23 | 143, −42.9% | 62.9 |
| 350 MHz | 188, −46.4% | 5.63 | 187, −46.5% | 7.41 |
| 450 MHz | 226, −49.8% | 3.48 | 225, −49.9% | 5.72 |
| 550 MHz | 257, −53.2% | 3.16 | 256, −53.4% | 5.89 |
| 650 MHz | 280, −56.9% | 3.92 | 279, −57.0% | 7.25 |
| 750 MHz | 295, −60.7% | 10.16 | 293, −60.9% | 7.85 |

3. For Band-Pass Responses:

The simulation results are illustrated in Table 2-4 with the following component values: (i) from 1 MHz to 200 MHz, g1=444.28 μS, g2=g3=314.15 μS, and C1=C2=from 50 pF to 0.25 pF; (ii) from 250 MHz to 600 MHz, g1=222.14 μS, g2=g3=157.075 μS, and C1=C2=from 0.1 pF to 0.042 pF. Although both voltage and current mode ones have null (0.00%) error at 1 MHz, which is the same as the recent one (in a related art) and more precise than another recently reported one with −2.33% error (in another related art) at 1MHz, when the operating frequency increases, the precision of the voltage-mode one is better in the frequency range from 1 to 100 MHz, but is worse from 150 to 600 MHz, than the current-mode one except at 500 MHz. The parasitic is a non-linear function of frequency which does not just increases with the increasing the operating frequency. For the voltage-mode one illustrated in FIG. 2.3, the null distortion remains from 1 MHz to 100 MHz except at 50 MHz with 2.6% error, and the deviation increases from 150 MHz to 600 MHz with −3.6% error to −42.2% error except at 500 MHz. On the other hand, for the current-mode one illustrated in FIG. 2.7, the f3dB error increases from 1 MHz (0.00% error) to 50 MHz (4.96% error), decreases from 50 MHz to 150 MHz (only 0.9% error), and then significantly increases from 150 MHz with only 0.9% error to 600 MHz with −40.9% error). The comparison between the voltage and the current mode band-pass biquads, the voltage mode is more precise than the current mode from 1 MHz to 100 MHz, but the superiority is changed from 150 MHz to 600 MHz except the case at 500 MHz. The output responses of the voltage and the current mode biquads at both 50 and 200 MHz are illustrated in FIG. 2.15.

TABLE 2-4
Filtering performance comparison between voltage mode
and current mode band-pass. biquad structures

| | Param. | | | |
|---|---|---|---|---|
| | f3dB & error | Peak | f3dB & error | Peak |
| Freq. | (VM) | (VM) | (CM) | (CM) |
| 1 MHz | 1.00, 0.00% | 1.001 | 1.00, 0.00% | 1.000 |
| 10 MHz | 10.0.0.00% | 1.038 | 10.233, 2.33% | 1.037 |
| 50 MHz | 51.3, 2.6% | 1.233. | 52.5, 4.96% | 1.238 |
| 100 MHz | 100, 0.00% | 1.554 | 104.7, 4.7% | 1.588 |
| 150 MHz | 144.5, −3.6% | 1.987 | 151.4, 0.9% | 2.075 |
| 200 MHz | 181.9, −9.0% | 2.543 | 190.5, −4.7% | 2.746 |
| 300 MHz | 229, −23.6% | 43.29 | 234.4, −21.9% | 35.56 |
| 400 MHz | 275, −31.1% | 12.64 | 346.7, −13.3% | 11.38 |
| 500 MHz | 380, −24.0% | 5.82 | 346.7, −36.9% | 7.45 |
| 600 MHz | 347, −42.2% | 12.18 | 354.8, −40.9% | 36.26 |

4. For Band-Reject Responses:

The simulation results are illustrated in Table 2-5 with the following component values: from 1 MHz to 200 MHz, g1=444.28 μS, g2=g3=314.15 μS, and C1=C2=from 50 pF to 0.25 pF. Although both voltage and current mode ones have null (0.00%) error at 1 MHz, which is the same as the recent one (in a related art) and more precise than another recently reported one with −2.33% (in another related art) error at 1MHz, when the operating frequency increases, the precision of the voltage-mode one is better in the f3dB error, but is worse about the deepest value in the band-reject range, from 1 to 200 MHz, than the current-mode one. It is noted that the higher the operating frequency the higher the deepest value of the band-reject amplitude-frequency response is. Note that the band-reject response is the superposition of the low-pass and the high-pass responses. It is noted that the parasitic lets the low-pass (resp. high-pass) part of the ban-reject output response be shifted to the higher (resp. lower) frequency (referring to Tables 2-2 and 2-3), due to the effect of parasitic conductances (resp. capacitances), and then allows the deepest value of the ban-reject output response significantly increase (even over than unity in magnitude, for example, at 200 MHz for the voltage mode one), as the operating frequency increases. The output responses of the voltage and the current mode biquads at 50 MHz are illustrated in FIG. 2.16. The voltage mode one enjoys more precise f3dB but a worse deepest value in the frequency range from 1 to 200 MHz.

TABLE 2-5
Filtering performance comparison between voltage mode
and current mode band-reject biquad structures.

| | Param. | | | |
|---|---|---|---|---|
| | f3dB & error | Deepest | f3dB & error | Deepest |
| Freq. | (VM) | (VM) | (CM) | (CM) |
| 1 MHz | 1.000, 0.00% | 0.0029 | 1.00, 0.00% | 0.0006 |
| 10 MHz | 10.00, 0.00% | 0.0394 | 10.00.0.00% | 0.0372 |
| 20 MHz | −19.95, 0.24% | 0.0834 | 19.95, −0.24% | 0.0808 |
| 40 MHz | 39.81, −0.47% | 0.1797 | 38.90, −2.74% | 0.1756 |
| 45 MHz | 44.67, −0.74% | 0.2058 | 43.65, −2.99% | 0.2015 |
| 50 MHz | 48.98, −2.04% | 0.2308 | 47.86, −4.27% | 0.2285 |
| 100 MHz | 93.33, −6.67% | 0.5438 | 89.13, −10.87% | 0.5357 |
| 150 MHz | 112.20, −25.20% | 0.9418 | 109.65, −26.9% | 0.8588 |
| 200 MHz | 186.21, −6.90% | Bandpass | 77.62, −61.2% | 0.99 |

5. For all-Pass Responses:

The simulation results are illustrated in Table 2-6 with the following component values: (i) from 1 MHz to 200 MHz, g1=444.28 μS, g2=g3=314.15 μS, and C1=C2=from 50 pF to 0.25 pF, (ii) from 300 MHz to 400 MHz, g1=355.4 μS, g2=g3=251.3 μS, and C1=C2=from 0.1333 pF to 0.1 pF, (iii) at 500 MHz, g1=266.67 μS, g2=g3=188.5 μS, and C1=C2=0.0667 pF, (iv) at 600 MHz, g1=222.14 μS, g2=g3=157.1 μS, and C1=C2=0.042 pF, and (v) from 700 to 750 MHz, g1=177.7 μS, g2=g3=125.7 μS, and C1=C2=from 0.0286 pF to 0.0267 pF. Both voltage and current mode ones have 1.1% and −1.2% errors at 1 MHz, respectively, which is near the recently reported error, −1.15% (in a related art) and (in another related art) at 1MHz. As the operating frequency increases, (i) from 1 MHz to 25 MHz, the f3dB error correspondingly decreases to −0.668%; and (ii) from 25 MHz to 750 MHz, the f3dB error is getting larger and larger from −0.668% to −57.3% (for the current mode one) or to −62.0% (for the voltage mode one). The phase difference of the current-mode (resp. voltage-mode) output signal is from 176° to −180° (resp. 180° to −176°) reduced to 62° to −52° (resp. 54° to −76°) as the operating frequency increases from 1 MHz to 500 MHz. But, as the operating frequency drastically increases from 500 MHz to 750 MHz, the phase difference gets better from the worst case (at 500 MHz) to the nearly normal case (at 750 MHz) with 179° to −175° and 175° to −178°, respectively, for the voltage and current mode ones. In all, the simulated phase difference can be practically used in the frequency range from 1 to 300 MHz and the range upper than 700 MHz. Table 2-6 illustrates that the current-mode one is a little bit better than the voltage-mode one from the precision point of view. FIG. 2.17 illustrates the phase and amplitude frequency responses for both the voltage and current mode all-pass biquads illustrated in FIGS. 2.3 and 2.7, respectively. The nearly equal-quantity parasitics are involved in both the voltage and current mode all-pass biquads and lead to nearly similar output distortion although the current mode one is a little bit better.

TABLE 2-6
Filtering performance comparison between voltage mode
and current mode all-pass biquad structures.

| | Param. | | | |
|---|---|---|---|---|
| | f3dBerror | Phase | f3dB error | Phase |
| Freq. | (VM) | (VM) | (CM) | (CM) |
| 1 MHz | 1.1% | 176o~−180o | −1.2% | 180o~−176o |
| 10 MHz | −1.15% | 180o~−177o | −1.15% | 179o~−177o |
| 25 MHz | −0.67% | 178o~−178o | −0.67% | 178o~−179o |
| 50 MHz | −0.89% | 177o~−180o | −0.89% | 176o~−180o |
| 100 MHz | −3.38% | 176o~−180o | −3.38% | 177o~−179o |
| 200 MHz | −10.1% | 177o~−176o | −7.95% | 176o~−177o |
| 300 MHz | −17.3% | 178o~−159o | −13.3% | 173o~−165o |
| 400 MHz | −21.5% | 80o~−79o | −17.9% | 83o~−145o |
| 500 MHz | −30.7% | 62o~−52o | −24.6% | 54o~−76o |
| 600 MHz | −40.6% | 71o~−47o | −38.8% | 104o~−91o |
| 700 MHz | −56.3% | 171o~−178o | −53.2% | 175o~−176o |
| 750 MHz | −62.0% | 179o~−175o | −57.3% | 175o~−178o |

2.4 Sensitivities and Tunings

The component sensitivities for different kinds of filtering output signals are obtained and presented as below using the same H-Spice simulation. Applying the results of the component sensitivities, the error of output responses can be much reduced just proper tuning the component values.

Part I. Low-Pass Sensitivity and Tuning

The sensitivities of 3 dB frequency for the current mode and voltage mode low-pass biquads to each component are illustrated in Tables 2-7 (in FIG. 2.18) and 2-8 (in FIG. 2.19), respectively. They illustrate that the sensitivity is a function of frequency. For the current mode one, the component sensitivities in absolute value form except for components g1 and C1 are reduced from unity (at 1 MHz) to a small value (about at 300 MHz) and then increase and have an abrupt amplification from 800 MHz to 900 MHz. The tendency of the component sensitivity in absolute value form for g1 is nearly the same as the above three cases but without an abrupt amplification from 800 MHz to 900 MHz, only just keeping the same small value 0.233. However, the component sensitivity in absolute value form for C1 is always kept by a value smaller than 0.291. As to the voltage mode one, the component sensitivities in absolute value form except for component C1 are straight reduced from unity (at 1 MHz) to a very small value (at 900 MHz). The component sensitivity for C1 is always kept at an absolute value smaller than 0.287 like the case of the current mode one. It is apparent that the component sensitivity of the voltage mode low-pass one illustrated in FIG. 2.3 is smaller in absolute value form than that of the current mode one illustrated in FIG. 2.7.

TABLE 2-7
The sensitivity of 3 dB frequency for the current mode low-pass
biquad illustrated in FIG. 2.7.

| | Sensi. | | | | |
|---|---|---|---|---|---|
| | For g1 | For g2 | For g3 | For C1 | For C2 |
| Freq. | (CM) | (CM) | (CM) | (CM) | (CM) |
| 1 MHz | 0.950 | −1.071 | −1.071 | −0.020 | 0.986 |
| 100 MHz | 0.503 | −0.700 | −0.698 | 0.291 | 0.695 |
| 200 MHz | 0.302 | −0.542 | −0.532 | 0.290 | 0.434 |
| 300 MHz | −0.0096 | −0.375 | −0.393 | 0.235 | 0.299 |
| 400 MHz | −0.0126 | −0.389 | −0.424 | 0.210 | 0.307 |
| 500 MHz | 0.0074 | −0.439 | −0.490 | 0.175 | 0.369 |
| 600 MHz | 0.051 | −0.535 | −0.600 | 0.159 | 0.452 |
| 700 MHz | 0.122 | −0.704 | −0.787 | 0.130 | 0.592 |
| 800 MHz | 0.233 | −1.023 | −1.122 | 0.095 | 0.832 |
| 900 MHz | 0.236 | −6.707 | −6.600 | −0.009 | 3.529 |

TABLE 2-8
The sensitivity of 3 dB frequency for the voltage mode low-pass
biquad illustrated in FIG. 2.3.

| | Sensi. | | | | |
|---|---|---|---|---|---|
| | For g1 | For g2 | For g3 | For C1 | For C2 |
| Freq. | (VM) | (VM) | (VM) | (VM) | (VM) |
| 1 MHz | 0.997 | −1.017 | −1.017 | −0.020 | 1.037 |
| 100 MHz | 0.575 | −0.757 | −0.757 | 0.270 | 0.763 |
| 200 MHz | 0.362 | −0.569 | −0.570 | 0.287 | 0.284 |
| 300 MHz | 0.001 | −0.288 | −0.300 | 0.216 | 0.239 |
| 400 MHz | 0.016 | −0.251 | −0.266 | 0.169 | 0.191 |
| 500 MHz | 0.015 | −0.215 | −0.229 | 0.152 | 0.152 |
| 600 MHz | −0.007 | −0.203 | −0.218 | −0.084 | −0.054 |
| 700 MHz | 0.0059 | −0.195 | −0.209 | 0.119 | 0.151 |
| 800 MHz | 0.038 | −0.189 | −0.204 | 0.112 | 0.149 |
| 900 MHz | 0.014 | −0.163 | −0.174 | 0.096 | 0.120 |

Applying the above sensitivity results to do the tuning of the output parameters, like f3dB and the peak value, the output signal with far larger error may be tuned to a very precise one after a succession of appropriate adjustments of component values. For example, the current-mode (resp. voltage-mode) low-pass output signal (with a theoretical central frequency at 300 MHz) can be tuned and improved from 324.4 MHz to 300.1 MHz (resp. from 347.5 MHz to 299.2 MHz) for the upper 3 dB frequency, and the peak, from 11.4 to 1.186 (resp. from 8.9 to 1.191), respectively, illustrated in FIGS. 2.20 and 2.21 with the final tuned component values, g1=22.2 μS, g2=188.5 μS, g3=188.5 μS, and C1=C2=0.08333 pF (respectively, g1=17.8 μS, g2=164.9 μS, g3=164.9 μS, and C1=C2=0.08333 pF).

Part II. High-pass Sensitivity and Tuning:

The sensitivities of 3 dB frequency for the current mode (FIG. 2.7) and voltage mode (FIG. 2.3) high-pass biquads to each component are illustrated in Tables 2-9 (FIG. 2.22) and 2-10 (FIG. 2.23). They illustrate that the sensitivity is a function of frequency. For example, the higher the operating frequency the larger the sensitivity in absolute value form of 3 dB frequency to component g2, g3, and C2, but the smaller the sensitivity in absolute value form of 3 dB frequency to component g1, and C1 for both current and voltage mode high-pass biquads. After a detail comparison, the current-mode sensitivity is a little bit larger in absolute value form than the voltage mode one in all.

TABLE 2-9
The sensitivity of 3 dB frequency for the current mode high-pass
biquad illustrated in FIG. 2.7.

| | Sensi. | | | | |
|---|---|---|---|---|---|
| | For g1 | For g2 | For g3 | For C1 | For C2 |
| Freq. | (CM) | (CM) | (CM) | (CM) | (CM) |
| 1 MHz | −0.893 | 0.022 | 0.028 | 1.134 | 0.029 |
| 150 MHz | −0.189 | −0.312 | −0.303 | 0.528 | 0.249 |
| 300 MHz | 0.106 | −0.438 | −0.461 | 0.229 | 0.433 |
| 450 MHz | 0.150 | −0.526 | −0.569 | 0.163 | 0.534 |
| 600 MHz | 0.152 | −0.658 | −0.710 | 0.116 | 0.642 |
| 750 MHz | 0.159 | −0.896 | −0.941 | 0.093 | 0.820 |

TABLE 2-10
The sensitivity of 3 dB frequency for the voltage mode high-pass
biquad illustrated in FIG. 2.3.

| | Sensi. | | | | |
|---|---|---|---|---|---|
| | For g1 | For g2 | For g3 | For C1 | For C2 |
| Freq. | (VM) | (VM) | (VM) | (VM) | (VM) |
| 1 MHz | −0.894 | 0.023 | 0.023 | 1.134 | 0.029 |
| 150 MHz | −0.229 | −0.295 | −0.296 | 0.544 | 0.237 |
| 300 MHz | 0.093 | −0.432 | −0.452 | 0.238 | 0.422 |
| 450 MHz | 0.142 | −0.520 | −0.561 | 0.172 | 0.525 |
| 600 MHz | 0.145 | −0.656 | −0.706 | 0.128 | 0.638 |
| 750 MHz | 0.138 | −0.880 | −0.937 | 0.101 | 0.802 |

Using the sensitivity result, the output response with large error may be tuned to be the one with much smaller error after using the adjustment of component values. For example, the current-mode (resp. voltage-mode) high-pass output response with a theoretical f3dB at 250 MHz has been improved from 142.6 MHz to 250.2 MHz (resp. from 155.4 MHz to 250.2 MHz), and from 62.9 to 1.002 (resp. from 2.23 to 0.924), for f3dB and the peak, respectively, illustrated in FIG. 2.24 (resp. FIG. 2.25) when the tuned component values become g1=11.3 μS, g2=157 μS, g3=311 μS, and C1=C2=0.1 pF (resp. g1=444.3 μS, g2=314.2 μS, g3=314.2 μS, and C1=0.0808 pF, C2=0.4 pF).

Part III. Band-Pass Sensitivity and Tuning:

The sensitivities of central frequency for the current mode (FIG. 2.7) and voltage mode (FIG. 2.3) band-pass biquads to each component are illustrated in Tables 2-11 and 2-12. They illustrate that the sensitivity from 1 MHz to 500 MHz is very small, either 0 or −0.455, or either 0 or 0.466.

TABLE 2-11
The sensitivity of central frequency for the current mode band-pass
biquad illustrated in FIG. 2.7.

| | Sensi. | | | | |
|---|---|---|---|---|---|
| | For g1 | For g2 | For g3 | For C1 | For C2 |
| Freq. | (CM) | (CM) | (CM) | (CM) | (CM) |
| 1 MHz | 0 | −0.455 | −0.455 | 0.466 | 0.466 |
| 50 MHz | 0 | −0.455 | −0.455 | 0.466 | 0.466 |
| 100 MHz | 0.466 | −0.455 | −0.455 | 0.466 | 0.466 |
| 150 MHz | 0.466 | −0.455 | −0.455 | 0.466 | 0.466 |
| 200 MHz | 0.466 | −0.455 | −0.455 | 0.466 | 0.466 |
| 250 MHz | 0 | −0.455 | −0.455 | 0 | 0 |
| 300 MHz | 0 | −0.455 | −0.455 | 0 | 0 |
| 350 MHz | 0.466 | −0.455 | −0.455 | 0.466 | 0.466 |
| 400 MHz | 0.466 | −0.455 | −0.455 | 0.466 | 0.466 |
| 450 MHz | 0 | 0 | 0 | 0 | 0.466 |
| 500 MHz | 0 | 0 | −0.455 | 0 | 0.466 |

TABLE 2-12
The sensitivity of central frequency for the voltage mode
band-pass biquad illustrated in FIG. 2.3.

| | Sensi. | | | | |
|---|---|---|---|---|---|
| | For g1 | For g2 | For g3 | For C1 | For C2 |
| Freq. | (VM) | (VM) | (VM) | (VM) | (VM) |
| 1 MHz | 0 | −0.455 | −0.455 | 0.466 | 0.466 |
| 50 MHz | 0 | −0.455 | −0.455 | 0.466 | 0.466 |
| 100 MHz | 0 | −0.455 | −0.455 | 0.466 | 0 |
| 150 MHz | 0 | −0.455 | −0.455 | 0.466 | 0.466 |
| 200 MHz | 0.466 | −0.455 | −0.455 | 0.466 | 0.466 |
| 250 MHz | 0.466 | 0 | 0 | 0.466 | 0.466 |
| 300 MHz | 0 | −0.455 | −0.455 | 0.466 | 0.466 |
| 350 MHz | 0 | −0.455 | −0.455 | 0.466 | 0.466 |
| 400 MHz | 0 | 0 | 0 | 0.466 | 0.466 |
| 450 MHz | 0 | −0.455 | −0.455 | 0 | 0.466 |
| 500 MHz | 0 | 0 | 0 | 0.466 | 0.466 |

Using the sensitivity result, the output response with large error may be tuned to be the one with small error after using the adjustment of component values. For example, the current-mode (resp. voltage-mode) band-pass output response with a theoretical central frequency at 300 MHz has been improved from 234.4 MHz to 302.0 MHz (resp. from 229.1 MHz to 302.0 MHz), and from 35.6 to 1.125 (resp. from 43.3 to 1.004), in central frequency and the peak, respectively, illustrated in FIG. 2.26 (FIG. 2.27) when the tuned component values become g1=170.8 μS, g2=157.1 μS, g3=306.3 μS, and C1=C2=0.08333 pF (resp. g1=185.0 μS, g2=337.7 μS, g3=157.1 μS, and C1=C2=0.08333 pF).

Part Iv Band-Reject Sensitivity and Tuning

The sensitivities of 3 dB frequency for the current mode (FIG. 2.7) and voltage mode (FIG. 2.3) band-reject biquads to each component are illustrated in Tables 2-13 (FIG. 2.28) and 2-14 (FIG. 2.29). They illustrate that the sensitivity is “not” (different from the above three cases) a function of frequency. The sensitivities of both the current-mode (illustrated in FIG. 2.7) and the voltage-mode (illustrated in FIG. 2.3) band-reject biquads to each component are 0 (for g1), about −0.455 (for g2 and g3), and 0.466 (for both C1 and C2). Both current-mode and voltage-mode band-reject biquads have the same sensitivities at the frequencies from 1 MHz to 100 MHz.

Using the sensitivity result, the output response with large error may be tuned to be the one with much smaller error after using the adjustment of component values. For example, the current-mode (resp. voltage-mode) band-reject output response with a theoretical central frequency at 100 MHz has been improved from 89.1 MHz with −10.9% error to 97.7 MHz with only −2.3% error (resp. from 93.3 MHz with −6.67% error to 100 MHz without any error), from 0.5357 to 0.2844 (resp. from 0.5439 to 0.3138), and from 1.22 to 1.21 (resp. from 1.07 to 1.06), in central frequency, the deepest value, and the peak, respectively, illustrated in FIG. 30 (resp. FIG. 31), when the tuned component values become g1=473.4 μS, g2=460 μS, g3=467.5 μS, and C1=0.5 pF, C2=1.0 pF (resp. g1=477 μS, g2=g3=460 μS, C1=0.5 pF, C2=1.0 pF).

TABLE 2-13
The sensitivity of 3 dB frequency for the current mode high-pass
biquad illustrated in FIG. 2.7.

| | Sensi. | | | | |
|---|---|---|---|---|---|
| | For g1 | For g2 | For g3 | For C1 | For C2 |
| Freq. | (CM) | (CM) | (CM) | (CM) | (CM) |
| 1 MHz | 0 | −0.456 | −0.456 | 0.466 | 0.466 |
| 20 MHz | 0 | −0.455 | −0.455 | 0.466 | 0.466 |
| 50 MHz | 0 | −0.455 | −0.455 | 0.466 | 0.466 |
| 80 MHz | 0 | −0.455 | −0.455 | 0.466 | 0.466 |
| 100 MHz | 0 | −0.455 | −0.455 | 0.466 | 0.466 |

TABLE 2-14
The sensitivity of 3 dB frequency for the voltage mode high-pass
biquad illustrated in FIG. 2.3.

| | Sensi. | | | | |
|---|---|---|---|---|---|
| | For g1 | For g2 | For g3 | For C1 | For C2 |
| Freq. | (VM) | (VM) | (VM) | (VM) | (VM) |
| 1 MHz | 0 | −0.456 | −0.456 | 0.466 | 0.466 |
| 20 MHz | 0 | −0.455 | −0.455 | 0.466 | 0.466 |
| 50 MHz | 0 | −0.455 | −0.455 | 0.466 | 0.466 |
| 80 MHz | 0 | −0.455 | −0.455 | 0.466 | 0.466 |
| 100 MHz | 0 | −0.455 | −0.455 | 0.466 | 0.466 |

Part V all-Pass Sensitivity and Tuning

The sensitivities of central frequency for the current mode (FIG. 2.7) and voltage mode (FIG. 2.3) all-pass biquads to each component are illustrated in Tables 2-15 (FIG. 2.32) and 2-16 (FIG. 2.33). They illustrate that the sensitivity is a non-linear function of frequency. There are several different kinds of variations, illustrated as below, of the sensitivities with respect to frequency. The sensitivities changed by the following sequence in absolute value with respect to frequency:

the small-medium-small sequence is for both the current-mode g1 and the voltage-mode C1;

the small-medium-large sequence is for both the voltage-mode g1 and the voltage-mode C2;

the medium-medium-large sequence is for both the current-mode g2 and the current-mode g3; and

the large-medium-large sequence is for the voltage-mode g2 and g3, and the current-mode C2;

the large-medium-small sequence is for the current-mode C1;

in which the small means the absolute value near zero, the medium means the absolute value near 0.5, and the large means the absolute value near unity. We may conclude that the sensitivities of the current-mode to the transconductances, g1, g2, and g3, are smaller in absolute value than those of the voltage-mode to these transconductances, respectively, but vice versa to the capacitances, C1, and C2.

TABLE 2-15
The sensitivity of central frequency for the current mode all-pass
biquad illustrated in FIG. 2.7.

| | Sensi. | | | | |
|---|---|---|---|---|---|
| | For g1 | For g2 | For g3 | For C1 | For C2 |
| Freq. | (CM) | (CM) | (CM) | (CM) | (CM) |
| 1 MHz | 0 | −0.445 | −0.445 | 0.951 | 0.951 |
| 50 MHz | 0 | −0.465 | −0.465 | 0.466 | 0.466 |
| 100 MHz | 0 | −0.455 | −0.455 | 0.466 | 0.466 |
| 200 MHz | 0.470 | −0.455 | −0.455 | 0.468 | 0.467 |
| 300 MHz | 0.492 | −0.456 | −0.452 | 0.478 | 0.471 |
| 400 MHz | 0.231 | −0.474 | −0.563 | −0.060 | 0.148 |
| 500 MHz | 0.293 | −0.548 | −0.548 | 0.186 | 0.471 |
| 600 MHz | 0.454 | −0.434 | −0.423 | 0.522 | 0.791 |
| 700 MHz | 0.005 | −0.897 | −1.338 | −0.002 | 0.942 |

TABLE 2-16
The sensitivity of central frequency for the voltage mode all-pass
biquad illustrated in FIG. 2.3.

| | Sensi. | | | | |
|---|---|---|---|---|---|
| | For g1 | For g2 | For g3 | For C1 | For C2 |
| Freq. | (VM) | (VM) | (VM) | (VM) | (VM) |
| 1 MHz | 0 | −0.890 | −0.890 | 0 | 0 |
| 50 MHz | 0 | −0.455 | −0.455 | 0.465 | o.465 |
| 100 MHz | 0 | −0.455 | −0.455 | 0.466 | 0.466 |
| 200 MHz | 0 | −0.455 | −0.455 | 0.468 | 0.467 |
| 300 MHz | 0.496 | −0.457 | −0.455 | 0.481 | 0.476 |
| 400 MHz | 0.258 | −0.599 | −0.465 | 0.366 | 0.357 |
| 500 MHz | 0.097 | −0.414 | −0.456 | 0.156 | 0.309 |
| 600 MHz | −0.021 | −0.504 | −0.585 | 0.165 | 0.418 |
| 700 MHz | −0.911 | −1.344 | −1.340 | −0.014 | 0.948 |

Using the tendency of the above sensitivity result, the output response with large error may be tuned to be the one with very small error after using the adjustment of component values. For example, the current-mode (resp. voltage-mode) all-pass output response with a theoretical central frequency at 500 MHz has been improved from 361.4 MHz with −27.7% error to 499.3 MHz with only −0.14% error (resp. from 346.7 MHz with −30.7% error to 499.3 MHz with only −0.14% error), from 53o˜−76o to 179o˜−179o (resp. from 62o˜−52o to 179o˜−179o), in central frequency and the phase range, respectively, illustrated in FIG. 2.34 (resp. FIG. 2.35), when the tuned component values become g1=276.1 μS, g2=30.6 μS, g3=52.8 μS, and C1=C2=0.0001 pF (resp. g1=345.1 μS, g2=121.2 μS, g3=45.5 μS, and C1=C2=0.0001 pF).

5 Responses of OTA-Parasitic C Biquads

The above Section illustrates that the low-pass, high-pass, band-pass, and all-pass (except the band-reject) biquads can be operated precisely after tunings using very small capacitances. Thus, it is considered in this Section to completely get rid of the grounded capacitor, which can absorb the shunt nodal parasitic capacitance, in the circuit (note that the two given capacitors are grounded). It means that the OTA-C filters will be transferred to the much more condensed OTA-only or OTA-parasitic C filters. The feasibility (please see below) of the voltage-mode and current-mode low-pass biquads (please see below) without using two grounded capacitors proves that the two parasitic capacitances at the two internal nodes can completely replace the two given grounded capacitors, and the conclusion is that the parasitic capacitance, unlike the traditional concept which is just the residue making the output error, can be considered as a real capacitor used in analog circuit design. Note that the above conclusion is based upon the following four backgrounds:

1. Each internal node in the circuit is connected by a grounded capacitor which can completely absorb the parasitic capacitance at that node;

2. No other capacitors except the grounded capacitors illustrated in (i) are used in the design;

3. Only the minimum number, which is in consistence with the order of the transfer function, of nodes is used in the design; and 4. Only the minimum number of active and passive components is used in the design for minimizing the whole parasitic effect.

Part I: OTA-Parasitic C Low-Pass Response

As these two grounded capacitors are taken out from the above two current and voltage mode biquads, FIGS. 2.36 and 2.37 illustrate the current-mode and voltage-mode OTA-only or OTA-parasitic C low-pass responses with 3 dB frequencies at 694.65 MHz and 844.12 MHz and peak values, 1.022 and 1.018, with the component values, g1=24.11 μS, g2=199.67 μS, g3=87.75 μS, and g1=17.58 μS, g2=125.58 μS, g3=99.94 μS, respectively. The two parasitic capacitances can be figured out with the values, 0.00565 pF and 0.16289 pF, and 0.00338 pF and 0.13218 pF, for the current-mode and voltage-mode biquads, respectively.

Part II: OTA-Only or Ota-Parasitic C High-Pass Response

When taking the two grounded capacitors out from the current-mode biquad illustrated in FIG. 2.7, the virtual line in FIG. 2.38 illustrates a very good high-pass simulation result with the 3 dB frequency at 689.5 MHz and the peak value, 1.11, having the changed component values: g1=217.35 μS, g2=163.30 μS, g3=79.12 μS. The parasitic capacitances used as two given capacitors are calculated having the values, Cp1=0.01234 pF, and Cp2=0.05577 pF. Note that the voltage-mode high-pass one cannot be transferred to an OTA-only high-pass biquad since the high-pass input signal is straight connected by a floating capacitor.

Part III: OTA-Only or OTA-Parasitic C Band-Pass Response

If the given capacitances illustrated in FIG. 2.7 (resp. FIG. 2.3) are decreased from 0.083 pF, through 0.050 pF, 0.033 pF, 0.017 pF, to null pF (namely, no capacitors), the band-pass output signal maintains with the central frequency at 602.56 MHz (resp. 616.60 MHz) and the peak value, only 0.378 (resp. 0.341), illustrated in the virtual-line (resp. real-line) curve of FIG. 2.39 (resp. FIG. 2.40), having the transconductances, g1=170.81 μS, g2=159.09 μS, and g3=74.45 μS (resp. g1=194.39 μS, g2=342.10 μS, and g3=43.44 μS). After the proper tunings of the three transconductances to the values, g1=309.70 μS, g2=158.95 μS, and g3=85.53 μS (resp. g1=437.34 μS, g2=314.25 μS, and g3=94.40 μS), the output signal is improved to be with the central frequency at 676.08 MHz (resp. 851.14 MHz) and the peak value 1.014 (resp. 1.005) illustrated in the real line curve of FIG. 2.39 (resp. FIG. 2.40).

The parasitic capacitances are calculated having the values 0.0739 pF and 0.0102 pF for the current-mode OTA-only or OTA-parasitic band-pass biquad and 0.0822 pF and 0.0126 pF for the corresponding voltage-mode one.

Part IV: OTA-Only or OTA-Parasitic C all-Pass Response

The current-mode one can be transferred to an OTA-only or OTA-parasitic C all-pass biquad. (Note that the voltage-mode one cannot be transferred to an OTA-only all-pass biquad since the high-pass input signal is straight connected by a floating capacitor.) When the two grounded capacitors are taken out from the biquad with the component values, g1=177.7 μS, g2=g3=125.7 μS (theoretical central frequency at 750 MHz), the simulated phase-frequency response is illustrated in the real-line curve of FIG. 2.41 with a central frequency at 929.74 MHz and a phase range from −32.48o to 3.36o. After the tunings of the three transconductances to the values, g1=194.90 μS, g2=36.84 μS, and g3=37.80 μS, the phase difference range has been enlarged to the acceptable range from −179.83o to 178.68o with the central frequency at 319.9 MHz, illustrated in the virtual-line curve of FIG. 2.41. The parasitic capacitances used as two given capacitors are calculated having the values, Cp1=0.54938 pF, and Cp2=0.00063 pF.

3. Analytical Synthesis of Voltage-Mode Odd-Nth-Order Ota And Equal-C Elliptic Filter Structure

Given the following voltage-mode odd-nth-order elliptic transfer function

$$\frac{{V}_{out}}{{V}_{in}} = \frac{{b}_{n - 1} {s}^{n - 1} + {b}_{n - 3} {s}^{n - 3} + … + {b}_{2} {s}^{2} + {a}_{0}}{\begin{matrix}{s}^{n} + {a}_{n - 1} {s}^{n - 1} + {a}_{n - 2} {s}^{n - 2} + \\ {a}_{n - 3} {s}^{n - 3} + … + {a}_{2} {s}^{2} + {a}_{1} s + {a}_{0}\end{matrix}} \qquad ( 3.1 )$$

where n is an odd integer, cross product (3.1),

Vₒᵤₜ(sⁿ+aₙ₋₁sⁿ⁻¹+aₙ₋₂sⁿ⁻²+ . . . +a₂s²+a₁s+a₀)=Vᵢₙ(bₙ₋₁s^{N-1}+bₙ₋₁sⁿ⁻¹+ . . . +b₂s²+a₀) (3.2)

divide it by sn−1,

$${V}_{out} [ ( s + {a}_{n - 1} ) + \frac{{a}_{n - 2}}{s} + \frac{{a}_{n - 3}}{{s}^{2}} + … + \frac{{a}_{2}}{{s}^{n - 3}} + \frac{{a}_{1}}{{s}^{n - 2}} + \frac{{a}_{0}}{{s}^{n - 1}} ] = {V}_{in} ( {b}_{n - 1} + \frac{{b}_{n - 3}}{{s}^{2}} + … + \frac{{b}_{2}}{{s}^{n - 3}} + \frac{{a}_{0}}{{s}^{n - 1}} ) \qquad ( 3.3 )$$

Re-arrange (3.3) as below.

$${V}_{out} ( s + {a}_{n - 1} ) = {V}_{in} {b}_{n - 1} - {V}_{out} \frac{{a}_{n - 2}}{s} - {V}_{out} \frac{{a}_{n - 3}}{{s}^{2}} + {V}_{in} \frac{{b}_{n - 3}}{{s}^{2}} - … - {V}_{out} \frac{{a}_{2}}{{s}^{n - 3}} + {V}_{in} \frac{{b}_{2}}{{s}^{n - 3}} - {V}_{out} \frac{{a}_{1}}{{s}^{n - 2}} - {V}_{out} \frac{{a}_{0}}{{s}^{n - 1}} + {V}_{in} \frac{{a}_{0}}{{s}^{n - 1}} \qquad ( 3.4 )$$

It is the proper combination illustrated below for the last five terms of the above equation.

$$- {V}_{out} \frac{{a}_{2}}{{s}^{n - 3}} + {V}_{in} \frac{{b}_{2}}{{s}^{n - 3}} - {V}_{out} \frac{{a}_{1}}{{s}^{n - 2}} - {V}_{out} \frac{{a}_{0}}{{s}^{n - 1}} + {V}_{in} \frac{{a}_{0}}{{s}^{n - 1}} = {V}_{in} \frac{{b}_{2}}{{s}^{n - 3}} + \frac{{a}_{2}}{{s}^{n - 3}} ( - {V}_{out} + \frac{\frac{{a}_{1}}{{a}_{2}}}{s} ( - {V}_{out} + \frac{\frac{{a}_{0}}{{a}_{1}}}{s} ( {V}_{in} - {V}_{out} ) ) ) \qquad ( 3.5 )$$

Another combination is illustrated below for the first five terms of (3.4) including the left one term of the equality notation.

$${V}_{out} = \frac{{b}_{n - 1}}{( s + {a}_{n - 1} )} ( {V}_{in} + \frac{\frac{{a}_{n - 2}}{{b}_{n - 1}}}{s} ( \begin{matrix}{V}_{out} - \frac{\frac{{a}_{n - 3}}{{a}_{n - 2}}}{s} {V}_{out} + \\ - \frac{\frac{{b}_{n - 3}}{{a}_{n - 2}}}{s} {V}_{in}\end{matrix} ) ) \qquad ( 3.6 )$$

Hence, Eq. (3.4) can be appropriately combined as follows.

$${V}_{out} = \frac{{b}_{n - 1}}{( s + {a}_{n - 1} )} \cdot \\ [ \begin{matrix}{V}_{in} + \\ \frac{( \frac{{a}_{n - 2}}{{b}_{n - 1}} )}{s} ( \begin{matrix}- {V}_{out} + \frac{( \frac{{b}_{n - 3}}{{a}_{n - 2}} )}{s} {V}_{in} + \\ \frac{( \frac{{a}_{n - 3}}{{a}_{n - 2}} )}{s} ( \begin{matrix}- {V}_{out} + \\ \frac{( \frac{{a}_{n - 4}}{{a}_{n - 3}} )}{s} ( \begin{matrix}- {V}_{out} + … + \\ \frac{( \frac{{a}_{3}}{{a}_{4}} )}{s} ( \begin{matrix}- {V}_{out} + \frac{( \frac{{b}_{2}}{{b}_{3}} )}{s} {V}_{in} \\ \frac{( \frac{{a}_{2}}{{a}_{3}} )}{s} ( \begin{matrix}- {V}_{out} + \\ \frac{( \frac{{a}_{1}}{{a}_{2}} )}{s} ( \begin{matrix}- {V}_{out} + \\ \frac{( \frac{{a}_{0}}{{a}_{1}} ( {V}_{in} - {V}_{out} ) )}{s}\end{matrix} )\end{matrix} )\end{matrix} )\end{matrix} )\end{matrix} )\end{matrix} )\end{matrix} ] \qquad ( 3.7 )$$

Therefore, based upon Eq. (3.7), the following n simple and feasible first-order equations may be obtained.

V₁=[(a₀/a₁)/s](Vᵢₙ−Vₒᵤₜ) (3.8-1)

V₂=[(a₁/a₂)/s](−Vₒᵤₜ+V₁) (3.8-2)

V₃=(1/s)[(b₂/a₃)Vᵢₙ+(a₂/a₃)(−Vₒᵤₜ+V₂)] (3.8-3)

V₄=[(a₃/a₄)/s](−Vₒᵤₜ+V₃) (3.8-4)

. . .

Vₙ₋₃=[(aₙ₋₃/aₙ₋₃)/s](−Vₒᵤₜ+Vₙ₋₄) (3.8-n-3)

Vₙ₋₂=(1/s)[(bₙ₋₃/aₙ₋₂)Vᵢₙ+(aₙ₋₃/aₙ₋₂)(−Vₒᵤₜ+Vₙ₋₃)] (3.8-n-2)

−Vₙ₋₁=[(aₙ₋₂/aₙ₋₁)/s](−Vₒᵤₜ+Vₙ₋₂) (3.8-n-1)

Vₒᵤₜ(s+aₙ₋₁)=bₙ₋₁(Vᵢₙ−Vₙ₋₁) (3.8-n)

There are three different kinds of equations illustrated in Eq. (3.8-1) to (3.8-n). The three typical cases are illustrated, for example, in Eq. (3.8-1), (3.8-n-2), and (3.8-n), respectively, FIG. 3.1 to 3.3 are the realized sub-circuitries of the above three typical cases, respectively.

The combination of the n sub-circuitries realized from Eq. (3.8-1) to (3.8-n) assembles the architecture of the voltage-mode odd-nth-order OTA-C elliptic filter with the minimum number of active and passive components which is illustrated in FIG. 3.4.

Note that the filter structure illustrated in FIG. 3.4 uses all grounded capacitors and equal capacitance, the latter of which eliminates the difficulty to fabricate different capacitances precisely in integrated circuits.

To illustrate the synthesis method, consider the structure generation of a third-order elliptic filter. The synthesis method uses Eqs. (3.8-1), (3.8-n-1), and (3.8-n). Based on these equations, when n=3, the following three equations may be obtained:

V₁=[(a₀/a₁)/s](Vᵢₙ−Vₒᵤₜ),

−V₂=[(a₁/a₂)/s](−Vₒᵤₜ+V₁),

Vₒᵤₜ(s+a₂)=b₂(Vᵢₙ−V₂),

Implementing the above equations using differential-input OTAs and grounded capacitors, the third-order OTA-C elliptic filter is illustrated in FIG. 3.5 with the following transfer function.

$$\frac{{I}_{out}}{{I}_{in}} = \frac{{b}_{2} {s}^{2} + {a}_{0}}{{s}^{3} + {a}_{2} {s}^{2} + {a}_{1} s + {a}_{0}} \qquad ( 3.9 )$$

Please note that the above third-order elliptic filter presented in FIG. 3.5 employs the minimum active and passive components. It can be explained as follows. The general third-order elliptic filter has the general transfer function.

$$\frac{{I}_{out}}{{I}_{in}} = \frac{{b}_{2} {s}^{2} + {b}_{0}}{{a}_{3} {s}^{3} + {a}_{2} {s}^{2} + {a}_{1} s + {a}_{0}} \qquad ( 3.10 )$$

The different coefficients in Eq. (3.10) can be reduced by one if we multiply a factor (a0/b0) to the numerator, then Eq. (3.10) becomes

$$\begin{matrix}\frac{{I}_{out} ( \frac{{a}_{0}}{{b}_{0}} )}{{I}_{in}} = \frac{{I}_{out}^{′}}{{I}_{in}} \\ = \frac{{b}_{2} ( \frac{{a}_{0}}{{b}_{0}} ) {s}^{2} + {a}_{0}}{{a}_{3} {s}^{3} + {a}_{2} {s}^{2} + {a}_{1} s + {a}_{0}} \\ = \frac{{b}_{2}^{′} {s}^{2} + {a}_{0}}{{a}_{3} {s}^{3} + {a}_{2} {s}^{2} + {a}_{1} s + {a}_{0}}\end{matrix} \qquad ( 3.11 )$$

The simplest component choice is (i) using three capacitances, C1, C2, and C3, to construct a3, (ii) using two out of the three capacitances in (i) and one transconductance g1 to construct a2, (iii) using one of the three capacitances in (i) and two transconductances, g1 and g2, to construct a1, (iv) using three transconductances, g1, g2, and g3, to construct a0, and (v) using two of the three capacitances and one different transconductance g4 to construct b2. Therefore, four OTAs and three capacitors are the minimum components necessary for realizing such a third-order elliptic filter. This merit can be deduced to the nth-order filter structure illustrated in FIG. 3.4 using the same approach.

In FIG. 3.5, if we replace the three unity capacitances from the left to the right sides with C3, C2, and C1, and the four transconductances from the left to the right sides with g4, g3, g2, and g1, respectively, the transfer function of FIG. 3.5 is

$$\begin{matrix}H ( s ) = \frac{{I}_{out}}{{I}_{in}} \\ = \frac{{s}^{2} {C}_{2} {C}_{3} {g}_{2} + {g}_{2} {g}_{3} {g}_{4}}{{s}^{3} {C}_{1} {C}_{2} {C}_{3} + {s}^{2} {C}_{2} {C}_{3} {g}_{1} + {sC}_{3} {g}_{2} {g}_{3} + {g}_{2} {g}_{3} {g}_{4}} \\ ≡ \frac{{b}_{2} {s}^{2} + {a}_{0}}{{a}_{3} {s}^{3} + {a}_{2} {s}^{2} + {a}_{1} s + {a}_{0}}\end{matrix} \qquad ( 3.12 )$$

Then

$${S}_{{C}_{3}}^{H} = ( \frac{{b}_{2} {s}^{2}}{{b}_{2} {s}^{2} + {a}_{0}} ) - ( \frac{{a}_{3} {s}^{3} + {a}_{2} {s}^{2} + {a}_{1} s}{{a}_{3} {s}^{3} + {a}_{2} {s}^{2} + {a}_{1} s + {a}_{0}} ) \\ {S}_{{C}_{2}}^{H} = ( \frac{{b}_{2} {s}^{2}}{{b}_{2} {s}^{2} + {a}_{0}} ) - ( \frac{{a}_{3} {s}^{3} + {a}_{2} {s}^{2}}{{a}_{3} {s}^{3} + {a}_{2} {s}^{2} + {a}_{1} s + {a}_{0}} ) \\ {S}_{{C}_{1}}^{H} = - ( \frac{{a}_{3} {s}^{3}}{{a}_{3} {s}^{3} + {a}_{2} {s}^{2} + {a}_{1} s + {a}_{0}} ) , \\ {S}_{{g}_{1}}^{H} = - ( \frac{{a}_{2} {s}^{2}}{{a}_{3} {s}^{3} + {a}_{2} {s}^{2} + {a}_{1} s + {a}_{0}} ) \\ {S}_{{g}_{2}}^{H} = 1 - ( \frac{{a}_{1} s + {a}_{0}}{{a}_{3} {s}^{3} + {a}_{2} {s}^{2} + {a}_{1} s + {a}_{0}} ) \\ {S}_{{g}_{3}}^{H} = ( \frac{{a}_{0}}{{b}_{2} {s}^{2} + {a}_{0}} ) - ( \frac{{a}_{1} s + {a}_{0}}{{a}_{3} {s}^{3} + {a}_{2} {s}^{2} + {a}_{1} s + {a}_{0}} ) \\ {S}_{{g}_{4}}^{H} = ( \frac{{a}_{0}}{{b}_{2} {s}^{2} + {a}_{0}} ) - ( \frac{{a}_{0}}{{a}_{3} {s}^{3} + {a}_{2} {s}^{2} + {a}_{1} s + {a}_{0}} ) \qquad ( 3.13 )$$

The standard sensitivity analysis above gives the fractional change in the complex magnitude of the transfer function normalized by the fractional change in the component value. Although the transfer function response includes the variations of all the elliptic filtering parameters such as fp, the largest frequency in the pass-band, fs, the smallest frequency in the stop-band, A1, the lowest ripple magnitude in the pass-band, and A2, the highest ripple magnitude in the stop-band, since these elliptic filtering parameters cannot be easily found from formulas derived from the transfer function, the sensitivity analysis of these parameters to each component value cannot be done in a simple manner. However, it is interesting to look at how the parameters affect the elliptic filter transfer function shape when the transition band from fp to fs, A1, and A2 change with the various components. This is presented as follows by considering the sensitivity-frequency responses of fp, fs, A1, and A2 to the various components, C1, C2, C3, g1, g2, g3, and g4.

To validate the theoretical predictions, 0.35 μm process H-spice simulations are now used. We use the CMOS implementation of a transconductor reported in [17], with ±1.65 V supply voltages and W/L=5μ/1μ and 10μ/1μ for NMOS and PMOS transistors, respectively. The component values for the third-order one are given by C1=24 pF, C2=8 pF (for the center capacitor in FIG. 3.5), C3=24 pF, and g1=128.07 μS (Ib=22.36 μA), g2=53.09 μS (Ib=5.97 μA), g3=163.43 μS (Ib=35.91 μA), g4=78.75 μS (Ib=10.28 μA), realizing Eq. (3.10) with a3=1, a2=0.84929, a1=1.14586, a0=0.59870, and b2=0.35225. The simulated amplitude-frequency response with the nominal fp=1.0271 MHz (error 2.71%), fs=1.2032 MHz (error 0.265%), A1=0.862 (error 1.45%), and A2=0.129197 (error 1.32%) when compared to the theoretical 1.00 MHz, 1.20 MHz, 0.85, and 0.127519, respectively, is illustrated in FIG. 3.6. We also notice that the power consumption, due to the very small biasing current necessary, is very low, only 491.40 μW for the above simulation. Moreover, the sensitivity-frequency responses of the parameters fp, fs, A1, and A2 to the transconductances, g1, g2, g3, and g4, are illustrated in FIG. 3.7 to 3.10, respectively. Table I illustrates the simulation values of the sensitivity-frequency responses of fp, fs, A1, and A2 to the transconductances, g1, g2, g3, and g4. In summary, if the sensitivity of A2 to g2 is not very important, all of the other individual sensitivities to the transconductance have their absolute values smaller than unity.

TABLE 3-I
Sensitivities of. fp, fs, A1, and A2

| | Freq. | | | |
|---|---|---|---|---|
| Sensi. | 100 kHz | 500 kHz | 1000 kHz | 5000 kHz |
| fp to g1 | −0.612218 | −0.551254 | −0.499815 | −0.358443 |
| fp to g2 | 0.277322 | 0.345281 | 0.352324 | 0.404641 |
| fp to g3 | 0.550573 | 0.556385 | 0.551737 | 0.501154 |
| fp to g4 | 0.647393 | 0.574064 | 0.506040 | 0.313935 |
| fs to g1 | −0.069676 | −0.063916 | −0.069026 | −0.112805 |
| fs to g2 | 0.074236 | 0.077879 | 0.095683 | 0.221280 |
| fs to g3 | 0.516764 | 0.519283 | 0.516079 | 0.511203 |
| fs to g4 | 0.479210 | 0.464543 | 0.469284 | 0.335666 |
| A1 to g1 | 0.292573 | 0.291218 | 0.303065733 | 0.280531 |
| A1 to g2 | −0.653770 | −0.636021 | −0.61278026 | −0.491012 |
| A1 to g3 | −0.361658 | −0.357535 | −0.344544 | −0.278024 |
| A1 to g4 | 0.654234 | 0.628852 | 0.597343 | 0.543130 |
| A2 to g1 | −0.242466 | −0.240018 | −0.243257 | −0.228167 |
| A2 to g2 | 1.411354 | 1.412306 | 1.415671 | 1.218123 |
| A2 to g3 | −0.386425 | −0.384586 | −0.389139 | −0.431107 |
| A2 to g4 | −0.708275 | −0.717002 | −0.723160 | −0.857422 |

4. Analytical Synthesis Methods for Current-Mode Odd-Nth-Order OTA-C Elliptic High-Pass Filter Structures

Given the current-mode odd-nth-order elliptic low-pass filter transfer function

$$\frac{{I}_{out}}{{I}_{in}} = \frac{{b}_{n - 1} {s}^{n - 1} + {b}_{n - 3} {s}^{n - 3} + … + {b}_{4} {s}^{4} + {b}_{2} {s}^{2} + {a}_{0}}{{a}_{n} {s}^{n} + {a}_{n - 1} {s}^{n - 1} + {a}_{n - 2} {s}^{n - 2} + … + {a}_{2} {s}^{2} + {a}_{1} s + {a}_{0}} \qquad ( 4.1 )$$

where n is an odd integer, as the s in (4.1) are replaced by the 1/s, the resulting transfer function will have a form different from (4.1), illustrated in (4.2) called the current-mode odd-nth-order elliptic high-pass filter transfer function, and may synthesize an elliptic high-pass filtering function. Therefore, for elliptic high-pass filters, the designers will have two distinct choices, i.e., (i) the current-mode even-nth-order elliptic high-pass filter structure with the minimum number of components, and (ii) the current-mode odd-nth-order elliptic high-pass filter structure which will be realized using the following analytical synthesis methods with the minimum number of components as well.

$$\frac{{I}_{out}}{{I}_{in}} = \frac{{a}_{0} {s}^{n} + {b}_{2} {s}^{n - 2} + {b}_{4} {s}^{n - 4} + … + {b}_{n - 3} {s}^{3} + {b}_{n - 1} s}{{a}_{0} {s}^{n} + {a}_{1} {s}^{n - 1} + {a}_{2} {s}^{n - 2} + … + {a}_{n - 2} {s}^{2} + {a}_{n - 1} s + {a}_{n}} \qquad ( 4.2 )$$

which can be re-written using a series of different coefficients as

$$\frac{{I}_{out}}{{I}_{in}} = \frac{{a}_{n} {s}^{n} + {b}_{n - 2}^{′} {s}^{n - 2} + {b}_{n - 4}^{′} {s}^{n - 4} + … + {b}_{3}^{′} {s}^{3} + {b}_{1}^{′} s}{{a}_{n} {s}^{n} + {a}_{n - 1} {s}^{n - 1} + {a}_{n - 2} {s}^{n - 2} + … + {a}_{2} {s}^{2} + {a}_{1} s + {a}_{0}} \qquad ( 4.3 )$$

Since

$$\begin{matrix}\frac{{I}_{out}}{{I}_{in}} = 1 - \frac{{a}_{n - 1} {s}^{n - 1} + {b}_{n - 2} {s}^{n - 2} + {a}_{n - 3} {s}^{n - 3} + … + {a}_{2} s + {b}_{1} s + {a}_{0}}{{a}_{n} {s}^{n} + {a}_{n - 1} {s}^{n - 1} + {a}_{n - 2} {s}^{n - 2} + … + {a}_{2} {s}^{2} + {a}_{1} s + {a}_{0}} \\ = \frac{{a}_{n} {s}^{n} + {b}_{n - 2}^{′} {s}^{n - 2} + {b}_{n - 4}^{′} {s}^{n - 4} + … + {b}_{3}^{′} {s}^{3} + {b}_{1}^{′} s}{{a}_{n} {s}^{n} + {a}_{n - 1} {s}^{n - 1} + {a}_{n - 2} {s}^{n - 2} + … + {a}_{2} {s}^{2} + {a}_{1} s + {a}_{0}}\end{matrix} \qquad ( 4.4 )$$

we can realize

$$\begin{matrix}{I}_{out}^{*} = \frac{\begin{matrix}{a}_{n - 1} {s}^{n - 1} + {b}_{n - 2} {s}^{n - 2} + \\ {a}_{n - 3} {s}^{n - 3} + … + {a}_{2} s + {b}_{1} s + {a}_{0}\end{matrix}}{{a}_{n} {s}^{n} + {a}_{n - 1} {s}^{n - 1} + {a}_{n - 2} {s}^{n - 2} + … + {a}_{2} {s}^{2} + {a}_{1} s + {a}_{0}} {I}_{in} & ( 4.5 ) \\ then {I}_{out} = {I}_{in} + ( - {I}_{out}^{*} ) & ( 4.6 )\end{matrix}$$

(4.5) can be decomposed into n parts as

$$\begin{matrix}{I}_{out}^{*} = \frac{{a}_{n - 1} {s}^{n - 1} + {b}_{n - 2} {s}^{n - 2} + {a}_{n - 3} {s}^{n - 3} + … + {a}_{2} s + {b}_{1} s + {a}_{0}}{{a}_{n} {s}^{n} + {a}_{n - 1} {s}^{n - 1} + {a}_{n - 2} {s}^{n - 2} + … + {a}_{2} {s}^{2} + {a}_{1} {s}^{2} + {a}_{1} s + {a}_{0}} {I}_{in} \\ = \frac{{a}_{n - 1} {s}^{n - 1}}{Δ} {I}_{in} + \frac{{b}_{n - 2} {s}^{n - 2}}{Δ} {I}_{in} + … + \frac{{a}_{2} {s}^{2}}{Δ} {I}_{in} + \frac{{b}_{1} s}{Δ} {I}_{in} + \frac{{a}_{0}}{Δ} {I}_{in} \\ = {I}_{out ( n - 1 )} + {I}_{out ( n - 2 )} + … + {I}_{out ( 2 )} + {I}_{out ( 1 )} + {I}_{out ( 0 )}\end{matrix} \qquad ( 4.7 )$$

where

$$\begin{matrix}{I}_{out ( 0 )} = \frac{{a}_{0} {I}_{i n}}{Δ} & ( 4.8 a ) \\ {I}_{out ( i )} = \frac{{b}_{i} {I}_{in} {s}^{i}}{Δ} \\ for i = 1 , 3 , 5 , … , n - 2 ; & ( 4.8 b ) \\ {I}_{out ( i )} = \frac{{a}_{i} {I}_{in} {s}^{i}}{Δ} \\ for i = 2 , 4 , 6 , … , n - 1 ; \\ and Δ = {a}_{n} {s}^{n} + {a}_{n - 1} {s}^{n - 1} + {a}_{n - 2} {s}^{n - 2} + … + {a}_{1} s + {a}_{0} . & ( 4.8 c )\end{matrix}$$

From Eq. (4.8a) to (4.8c), following equations may be obtained.

$$\begin{matrix}{I}_{out ( 0 )} = \frac{{a}_{0}}{Δ} {I}_{in} & ( 4.8 \text{-} 0 ) \\ {I}_{out ( 1 )} = \frac{{b}_{1} s}{Δ} {I}_{in} & ( 4.8 \text{-} 1 ) \\ {I}_{out ( 2 )} = \frac{{a}_{2} {s}^{2}}{Δ} {I}_{in} & ( 4.8 \text{-} 2 ) \\ {I}_{out ( 3 )} = \frac{{b}_{3} {s}^{3}}{Δ} {I}_{in} \\ … & ( 4.8 \text{-} 3 ) \\ {I}_{out ( n - 3 )} = \frac{{a}_{n - 3} {s}^{n - 3}}{Δ} {I}_{in} & ( 4.8 \text{-} n \text{-} 3 ) \\ {I}_{out ( n - 2 )} = \frac{{b}_{n - 2} {s}^{n - 2}}{Δ} {I}_{in} & ( 4.8 \text{-} n \text{-} 2 ) \\ {I}_{out ( n - 1 )} = \frac{{a}_{n - 1} {s}^{n - 1}}{Δ} {I}_{in} & ( 4.8 \text{-} n \text{-} 1 )\end{matrix}$$

Cross multiplying Eq. (4.8-n-1), and re-arranging, we obtain

$${I}_{out ( n - 1 )} {a}_{n} s = ( {I}_{in} - {I}_{out ( n - 1 )} - {I}_{out ( n - 1 )} {\sum }_{i = 0}^{n - 2} \frac{{a}_{i} {s}^{i}}{{a}_{n - 1} {s}^{n - 1}} ) {a}_{n - 1} \qquad ( 4.9 )$$

Dividing Eq. (4.8-0) by Eq. (4.8-n-1) provides

$${I}_{out ( 0 )} = {I}_{out ( n - 1 )} \frac{{a}_{0}}{{a}_{n - 1} {s}^{n - 1}}$$

Similarly, dividing Eq. (4.8-1) by Eq. (4.8-n-1) provides

$${I}_{out ( 1 )} = {I}_{out ( n - 1 )} \frac{{b}_{1} s}{{a}_{n - 1} {s}^{n - 1}} , or in general \\ {I}_{out ( i )} = {I}_{out ( n - 1 )} \frac{{a}_{i} {s}^{i}}{{a}_{n - 1} {s}^{n - 1}} for i = 0 , 2 , 4 , … , n \text{-} 3 ; \\ {I}_{out ( i )} = {I}_{out ( n - 1 )} \frac{{b}_{i} {s}^{i}}{{a}_{n - 1} {s}^{n - 1}} for i = 1 , 3 , 5 , … , n - 2. \qquad ( 4.10 )$$

Substituting Eq. (4.10) into Eq. (4.9) provides

$${I}_{out ( n - 1 )} {a}_{n} s = ( \begin{matrix}{I}_{in} - {I}_{out ( n - 1 )} - {I}_{out ( n - 2 )} ( \frac{{a}_{n - 2}}{{b}_{n - 2}} ) - \\ {I}_{out ( n - 3 )} - … - {I}_{out ( 2 )} - \\ {I}_{out ( 1 )} ( \frac{{a}_{1}}{{b}_{1}} ) - {I}_{out ( 0 )}\end{matrix} ) {a}_{n - 1} \qquad ( 4.11 )$$

Re-arranging Eq. (4.11) provides

$${I}_{in} = {I}_{out ( 0 )} + {I}_{out ( 1 )} ( \frac{{a}_{1}}{{b}_{1}} ) + {I}_{out ( 2 )} + … + {I}_{out ( n - 3 )} + {I}_{out ( n - 2 )} ( \frac{{a}_{n - 2}}{{b}_{n - 2}} ) + {I}_{out ( n - 1 )} + {I}_{out ( n - 1 )} ( \frac{{a}_{n} s}{{a}_{n - 1}} ) \qquad ( 4.12 )$$

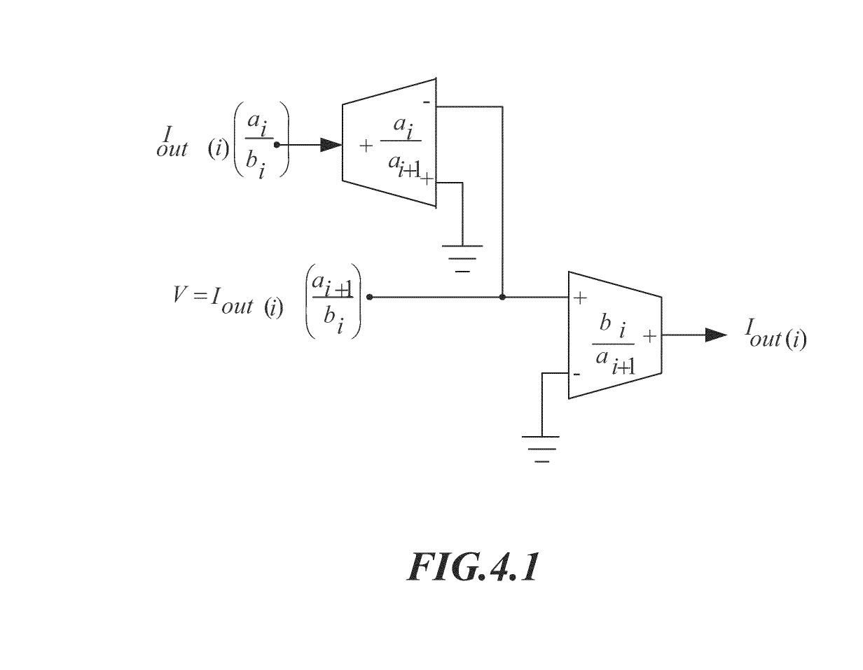

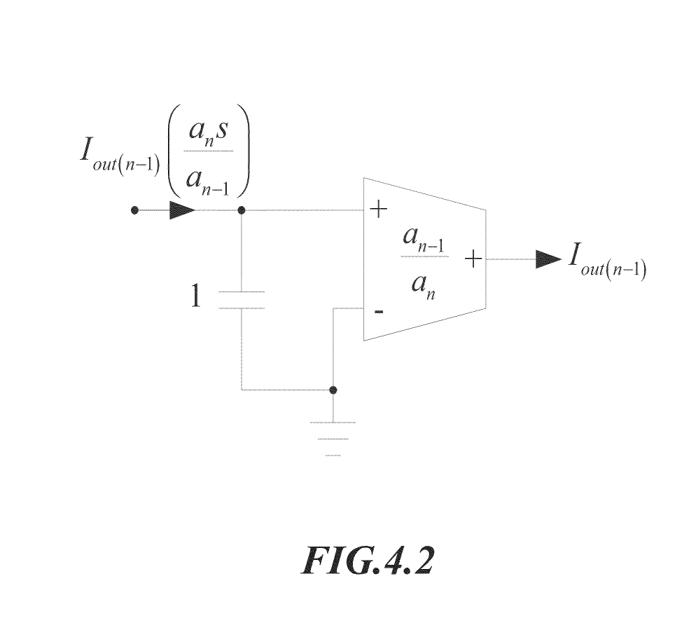

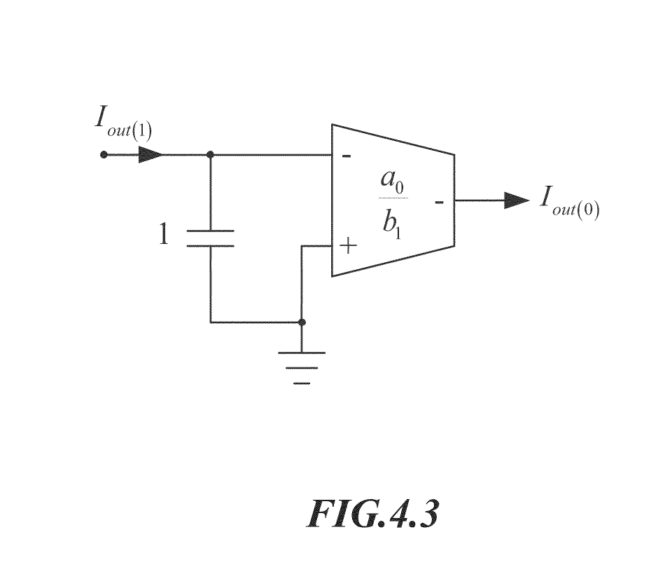

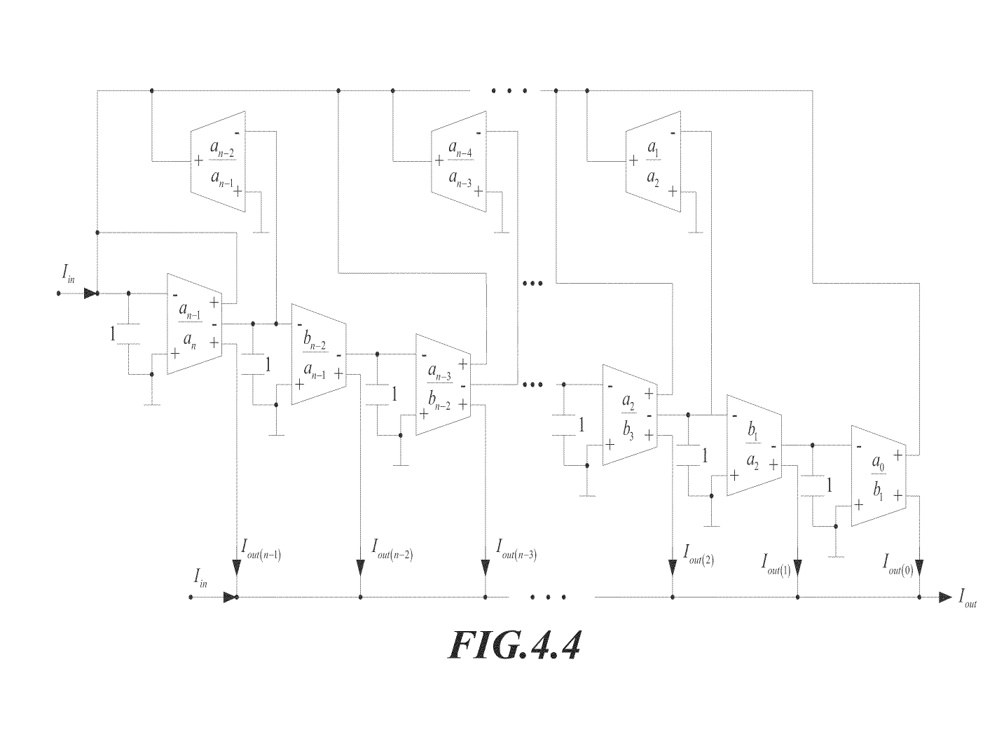

From Eq. (4.12), it can be seen that the input current, Iin, is the summation of the n+1 output currents, Iout(0), Iout(1)(a1/b1), Iout(2), Iout(3)(a3/b3), Iout(4), . . . , Iout(n−2)(an−2/bn−2), Iout(n−1), and Iout(n−1)(ans/an−1), in which the current Iout(i)(ai/bi) is realized by two OTAs, the individual transconductances of which are ai/ai+1 and bi/ai+1, as illustrated in FIG. 4.1, and the current Iout(n−1)(ans/bn−1) is realized by an OTA with a transconductance bn−1/an and a grounded capacitor with unit capacitance, as illustrated in FIG. 4.2.

Now it is needed to obtain the relations between the n output currents. Dividing Eq. (4.8-0) by Eq. (4.8-1) provides

$${I}_{out ( 0 )} = {I}_{out ( 1 )} \frac{{a}_{0}}{{b}_{1} s} = {I}_{out ( 1 )} \frac{{a}_{0} / {b}_{1}}{s} \qquad ( 4.13 a )$$

Eq. (4.13a) is realized by the integrator using an OTA with a transconductance a0/b1 and a grounded unit capacitor as illustrated in FIG. 4.3.

Similarly, dividing Eq. (4.8-1) by Eq. (4.8-2); and Eq. (4.8-2) by Eq. (4.8-3) provides

$$\begin{matrix}{I}_{out ( 1 )} = {I}_{out ( 2 )} \frac{{b}_{1} / {a}_{2}}{s} & ( 4.13 b ) \\ {I}_{out ( 2 )} = {I}_{out ( 3 )} \frac{{a}_{2} / {b}_{3}}{s} & ( 4.13 c ) \\ or , in general \\ {I}_{out ( i )} = {I}_{out ( i + 1 )} \frac{{b}_{i} / {a}_{i + 1}}{s} for i = 1 , 3 , 5 , … , n - 2 ; \\ {I}_{out ( i )} = {I}_{out ( i + 1 )} \frac{{a}_{i} / {b}_{i + 1}}{s} for i = 0 , 2 , 4 , … , n - 3. & ( 4.14 )\end{matrix}$$

Eq. (4.14) is realized successively by n−1 integrators from the lower right in FIG. 4.4.

On the other hand, Eq. (4.12) is realized by the other OTAs with transconductances a1/a2, a3/a4, a5/a6 . . . , an−4/an−3, an−2/an−1, and an−1/an, and a grounded capacitor with unit capacitance, as illustrated in FIG. 4. The output Iout is the summation of one input current signal Iin and the n output currents: −Iout(0), −Iout(1), . . . , −Iout(n−2), and −Iout(n−1).

To illustrate the synthesis method, consider the structure generation of a third-order elliptic high-pass filter. The synthesis method uses (4.13a), (4.13b) and (4.12). Based on these equations, when n=3, we have the following 3 equations:

$${I}_{out ( 0 )} = {I}_{out ( 1 )} \frac{{a}_{0}}{{b}_{1} s} = {I}_{out ( 1 )} \frac{{a}_{0} / {b}_{1}}{s} , \\ {I}_{out ( 1 )} = {I}_{out ( 2 )} \frac{{b}_{1} / {a}_{2}}{s}$$

$${I}_{in} = {I}_{out ( 0 )} + {I}_{out ( 1 )} ( \frac{{a}_{1}}{{b}_{1}} ) + {I}_{out ( 2 )} + {I}_{out ( 2 )} ( \frac{{a}_{3} s}{{a}_{2}} )$$

The implementation of the above equations for a third-order OTA-C elliptic high-pass filter using only single-ended-input OTAs and grounded capacitors is illustrated in FIG. 4.5, wherein the following transfer function is realized.

$$\frac{{a}_{2} {s}^{2} + {b}_{1} s + {a}_{0}}{{a}_{3} {s}^{3} + {a}_{2} {s}^{2} + {a}_{1} s + {a}_{0}} \qquad ( 4.15 )$$

Note that the above third-order elliptic high-pass filter presented in FIG. 4.5 employs the minimum number of active and passive components, four single-ended-input OTAs and three grounded capacitors. The third-order elliptic high-pass filter illustrated in FIG. 4.5 has the following transfer function

$$\frac{{a}_{3} {s}^{3} + ( {a}_{1} - {b}_{1} ) s}{{a}_{3} {s}^{3} + {a}_{2} {s}^{2} + {a}_{1} s + {a}_{0}} \qquad ( 4.16 )$$

which is obtained using the reduction from unity by the transfer function illustrated in (4.15).

5. Analytical Synthesis Methods for Voltage-Mode Odd-Nth-Order OTA-C Elliptic High-Pass Filter Structure

Given the voltage-mode odd-nth-order elliptic low-pass filter transfer function

$$\frac{{V}_{out}}{{V}_{in}} = \frac{{b}_{n - 1} {s}^{n - 1} + {b}_{n - 3} {s}^{n - 3} + … + {b}_{4} {s}^{4} + {b}_{2} {s}^{2} + {a}_{0}}{{a}_{n} {s}^{n} + {a}_{n - 1} {s}^{n - 1} + {a}_{n - 2} {s}^{n - 2} + … + {a}_{2} {s}^{2} + {a}_{1} s + {a}_{0}} \qquad ( 5.1 )$$

where n is an odd integer, as the s in Eq. (5.1) are replaced by the 1/s, the resulting transfer function will have a form different from Eq. (5.1), illustrated in Eq. (5.2) called the voltage-mode odd-nth-order elliptic high-pass filter transfer function, and may synthesize an elliptic high-pass filtering function. Therefore, for elliptic high-pass filters, the designers will have two distinct choices, i.e., (i) the voltage-mode even-nth-order elliptic high-pass filter structure with the minimum number of components, and (ii) the voltage-mode odd-nth-order elliptic high-pass filter structure which will be realized using the following analytical synthesis methods with the minimum number of components as well.

$$\frac{{V}_{out}}{{V}_{in}} = \frac{{a}_{0} {s}^{n} + {b}_{2} {s}^{n - 2} + {b}_{4} {s}^{n - 4} + … + {b}_{n - 3} {s}^{3} + {b}_{n - 1} s}{{a}_{0} {s}^{n} + {a}_{1} {s}^{n - 1} + {a}_{2} {s}^{n - 2} + … + {a}_{n - 2} {s}^{2} + {a}_{n - 1} s + {a}_{n}} \qquad ( 5.2 )$$

which can be re-written using a series of different coefficients as

$$\frac{{V}_{out}}{{V}_{in}} = \frac{{a}_{n} {s}^{n} + {b}_{n - 2} {s}^{n - 2} + {b}_{n - 4} {s}^{n - 4} + … + {b}_{3} {s}^{3} + {b}_{1} s}{{a}_{n} {s}^{n} + {a}_{n - 1} {s}^{n - 1} + {a}_{n - 2} {s}^{n - 2} + … + {a}_{2} {s}^{2} + {a}_{1} s + {a}_{0}} \qquad ( 5.3 )$$

Cross multiplying (5.3), dividing it by sn−1, and appropriately doing the combination yield

$${V}_{out} [ \begin{matrix}( {a}_{n} s + {a}_{n - 1} ) + \frac{{a}_{n - 2}}{s} + \frac{{a}_{n - 3}}{{s}^{2}} + \frac{{a}_{n - 4}}{{s}^{3}} + \\ \frac{{a}_{n - 5}}{{s}^{4}} + … + \frac{{a}_{3}}{{s}^{n - 4}} + \frac{{a}_{2}}{{s}^{n - 3}} + ( \frac{{a}_{1}}{{s}^{n - 2}} + \frac{{a}_{0}}{{s}^{n - 1}} )\end{matrix} ] = {V}_{in} [ \begin{matrix}( {a}_{n} s ) + ( \frac{{b}_{n - 2}}{s} ) + ( \frac{{b}_{n - 4}}{{s}^{3}} ) + … + \\ ( \frac{{b}_{3}}{{s}^{n - 4}} ) + ( \frac{{b}_{1}}{{s}^{n - 2}} )\end{matrix} ] \qquad ( 5.4 )$$

in which

$$\begin{matrix}( i ) {V}_{in} ( \frac{{b}_{1}}{{s}^{n - 2}} ) - {V}_{out} ( \frac{{a}_{1}}{{s}^{n - 2}} + \frac{{a}_{0}}{{s}^{n - 1}} ) = ( \frac{1}{{s}^{n - 2}} ) [ {V}_{in} ( {b}_{1} ) - {V}_{out} ( {a}_{1} + \frac{{a}_{0}}{s} ) ] & ( 5.5 ) \\ ( ii ) {V}_{in} ( \frac{{b}_{1}}{{s}^{n - 2}} ) - {V}_{out} ( \frac{{a}_{1}}{{s}^{n - 2}} + \frac{{a}_{0}}{{s}^{n - 1}} ) - {V}_{out} ( \frac{{a}_{2}}{{s}^{n - 3}} ) = ( \frac{1}{{s}^{n - 3}} ) [ ( \frac{1}{s} ) [ {V}_{in} ( {b}_{1} ) - {V}_{out} ( {a}_{1} + \frac{{a}_{0}}{s} ) ] - {V}_{out} ( {a}_{2} ) ] & ( 5.6 ) \\ ( iii ) [ {V}_{in} ( \frac{{b}_{1}}{{s}^{n - 2}} ) - {V}_{out} ( \frac{{a}_{1}}{{s}^{n - 2}} + \frac{{a}_{0}}{{a}_{n} {s}^{n - 1}} ) - {V}_{out} ( \frac{{a}_{2}}{{s}^{n - 3}} ) ] + {V}_{in} ( \frac{{b}_{3}}{{s}^{n - 4}} ) - {V}_{out} ( \frac{{a}_{3}}{{s}^{n - 4}} ) = ( \frac{1}{{s}^{n - 4}} ) [ \begin{matrix}( \frac{1}{s} ) [ ( \frac{1}{s} ) [ {V}_{in} ( {b}_{1} ) - {V}_{out} ( {a}_{1} + \frac{{a}_{0}}{s} ) ] - {V}_{out} ( {a}_{2} ) ] + \\ {V}_{in} ( {b}_{3} ) - {V}_{out} ( {a}_{3} )\end{matrix} ] & ( 5.7 )\end{matrix}$$

Therefore, Eq. (5.4) can be decomposed as

$${V}_{out} ( {a}_{n} s + {a}_{n - 1} ) = {V}_{in} {a}_{n} s + \frac{1}{s} [ \begin{matrix}{V}_{in} ( {b}_{n - 2} ) - {V}_{out} ( {a}_{n - 2} ) + \\ \frac{1}{s} [ \begin{matrix}- {V}_{out} ( {a}_{n - 3} ) + \\ \frac{1}{s} [ \begin{matrix}{V}_{in} ( {b}_{n - 4} ) - {V}_{out} ( {a}_{n - 4} ) + \\ \frac{1}{s} [ \begin{matrix}… + \\ \frac{1}{s} [ \begin{matrix}{V}_{in} ( {b}_{3} ) - {V}_{out} ( {a}_{3} ) + \\ \frac{1}{s} [ \begin{matrix}- {V}_{out} ( {a}_{2} ) + \\ \frac{1}{s} [ {V}_{in} ( {b}_{1} ) - {V}_{out} ( {a}_{1} + \frac{{a}_{0}}{s} ) ]\end{matrix} ]\end{matrix} ]\end{matrix} ]\end{matrix} ]\end{matrix} ]\end{matrix} ] \qquad ( 5.8 )$$

Then, the following equations are obtained.

$$\begin{matrix}{V}_{1} ≡ - ( \frac{{a}_{0}}{s} ) {V}_{out} , \\ i . e . , \\ {V}_{1} ( \frac{s}{{a}_{0}} ) + {V}_{out} ( 1 ) = 0 & ( 5.9 \text{-} 1 ) \\ {V}_{2} ( \frac{s}{{a}_{1}} ) = {V}_{in} ( \frac{{b}_{1}}{{a}_{1}} ) - {V}_{out} ( 1 ) + {V}_{1} ( \frac{1}{{a}_{1}} ) & ( 5.9 \text{-} 2 ) \\ {V}_{3} ( \frac{s}{{a}_{2}} ) = - {V}_{out} ( 1 ) + {V}_{2} ( \frac{1}{{a}_{2}} ) & ( 5.9 \text{-} 3 ) \\ {V}_{4} ( \frac{s}{{a}_{3}} ) = {V}_{in} ( \frac{{b}_{3}}{{a}_{3}} ) - {V}_{out} ( 1 ) + {V}_{3} ( \frac{1}{{a}_{3}} ) \\ … & ( 5.9 \text{-} 4 ) \\ {V}_{n - 3} ( \frac{s}{{a}_{n - 4}} ) = {V}_{in} ( \frac{{b}_{n - 4}}{{a}_{n - 4}} ) - {V}_{out} ( 1 ) + {V}_{n - 4} ( \frac{1}{{a}_{n - 4}} ) & ( 5.9 \text{-} n \text{-} 3 ) \\ {V}_{n - 2} ( \frac{s}{{a}_{n - 3}} ) = - {V}_{out} ( 1 ) + {V}_{n - 3} ( \frac{1}{{a}_{n - 3}} ) \\ {V}_{n - 1} ( \frac{s}{{a}_{n - 2}} ) = {V}_{i n} ( \frac{{b}_{n - 2}}{{a}_{n - 2}} ) - {V}_{out} ( 1 ) + {V}_{n - 2} ( \frac{1}{{a}_{n - 2}} ) \\ And & \begin{matrix}\begin{matrix}( 5.9 \text{-} n \text{-} 2 ) \\ \end{matrix} \\ ( 5.9 \text{-} n \text{-} 1 )\end{matrix} \\ {V}_{out} ( {a}_{n} s + {a}_{n - 1} ) = {V}_{in} ( {a}_{n} s ) + {V}_{n - 1} , \\ i . e . , & \begin{matrix}( 5.9 \text{-} n ) \\ \end{matrix} \\ {V}_{out} ( \frac{{sa}_{n}}{{a}_{n - 1}} + 1 ) = {V}_{in} ( \frac{{sa}_{n}}{{a}_{n - 1}} ) + {V}_{n - 1} ( \frac{1}{{a}_{n - 1}} ) & \end{matrix}$$

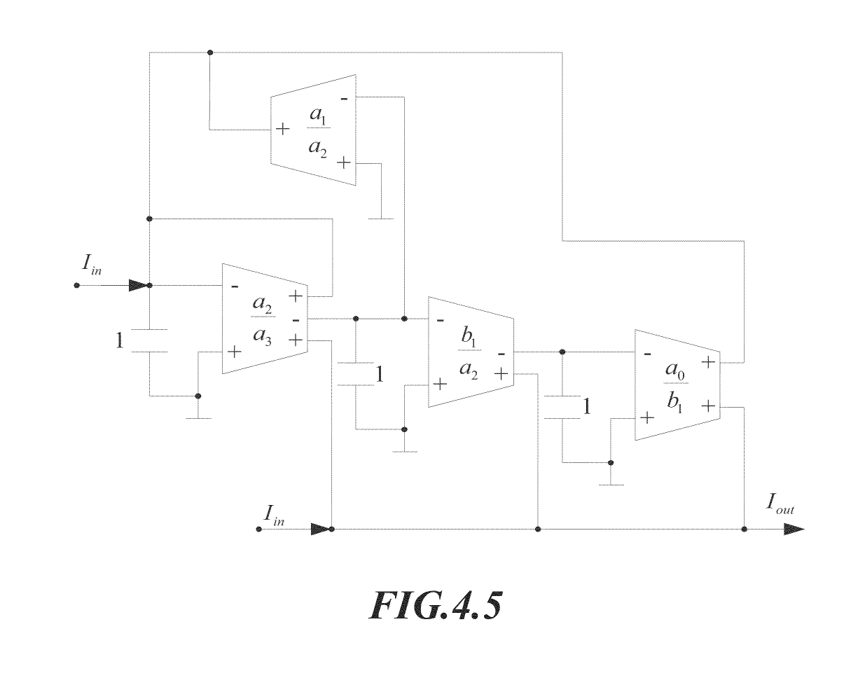

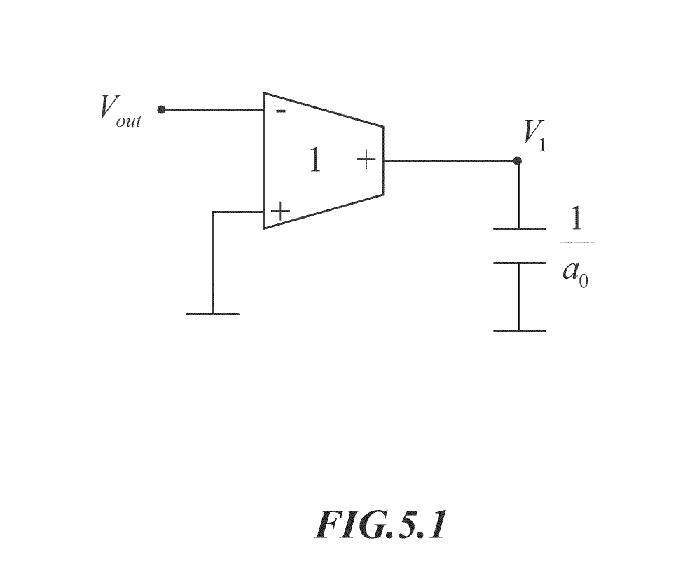

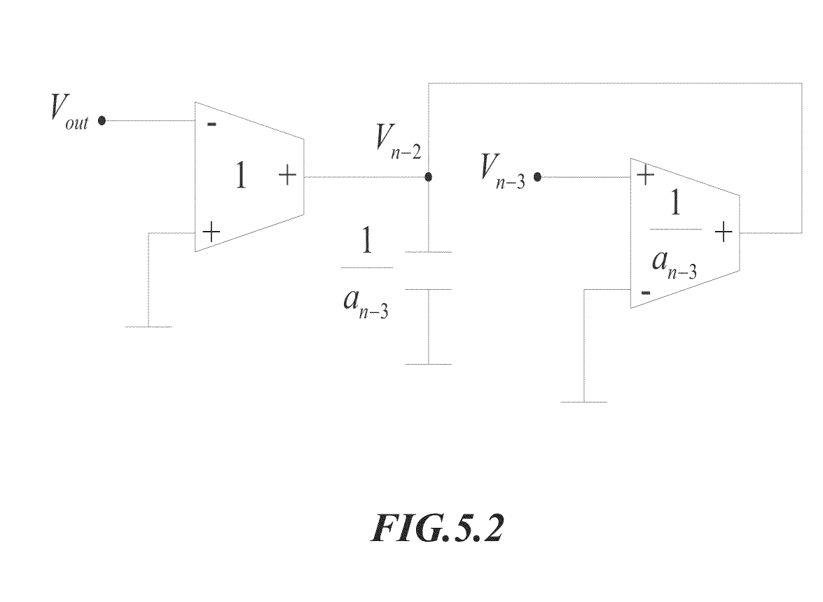

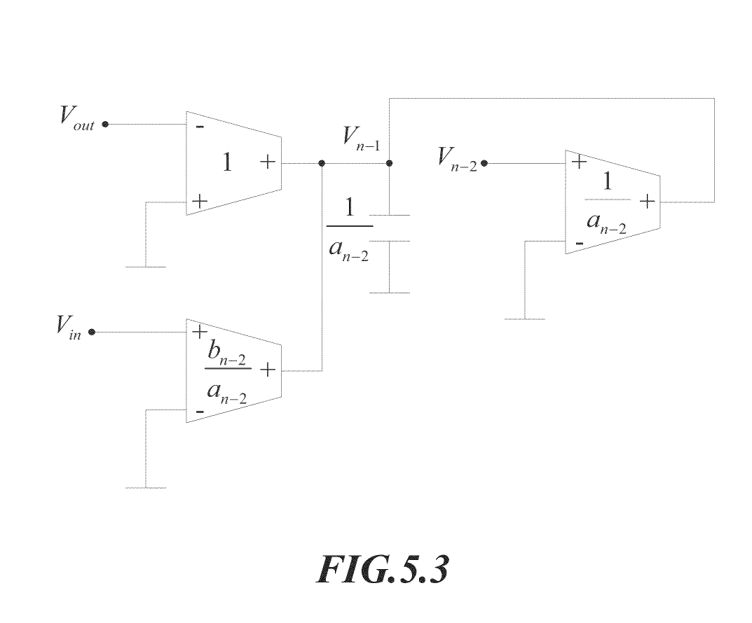

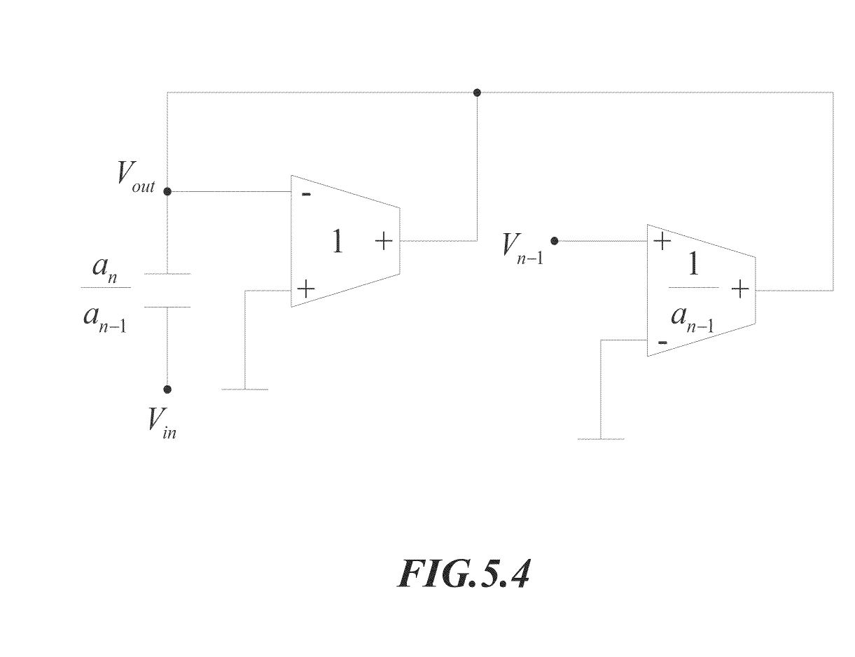

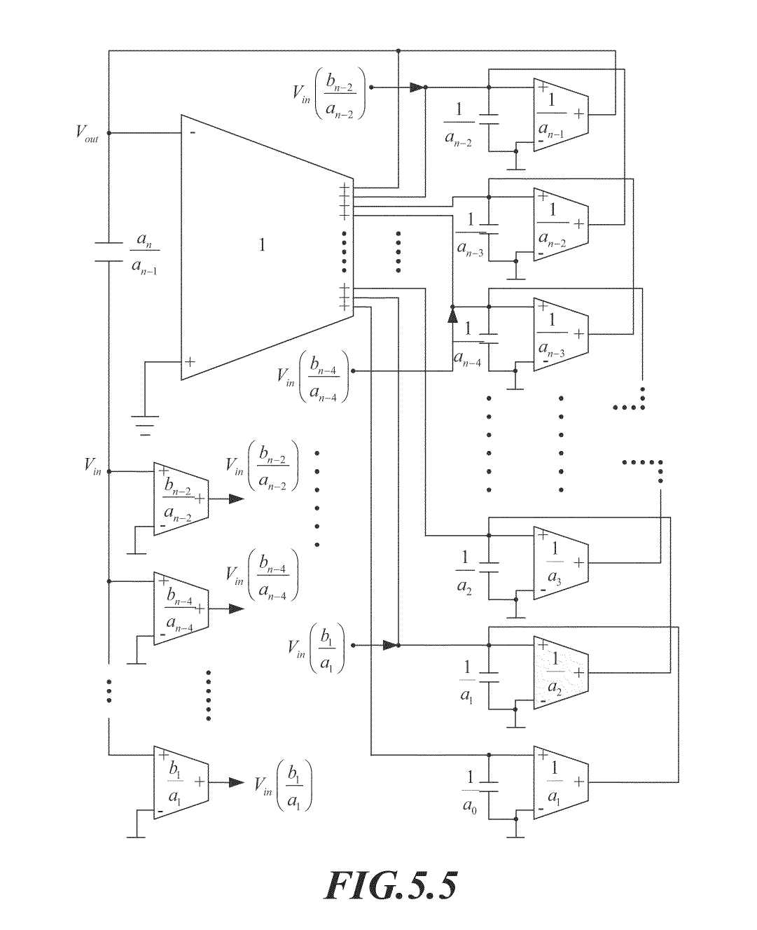

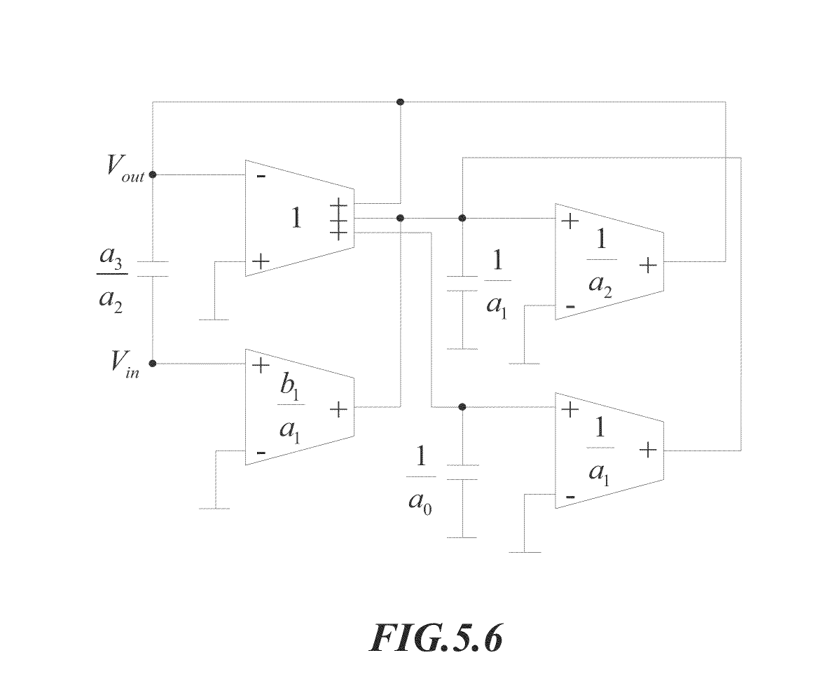

Equations (5.9-1), (5.9-n-2), (5.9-n-1), and (5.9-n) can be easily realized using the single-ended-input OTA and one grounded capacitor and illustrated in FIG. 5.1, 5.2, 5.3, and 5.4, respectively. Then, the whole voltage-mode odd-nth-order OTA-C elliptic filter structure is constructed by the combination of all the sub-circuitries realized from Eq. (5.9-1) to (5.9-n) and illustrated in FIG. 5.5.

To illustrate the synthesis method, consider the structure generation of a third-order elliptic high-pass filter. The synthesis method uses Eq. (5.9-1), (5.9-n-1) and (5.9-n). Based on these equations, when n=3, we have the following 3 equations:

$${V}_{1} ( \frac{s}{{a}_{0}} ) + {V}_{out} ( 1 ) = 0 , \\ {V}_{2} ( \frac{s}{{a}_{1}} ) = {V}_{in} ( \frac{{b}_{1}}{{a}_{1}} ) - {V}_{out} ( 1 ) + {V}_{1} ( \frac{1}{{a}_{1}} )$$

$${V}_{out} ( \frac{{sa}_{3}}{{a}_{2}} + 1 ) = {V}_{in} ( \frac{{sa}_{3}}{{a}_{2}} ) + {V}_{2} ( \frac{1}{{a}_{2}} )$$

The implementation of the above equations for a third-order OTA-C elliptic high-pass filter using only single-ended-input OTAs and grounded capacitors is illustrated in FIG. 5.6 and has the following transfer equation

$$\frac{{a}_{3} {s}^{3} + {b}_{1} s}{{a}_{3} {s}^{3} + {a}_{2} {s}^{2} + {a}_{1} s + {a}_{0}} \qquad ( 5.10 )$$

6. Analytical Synthesis of Voltage-Mode Even-Nth-Order OTA-C Elliptic Filter Structure with the Minimum Number of Components

The analytical synthesis methods1-5, using a succession of innovative algebra manipulation operations to decompose a single complicated nth-order filter transfer function into a set of simple and feasible equations, have been demonstrated to be very effective for simultaneously achieving the three important criteria for the design of OTA-C filters. If we do the comparison between the recently reported current-mode and voltage-mode OTA-C filter structures using analytical synthesis methods1-5, the active component number of the voltage mode3-5 is at least two more than that of the current mode2. None of the previously reported voltage-mode even-nth-order OTA-C elliptic filter structures uses the minimum components. In the following presents a new kind of analytical synthesis method, different from the recently presented ones1-5 using all single-ended-input OTAs and all grounded capacitors, which will produce a voltage-mode even-nth-order elliptic filter structure with the minimum number of components using all single-ended-input OTAs and nearly all grounded capacitors but one floating capacitor. The voltage-mode even-nth-order elliptic filter transfer function is given as below.

$$\frac{{V}_{out}}{{V}_{in}} = \frac{{a}_{n} {s}^{n} + {b}_{n - 2} {s}^{n - 2} + {b}_{n - 4} {s}^{n - 4} + … + {b}_{2} {s}^{2} + {b}_{0}}{\begin{matrix}{a}_{n} {s}^{n} + {a}_{n - 1} {s}^{n - 1} + {a}_{n - 2} {s}^{n - 2} + \\ {a}_{n - 3} {s}^{n - 3} + … + {a}_{2} {s}^{2} + {a}_{1} s + {a}_{0}\end{matrix}} \qquad ( 6.1 )$$

where n is an even integer. Cross multiplying (1), divide by ansn−1 and re-arrange the sequence of terms,

$$( {V}_{out} - {V}_{in} ) s + {V}_{out} ( \frac{{a}_{n - 1}}{{a}_{n}} ) = - {V}_{out} ( \frac{\frac{{a}_{n - 2}}{{a}_{n}}}{s} + \frac{\frac{{a}_{n - 3}}{{a}_{n}}}{{s}^{2}} + … + \frac{\frac{{a}_{2}}{{a}_{n}}}{{s}^{n - 3}} + \frac{\frac{{a}_{1}}{{a}_{n}}}{{s}^{n - 2}} + \frac{\frac{{a}_{0}}{{a}_{n}}}{{s}^{n - 1}} ) + {V}_{in} ( \frac{\frac{{b}_{n - 2}}{{a}_{n}}}{s} + \frac{\frac{{b}_{n - 4}}{{a}_{n}}}{{s}^{3}} + … + \frac{\frac{{b}_{2}}{{a}_{n}}}{{s}^{n - 3}} + \frac{\frac{{b}_{0}}{{a}_{n}}}{{s}^{n - 1}} ) \qquad ( 6.2 )$$

Since

$$\begin{matrix}( \frac{{a}_{j}}{{a}_{n}} ) = ( \frac{{a}_{n - 1}}{{a}_{n}} ) ( \frac{{a}_{n - 2}}{{a}_{n - 1}} ) ( \frac{{a}_{n - 3}}{{a}_{n - 2}} ) … ( \frac{{a}_{j + 2}}{{a}_{j + 3}} ) ( \frac{{a}_{j + 1}}{{a}_{j + 2}} ) ( \frac{{a}_{j}}{{a}_{j + 1}} ) \\ for j = 0 , 1 , 2 … , n - 3 , n - 2 ; \\ and & ( 6.3 ) \\ ( \frac{{b}_{j}}{{a}_{n}} ) = ( \frac{{a}_{n - 1}}{{a}_{n}} ) ( \frac{{a}_{n - 2}}{{a}_{n - 1}} ) ( \frac{{a}_{n - 3}}{{a}_{n - 2}} ) … ( \frac{{a}_{j + 1}}{{a}_{j + 2}} ) ( \frac{{a}_{j}}{{a}_{j + 1}} ) ( \frac{{b}_{j}}{{a}_{j}} ) \\ for j = 0 , 2 , 4 … , n - 4 , n - 2. & ( 6.4 )\end{matrix}$$

Observing Eq. (6.2) and using Eq. (6.3) and (6.4), consider and factorize the first two terms of the right side of Eq. (6.2) as

$$- {V}_{out} ( \frac{\frac{{a}_{n - 2}}{{a}_{n}}}{s} ) + {V}_{i n} ( \frac{\frac{{b}_{n - 2}}{{a}_{n}}}{s} ) = ( \frac{\frac{{a}_{n - 2}}{{a}_{n - 1}}}{s} ) [ \begin{matrix}{V}_{in} ( \frac{{a}_{n - 1}}{{a}_{n}} ) ( \frac{{b}_{n - 2}}{{a}_{n - 2}} ) - \\ {V}_{out} ( \frac{{a}_{n - 1}}{{a}_{n}} )\end{matrix} ] \qquad ( 6.5 )$$

the second three terms of the right side of Eq. (6.2) as

$$- {V}_{out} ( \frac{\frac{{a}_{n - 3}}{{a}_{n}}}{{s}^{2}} ) - {V}_{out} ( \frac{\frac{{a}_{n - 4}}{{a}_{n}}}{{s}^{3}} ) + {V}_{in} ( \frac{\frac{{b}_{n - 4}}{{a}_{n}}}{{s}^{3}} ) = - ( \frac{\frac{{a}_{n - 2}}{{a}_{n - 1}}}{s} ) ( \frac{\frac{{a}_{n - 3}}{{a}_{n - 2}}}{s} ) [ {V}_{out} ( \frac{{a}_{n - 1}}{{a}_{n}} ) - ( \frac{\frac{{a}_{n - 4}}{{a}_{n - 3}}}{s} ) [ \begin{matrix}{V}_{in} ( \frac{{a}_{n - 1}}{{a}_{n}} ) ( \frac{{b}_{n - 4}}{{a}_{n - 4}} ) - \\ {V}_{out} ( \frac{{a}_{n - 1}}{{a}_{n}} )\end{matrix} ] ] \qquad ( 6.6 )$$

So do the last three terms of the right side of Eq. (6.2) as

$$- {V}_{out} ( \frac{\frac{{a}_{1}}{{a}_{n}}}{{s}^{n - 2}} ) - {V}_{out} ( \frac{\frac{{a}_{0}}{{a}_{n}}}{{s}^{n - 1}} ) + {V}_{in} ( \frac{\frac{{b}_{0}}{{a}_{n}}}{{s}^{n - 1}} ) = - ( \frac{\frac{{a}_{1}}{{a}_{n - 1}}}{s} ) [ {V}_{out} ( \frac{{a}_{n - 1}}{{a}_{n}} ) - ( \frac{\frac{{a}_{0}}{{a}_{1}}}{s} ) [ \begin{matrix}{V}_{in} ( \frac{{a}_{n - 1}}{{a}_{n}} ) ( \frac{{b}_{0}}{{a}_{0}} ) - \\ {V}_{out} ( \frac{{a}_{n - 1}}{{a}_{n}} )\end{matrix} ] ] \qquad ( 6.7 )$$

Therefore, Eq. (6.2) can be manipulated as follows.

$$( {V}_{out} - {V}_{in} ) s + {V}_{out} ( \frac{{a}_{n - 1}}{{a}_{n}} ) = ( \frac{\frac{{a}_{n - 2}}{{a}_{n - 1}}}{s} ) [ \begin{matrix}{V}_{i n} ( \frac{{a}_{n - 1}}{{a}_{n}} ) ( \frac{{b}_{n - 2}}{{a}_{n - 2}} ) - {V}_{out} ( \frac{{a}_{n - 1}}{{a}_{n}} ) - \\ ( \frac{\frac{{a}_{n - 3}}{{a}_{n - 2}}}{s} ) [ \begin{matrix}{V}_{out} ( \frac{{a}_{n - 1}}{{a}_{n}} ) - \\ ( \frac{\frac{{a}_{n - 4}}{{a}_{n - 3}}}{s} ) [ \begin{matrix}{V}_{i n} ( \frac{{a}_{n - 1}}{{a}_{n}} ) ( \frac{{b}_{n - 4}}{{a}_{n - 4}} ) - {V}_{out} ( \frac{{a}_{n - 1}}{{a}_{n}} ) - … \\ … ( \frac{\frac{{a}_{1}}{{a}_{2}}}{s} ) [ \begin{matrix}{V}_{out} ( \frac{{a}_{n - 1}}{{a}_{n}} ) - \\ ( \frac{\frac{{a}_{0}}{{a}_{1}}}{s} ) [ \begin{matrix}{V}_{i n} ( \frac{{a}_{n - 1}}{{a}_{n}} ) ( \frac{{b}_{0}}{{a}_{0}} ) - \\ {V}_{out} ( \frac{{a}_{n - 1}}{{a}_{n}} )\end{matrix} ]\end{matrix} ]\end{matrix} ]\end{matrix} ]\end{matrix} ] \qquad ( 6.8 )$$

Based upon Eq. (6.8),

$$\begin{matrix}{V}_{1} = - \frac{1}{s} [ {V}_{in} ( \frac{{a}_{n - 1}}{{a}_{n}} ) ( \frac{{b}_{0}}{{a}_{0}} ) - {V}_{out} ( \frac{{a}_{n - 1}}{{a}_{n}} ) ] \\ {V}_{j} = - \frac{1}{s} [ {V}_{out} ( \frac{{a}_{n - 1}}{{a}_{n}} ) - {V}_{j - 1} ( \frac{{a}_{j - 2}}{{a}_{j - 2}} ) ] \\ for j = 2 , 4 … , n - 2 & ( 6.9 \text{-} 1 ) \\ {V}_{j} = - \frac{1}{s} [ {V}_{in} ( \frac{{a}_{n - 1}}{{a}_{n}} ) ( \frac{{b}_{j - 1}}{{a}_{j - 1}} ) - {V}_{out} ( \frac{{a}_{n - 1}}{{a}_{n}} ) - {V}_{j - 1} ( \frac{{a}_{j - 2}}{{a}_{j - 1}} ) ] \\ for j = 3 , 5 … , n - 1 & ( 6.9 \text{-} j ) \\ ( {V}_{out} - {V}_{in} ) s + {V}_{out} ( \frac{{a}_{n - 1}}{{a}_{n}} ) = - {V}_{n - 1} ( \frac{{a}_{n - 2}}{{a}_{n - 1}} ) & ( 6.9 \text{-} n )\end{matrix}$$

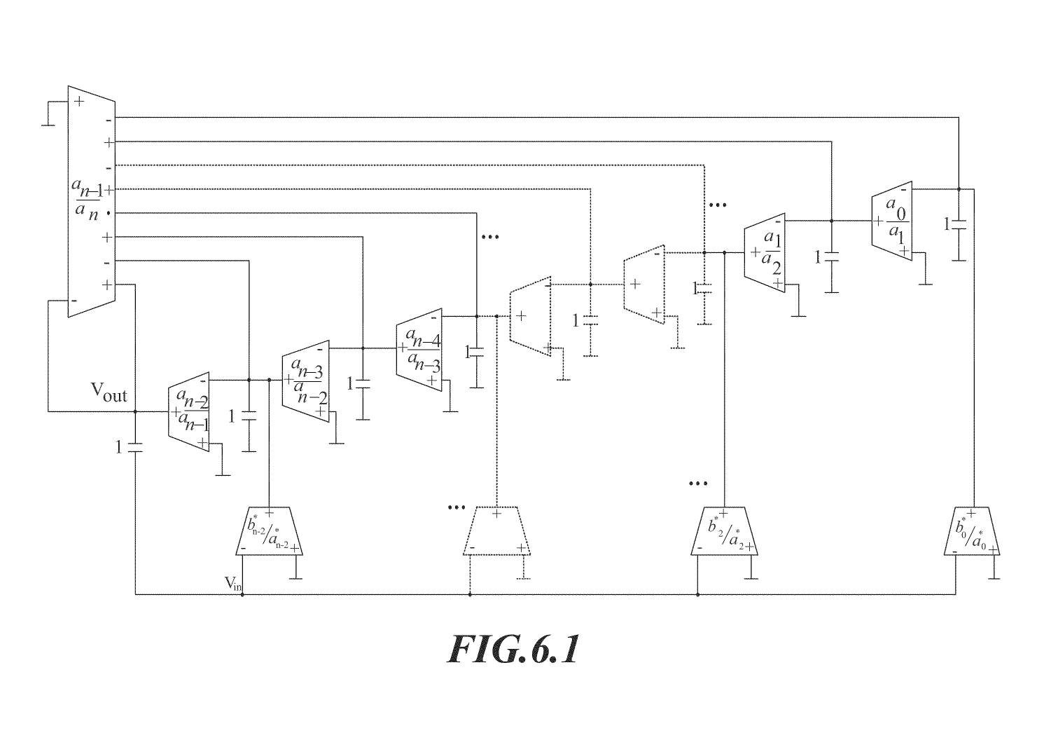

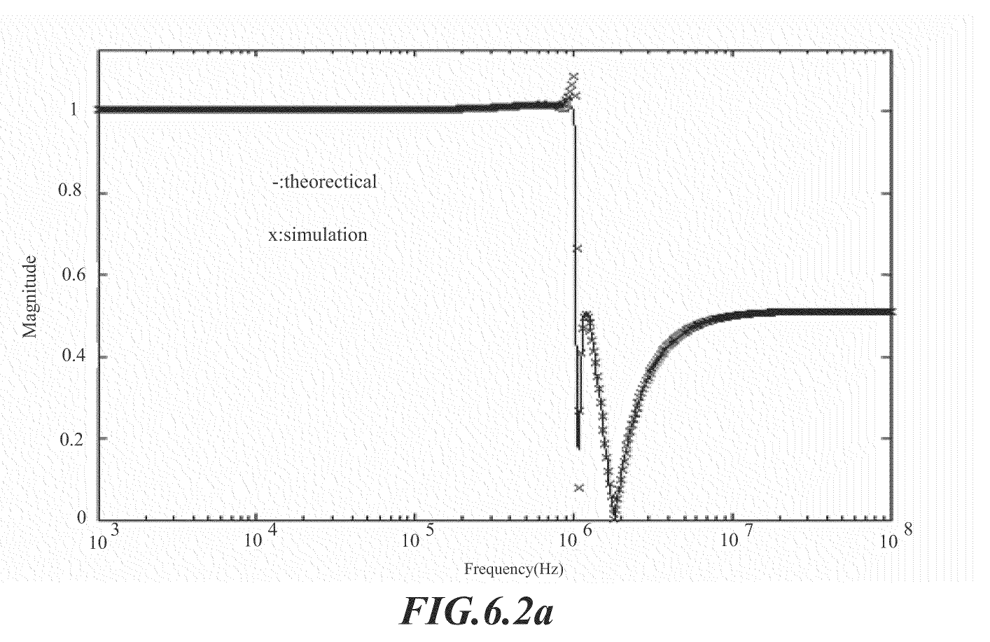

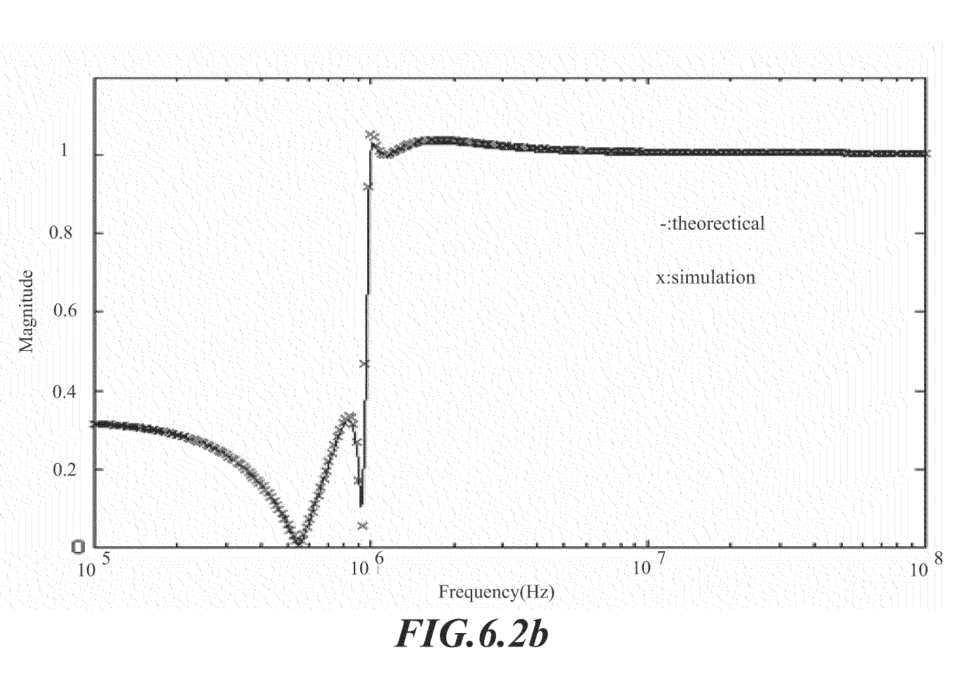

The above equations are simple and easy to be realized using single-ended-input OTAs and grounded/floating capacitors. After the combination of these simple circuitries, FIG. 6.1 illustrates the new voltage-mode even-nth-order OTA-C elliptic filter structure having equal capacitance type with the same minimum number of components as in 1. The 0.35 μm process H-spice simulation including the fourth-order elliptic low-pass and high-pass amplitude-frequency responses illustrated in FIG. 6.2(a) and 6.2(b), respectively, validates the theoretical predictions.

The above description is given by way of example, and not limitation. Given the above disclosure, one skilled in the art could devise variations that are within the scope and spirit of the invention disclosed herein, including configurations ways of the recessed portions and materials and/or designs of the attaching structures. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. An analytical synthesis method (ASM) for designing a high-order current/voltage-mode operational trans-conductance amplifier and capacitor (OTA-C) filter, comprising:
converting a decomposition of a complicated nth-order transferring a function into a set of equations corresponding to a set of sub-circuitries; and
constructing a circuit structure by combining said sub-circuitries.

2. The ASM for designing OTA-C filter as claimed in claim 1, wherein said OTA-C filter comprises n OTAs and n capacitors serves as a voltage-mode nth-order OTA-C universal filter.

3. The ASM for designing OTA-C filter as claimed in claim 2, wherein said voltage-mode nth-order OTA-C universal filter comprises active and passive components.

4. The ASM for designing OTA-C filter as claimed in claim 2, wherein said OTA-C filter comprises a voltage-mode nth-order OTA-only (OTA-parasitic C) low-pass filter without any capacitor.

5. The ASM for designing OTA-C filter as claimed in claim 1, further comprising a technique for improving a precision of output parameters comprising:
determining an increment or a decrement tendency of output parameters when an individual component varies;
obtaining relationships among said output parameters; and
determining a non-contradictive approach to improve precision of said output parameters.

6. The ASM for designing OTA-C filter as claimed in claim 1, wherein when said OTA-C filter comprises three OTAs and two capacitors and serves as a tunable voltage-mode second-order OTA-C universal filter.

7. The ASM for designing OTA-C filter as claimed in claim 6, wherein said tunable voltage-mode second-order OTA-C universal filter comprises active and passive components.

8. The ASM for designing OTA-C filter as claimed in claim 5, wherein said OTA-C filter comprises three OTAs and two capacitors and serves as a tunable current-mode second-order OTA-C universal filter.

9. The ASM for designing OTA-C filter as claimed in claim 6, wherein said tunable voltage-mode second-order OTA-only (or OTA-parasitic C) comprises a low-pass and band-pass filter without two capacitors.

10. The ASM for designing OTA-C filter as claimed in claim 1, wherein when said OTA-C filter comprises a voltage-mode odd-nth-order OTA-C elliptic filter.

11. The ASM for designing OTA-C filter as claimed in claim 10, wherein said voltage-mode odd-nth-order OTA-C elliptic filter comprises a voltage-mode third-order OTA-C elliptic filter.

12. The ASM of designing OTA-C filter as claimed in claim 1, wherein when said OTA-C filter comprises a current-mode odd-nth-order OTA-C elliptic high-pass filter.

13. The ASM for designing OTA-C filter as claimed in claim 12, wherein said current-mode odd-nth-order OTA-C elliptic high-pass filter comprises a current-mode 3rd-order OTA-C elliptic high-pass filter.

14. The ASM of designing OTA-C filter as claimed in claim 5, wherein when said OTA-C filter comprises a voltage-mode odd-nth-order OTA-C elliptic high-pass filter.

15. The ASM for designing OTA-C filter as claimed in claim 14, wherein said voltage-mode odd-nth-order OTA-C elliptic high-pass filter comprises a current-mode 3rd-order OTA-C elliptic high-pass filter.

16. The ASM for designing OTA-C filter as claimed in claim 1, wherein when said OTA-C filter comprises a voltage-mode even-nth-order OTA-C elliptic filter.

17. The ASM for designing OTA-C filter as claimed in claim 16, wherein said voltage-mode even-nth-order OTA-C elliptic filter comprises at least an oscillator.

18. The ASM for designing OTA-C filter as claimed in claim 17, wherein said oscillator comprises an OTA-C quadrature oscillator I.

19. The ASM for designing OTA-C oscillator as claimed in claim 17, wherein said oscillator comprises an OTA-C quadrature oscillator II.

20. The ASM for designing OTA-C filter as claimed in claim 20, wherein said OTA-C quadrature oscillator II comprises at least one component.

21. The ASM for designing OTA-C oscillator as claimed in claim 17, wherein said oscillator comprises an OTA-C quadrature oscillator III.

22. The ASM for designing OTA-C oscillator as claimed in claim 21, wherein said OTA-C quadrature oscillator III comprises an OTA-only (or OTA-parasitic C) quadrature oscillator.
